(19) United States
(12) Patent Application Publication
(10) Pub. No.: US 2003/0135971 A1
(43) Pub. Date: Jul. 24, 2003

(54) Bundle draw based processing of nanofibers and method of making

(76) Inventors: Michael Liberman, Deland, FL (US); Michael C. Murray, Eustis, FL (US); Matthew R. June, Daytona Beach, FL (US); Nathaniel R. Quick, Lake Mary, FL (US); Richard Salinaro, Hastings on Hudson, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/217,336

(22) Filed: Aug. 9, 2002

Related U.S. Application Data
(63) Continuation-in-part of application No. 09/654,980, filed on Sep. 5, 2000, now Pat. No. 6,497,029.
Application No. 09/654,980 is a continuation-in-part of application No. 09/190,723, filed on Nov. 12, 1998, now Pat. No. 6,112,395.
(60) Provisional application No. 60/065,363, filed on Nov. 12, 1997.

(51) Int. Cl. B23P 17/00

(52) U.S. Cl. 29/419.1

(57) ABSTRACT

A process is disclosed for making ultra fine fibers comprising forming a continuous cladding about a plurality of coated metallic wires. The cladding is drawn for reducing the outer diameter and for diffusion bonding the coating within the cladding. A plurality of the drawn claddings are assembled and a second cladding is formed the remainders. The second cladding is drawn for further reducing the outer diameter. The sacrificial coating and the claddings are removed to obtain a plurality of ultra fine fibers. In some embodiments, the ultra fine fibers are converted through a doping process.

### CROSS REFERENCE TO RELATED APPLICATIONS

This application is a continuation-in-part of U.S. patent application Ser. No. 09/654,980 entitled “PROCESS OF MAKING FINE AND ULTRA FINE METALLIC FIBERS” filed on Sep. 5, 2000, which is a continuation-in-part of U.S. patent application Ser. No. 09/190,723 entitled “PROCESS OF MAKING FINE AND ULTRA FINE METALLIC FIBERS” filed on Nov. 12, 1998, now U.S. Pat. No. 6,112,395, which application claims priority under 35 U.S.C. § 119(e) to Provisional Application Serial No. 60/065,363, filed Nov. 12, 1997, entitled “PROCESS OF MAKING FINE AND ULTRA FINE METALLIC FIBERS.” The disclosures of the above-described references are hereby incorporated by reference in their entirety.

### BACKGROUND OF THE INVENTION

1. Field of the Invention

This invention relates to metallic fibers and more particularly to an improved method of making fine and ultra fine fibers through a new cladding and drawing process. The invention also relates to modifications to and uses of the fibers thus produced.

2. Description of the Related Art

In recent years, the need for high quality, small diameter metallic fibers has grown as new applications for such fibers are developed by the art. High quality, small diameter metallic fibers have been used in diverse applications such as filtration media as well as being dispersed within a polymeric material to provide electrostatic shielding for electronic equipment and the like. The need for high quality, small diameter metallic fibers has led to various new ways and processes for making these high quality metallic fibers for the various uses in the art.

Typically, high quality metallic fibers may be characterized as small diameter metallic fibers having a diameter of less than 50 micrometers with a substantially uniform diameter along the longitudinal length thereof Typically, the fibers are produced in a fiber tow and severed to have a longitudinal length at least 1,000 times the diameter of the metallic fiber.

A disadvantage of some cladding and drawing processes is the diffusion of impurities of the carbon steel into metallic fiber during the drawing process, which is exacerbated for processing nanofibers and precious metals where chemical purity is required for product applications. A substantial amount of heat and pressure are produced during the drawing process, potentially causing a fusion of undesirable materials from the carbon steel upon the surface of the metallic fibers. These undesirable materials such as carbon, hydrocarbon materials such as oils and the like can remain on the surface of the metallic fibers through the leaching process and reside thereon in the end product. In certain applications, these undesired impurities are detrimental to the application and the use of the metallic fibers. For example, these undesirable impurities may be detrimental when the metallic fibers are used in a filtration process or the like.

### SUMMARY OF THE INVENTION

Methods of making ultra fine fibers, drawn metallic ultra fine fibers, devices including the ultra fine fibers, and uses for the ultra fine fibers are disclosed.

An ultra fine fiber can include a drawn metallic fiber having a diameter less than about 100 nanometers. The ultra fine fiber can have a diameter of between about 30 and 90 nanometers. The fiber can be a metallic fiber including stainless steel or gold. Alternatively, the metallic fiber can include iron, nickel, platinum, silver, or any alloy thereof.

The fiber can further include a combination of a first metal with a second component to form a material. The second component can include, for example, boron, carbon, nitrogen, oxygen, aluminum, silicon, phosphorus, sulfur, nickel, copper, zinc, gallium, germanium, palladium, silver, cadmium, indium, tin, platinum, gold, titanium, rhodium, zirconium, vanadium, titanium tetra-chloride, titanium ethoxide, aluminum sec-but-oxide, tetra-carbonyl nickel, and the like. Additionally, the material can include, for example, an alloy, a ceramic, a catalyst, an intermetallic, a glass, and the like. The material can have at least one electrical function. The material can function as a conductor, a semiconductor, an insulator, a capacitor, an electrode, or a photoconductor.

The fiber can also have an outer layer adjacent an outer circumference of the fiber. The outer layer of the fiber can contain boron, carbon, nitrogen, oxygen, aluminum, silicon, phosphorus, sulfur, nickel, copper, zinc, gallium, germanium, platinum, silver, indium, titanium tetra-chloride, titanium ethoxide, aluminum sec-but-oxide, tetra-carbonyl nickel, and the like.

The fiber has a longitudinal axis and can include at least a first region and a second region along its longitudinal axis. The first region can have a first characteristic and the second region can have a second characteristic. The first or second characteristic can be an electrical function, including, for example, a conductor, a semiconductor, an insulator, a capacitor, a resistor, an electrode, and the like. The first or second characteristic of the fiber can be a material having a combination of a first metal with a second component. The first metal can include a metal, for example, stainless steel, gold, iron, nickel, platinum, silver, titanium, zirconium, niobium, vanadium, and the like. Additionally, the second component can include an element, for example, boron, carbon, nitrogen, oxygen, aluminum, silicon, phosphorus, sulfur, nickel, copper, zinc, gallium, germanium, palladium, silver, cadmium, indium, tin, platinum, indium, gold, titanium, rhodium, zirconium, vanadium, and the like. Alternatively the material can be, for example, an alloy, a ceramic, a catalyst, or an intermetallic.

Another embodiment of the invention includes a device including a drawn metallic fiber having a diameter less than 100 nanometers. The device can be, for example, a filter, a sensor, a capacitor, a resistor, a semiconductor, a fuel cell, a nanogear, a nanomechanical device, a nanochemical device, a nanoelectrical device, a nanoelectromechanical system, a nanospring, or a catalyst.

Another embodiment of the invention is a filter including an ultra fine fiber, where the fiber includes a drawn metallic fiber having a diameter less than about 100 nanometers. The filter can include a fiber having a ductile material that is resistant to chemical corrosion. Alternatively, the filter can include a fiber having a material having a catalytic property or a fiber having a material having resistance to a temperatures between about 100° C. to about 1250° C.

The filter can have a thickness of between about 25 μm and about 1250 μm and can have pores capable of excluding particles of a minimum size, wherein the minimum size is between about 1000 Daltons and about 1 μm. Further, the filter can have a bulk porosity of at least about 30%.

Another embodiment of the invention is a process for making ultra fine fibers. The process includes providing a plurality of metallic wires, coating the wires with a sacrificial coating material to obtain a plurality of coated wires, subjecting the plurality of coated wires to at least two cycles of a drawing process, releasing the fibers by removing the sacrificial coating material and claddings, and obtaining a plurality of ultra fine metallic fibers, the fibers having a diameter of less than about 100 nanometers. The drawing process includes forming a bundle of metallic wires, or claddings containing metallic wires, encasing the bundle within an outer cladding and drawing the outer cladding to reduce the outer diameter thereof and to reduce the cross-section of the metallic wires.

At least one cycle of the drawing process can include an annealing step, and the annealing step can include exposing the metallic wires to a temperature between 0.5 and 0.8 of a melting point of the wires.

The process can include three or more cycles of the drawing process and can further include exposing at least a portion of a fiber to a second component under conditions permitting doping of the second component into the fiber. The conditions permitting doping can include contacting the fiber with a doping atmosphere including a gas. The gas can include an element, for example, nitrogen, hydrogen, carbon, boron, phosphorus, silicon, aluminum, sulfur, oxygen titanium tetra-chloride, titanium ethoxide, aluminum sec-but-oxide, tetra-carbonyl nickel, or the like. The conditions permitting doping can further include heating the fibers in the doping atmosphere, preferably at a temperature sufficient to break an intramolecular bond of the gas, and the temperature can be lower than a melting point of the fiber.

The conditions permitting doping can include heating the fiber at a level between about 0.5 and 0.9 of a melting point of the fibers. The heating can be at a level between about 0.6 and 0.8, and most preferably between about 0.65 and 0.69 of a melting point of the fibers.

The process of making ultra fine fibers can include a coating step that includes electroplating the coating material onto the metallic wires. The process of making ultra fine fibers can also include treating an interior of the cladding with a release material to inhibit chemical interaction between the cladding and the plurality of coated metallic wires within the cladding. The release material can be in a quantity sufficient to inhibit chemical interaction between the cladding and the plurality of coated metallic wires within the cladding, and the quantity can be insufficient to inhibit a diffusion bond between the coated metallic wires and the sacrificial coating material.

The process of making ultra fine fibers can include in the encasing step of at least one cycle forming a longitudinally extending sheet of cladding material into a continuous tube about the plurality of metallic wires.

In the process of making ultra fine fibers, the sacrificial coating can include from about 5% to about 15% by volume of a combined volume of the metallic wires and the sacrificial coating material. In the process of making ultra fine fibers the releasing step can include chemically removing the sacrificial coating material, or immersing the drawn metallic wires into an acid for dissolving the sacrificial coating material.

In the process of making ultra fine fibers at least one cycle can include a reduction ratio of the cross section of the wires between about 8% and about 20%, preferably about 10%. In the process of making ultra fine fibers, the metallic wires can have a diameter of from about 12 μm to about 50 μm prior to the drawing process. An embodiment of the invention includes use of an ultra fine fiber in a device, where the ultra fine fiber includes a drawn metallic fiber having a diameter less than about 100 nanometers for use in a device. The device can be an electronic sensor, and the electronic sensor can, for example, be a piezo-resistive sensor, a chemo-resistive sensor, a nano-computer switch, a thermo-resistive sensor, a nano-transmitter, a nano-receiver, a thermocouple, or a nano-antenna. The device can be a biomedical sensor, such as, for example, a glucose sensor. Alternatively, the device can be an opto-electronic converter, such as, for example, a photovoltaic cell. The device can be a filtration device, such as, for example, a nano-catalytically enhanced filtration device, an aerosol filter device, a nano-filtration membrane, or the like. The device can be an energy device, such as, for example, a nano-fuel cell array, a nano-storage capacitor, an infrared energy sensor, an ultraviolet energy sensor, a microwave energy sensor, an RF energy sensor, a thermocouple, a nano-heater, or the like. The device can be a chemical device, such as, for example, a nano-engineered catalyst structure, a nano-chemical sensor, a nano-chemical analyzer, and the like. Alternatively the device can be a mechanical device or an electronic device. The mechanical device can be a nano-electro-mechanical system, a nano-spring, a nano-lever, a nano-diaphragm, a nano cable or a nanogear. The electronic device can be a transistor, a diode, an LED, a nanotorus, a cathode emitter, a rectifier, a resistor, an inductor, a nanocomputer, or a nanomemory circuit. The device can also be a quantum well device, a quantum cascade device, a ceramic superconductor, or a nanowire laser.

The various uses of an ultra fine fiber in a device can employ a fiber having a diameter between about 30 and 90 nanometers; such an ultra fine fiber can contain, for example, stainless steel, gold, iron, nickel, platinum, silver, titanium, zirconium, niobium, vanadium, chromium, manganese, cobalt, molybdenum, copper, or the like.

### BRIEF DESCRIPTION OF THE DRAWINGS

FIG. 1 is a block diagram illustrating a first improved process of forming fine metallic fibers through a new cladding and drawing process of the invention.

FIG. 2 is an isometric view of a metallic wire referred to in FIG. 1.

FIG. 2A is an enlarged end view of FIG. 2.

FIG. 3 is an isometric view of the wire of FIG. 2 with a coating material thereon.

FIG. 3A is an enlarged end view of FIG. 3.

FIG. 4 is an isometric view of an initial step of a first optional process of encasing an assembly of a plurality of wires of FIG. 3 within a casing.

FIG. 4A is an end view of FIG. 4.

FIG. 5 is an isometric view of the completed step of the first optional process of encasing the assembly of the plurality of wires of FIG. 3 within the casing.

FIG. 5A is an end view of FIG. 5.

FIG. 6 is an isometric view of an initial step of a second optional process of encasing an assembly of a plurality of wires of FIG. 3 within a casing.

FIG. 6A is an end view of FIG. 6.

FIG. 7 is an isometric view of the completed step of the second optional process of encasing the assembly of the plurality of wires of FIG. 3 within the casing.

FIG. 7A is an end view of FIG. 7.

FIG. 8 is an isometric view of an initial process of forming a tube about the casing of FIG. 5 with a cladding material.

FIG. 8A is an end view of FIG. 8.

FIG. 9 is an isometric view of the completed process of forming the tube about the casing of FIG. 5 with the cladding material.

FIG. 9A is an end view of FIG. 9.

FIG. 10 is an isometric view of the cladding of FIG. 9 after a first drawing process.

FIG. 10A is an enlarged end view of FIG. 10.

FIG. 11 is an isometric view illustrating the mechanical removal of the tube after the first drawing process of FIG. 10.

FIG. 11A is an enlarged end view of FIG. 11.

FIG. 12 is an isometric view of the casing of FIG. 11 after the second drawing process.

FIG. 12A is an enlarged end view of FIG. 12.

FIG. 13 is an isometric view of the plurality of the fine metallic fibers of FIG. 12 after removal of the coating material.

FIG. 13A is an enlarged end view of FIG. 13.

FIG. 14 is a diagram illustrating a first portion of an apparatus for performing the first improved process of forming fine metallic fibers shown in FIG. 1.

FIG. 15 is a diagram illustrating a second portion of the apparatus of FIG. 14.

FIG. 16 is a diagram illustrating a third portion of the apparatus of FIG. 14.

FIG. 17 is a block diagram illustrating a second improved process of forming ultra fine metallic fibers through a new cladding and drawing process of the invention.

FIG. 18 is an isometric view of an initial step of a first optional process of encasing an assembly of a plurality of the remainders of FIG. 12 within a second casing.

FIG. 18A is an end view of FIG. 18.

FIG. 19 is an isometric view of the completed step of the first optional process of encasing the assembly of the plurality remainders of FIG. 12 within the second casing.

FIG. 19A is an end view of FIG. 19.

FIG. 20 is an isometric view of an initial step of a second optional process of encasing an assembly of the plurality of remainders of FIG. 12 within a second casing.

FIG. 20A is an end view of FIG. 20.

FIG. 21 is an isometric view of the completed step of the second optional process of encasing the assembly of the plurality of remainders of FIG. 12 within the second casing.

FIG. 21A is an end view of FIG. 21.

FIG. 22 is an isometric view of an initial process of forming a second tube about the second casing of FIG. 19 with a second cladding material.

FIG. 22A is an end view of FIG. 22.

FIG. 23 is an isometric view of the completed process of forming the second tube about the second casing of FIG. 19 with the second cladding material.

FIG. 23A is an end view of FIG. 23.

FIG. 24 is an isometric view of the second cladding of FIG. 23 after a third drawing process.

FIG. 24A is an enlarged end view of FIG. 24.

FIG. 25 is an isometric view illustrating the mechanical removal of the second tube after the third drawing process of FIG. 10.

FIG. 25A is an enlarged end view of FIG. 25.

FIG. 26 is an isometric view of the second casing of FIG. 25 after a fourth drawing process.

FIG. 26A is an enlarged end view of FIG. 26.

FIG. 27 is an isometric view of the plurality of the ultra fine metallic fibers of FIG. 26 after removal of the coating material.

FIG. 27A is an enlarged end view of FIG. 27.

FIG. 28 is a diagram illustrating a first portion of a second apparatus for performing the second improved process of forming ultra fine metallic fibers shown in FIG. 17.

FIG. 29 is a diagram illustrating a second portion of the apparatus of FIG. 28.

FIG. 30 is a diagram illustrating a third portion of the apparatus of FIG. 28.

FIG. 31 is a diagram illustrating a fourth portion of the apparatus of FIG. 28.

FIG. 32 is a diagram illustrating a fifth portion of the apparatus of FIG. 28.

FIG. 33 is a diagram illustrating a sixth portion of the apparatus of FIG. 28.

FIG. 34 is an isometric view of a first example of an assembly of a multiplicity of mixed first and second coated metallic wires.

FIG. 35 is an isometric view of a second example of an assembly of a multiplicity of mixed first and second coated metallic wires.

FIG. 36 is an isometric view of a third example of an array of a multiplicity of assemblies of the first and second coated metallic wires.

FIG. 37 is an isometric view of a fourth example of an array of a multiplicity of assemblies of the first and second coated metallic wires.

FIG. 38 is an enlarged view of a portion of FIGS. 16, 30 and 33 illustrating a variable cutting assembly for scoring or cutting the cladding material.

FIG. 39 is an enlarged view of a portion of FIG. 38 illustrating a cutting blade in a first position. and

FIG. 40 is an enlarged view of a portion of FIG. 38 illustrating the cutting blade in a second position.

FIG. 41 is a block diagram illustrating a first improved process of forming fine metallic fibers through a new cladding and drawing process of the invention.

FIG. 42 is an isometric view of a metallic wire referred to in FIG. 41.

FIG. 42A is an enlarged end view of FIG. 42.

FIG. 43 is an isometric view of the wire of FIG. 42 with a coating material thereon.

FIG. 43A is an enlarged end view of FIG. 43.

FIG. 44 is an isometric view illustrating an assembly of a multiplicity of the metallic wire of FIG. 43 being wrapped with a wrapping material.

FIG. 44A is an enlarged end view of FIG. 44.

FIG. 45 is an isometric view illustrating a plurality of the wrapped assemblies of FIG. 44.

FIG. 45A is an end view of FIG. 45.

FIG. 46 is an isometric view illustrating the plurality of the wrapped assemblies of FIG. 45 being simultaneously inserted into a preformed tube for providing a cladding.

FIG. 46A is an end view of FIG. 46.

FIG. 47 is a sectional view along line 47-47 of FIG. 46.

FIG. 47A is a magnified view of a portion of FIG. 46A.

FIG. 48 is an isometric view similar to FIG. 46 illustrating the complete insertion of the plurality of wrapped assemblies within the preformed tube for providing the cladding.

FIG. 48A is a magnified view of a portion of FIG. 48.

FIG. 49 is an isometric view similar to FIG. 48 illustrating an initial tightening of the cladding about the plurality of the wrapped assemblies therein.

FIG. 49A is a magnified view of a portion of FIG. 49.

FIG. 50 is an isometric view of the cladding of FIG. 49 after a drawing process.

FIG. 50A is an enlarged end view of FIG. 50.

FIG. 51 is an isometric view of the plurality of the fine metallic fibers after removal of the coating material in FIG. 50.

FIG. 51A is an enlarged end view of FIG. 51.

FIG. 52 is a diagram illustrating an apparatus for wrapping a multiplicity of the metallic wires with a wrapping material.

FIG. 53 is a diagram illustrating the simultaneous insertion of the plurality of the wrapped assemblies of FIGS. 45 and 46 within the preformed tube.

FIG. 54 is a block diagram illustrating a forth improved process of forming fine metallic fibers through a new cladding and drawing process of the present invention.

FIG. 55 is a block diagram illustrating a fifth improved process of forming ultra fine metallic fibers through a new cladding and drawing process of the present invention.

FIG. 56 is a block diagram illustrating a general process for creating an alloy.

FIG. 57 is an isometric view of a metal wire.

FIG. 57A is an enlarged cross sectional view of FIG. 57.

FIG. 58 is an isometric view of the metal wire referred to in FIG. 57 encased in a tube to thereby form a metal member;

FIG. 58A is an enlarged cross-sectional view of FIG. 58.

FIG. 59 is an isometric view of a plurality of metal members jacketed or inserted within a composite tube.

FIG. 59A is a cross sectional view of FIG. 59.

FIG. 60 is an isometric view of the plurality of the metal members inserted within the preformed tube after the process step of drawing the metal composite.

FIG. 60A is an enlarged end view of FIG. 60.

FIG. 61 is an isometric view illustrating the mechanical removal of the preformed composite tube.

FIG. 61A is an enlarged end view of FIG. 61.

FIG. 62 is an isometric view illustrating the remainder upon complete removal of the tube.

FIG. 62A is an enlarged cross sectional view of the alloy product of the heated remainder of FIG. 62.

FIG. 63 is a block diagram of a process for making fine metallic alloy fibers of the invention.

FIG. 64 is an isometric view of a metallic alloy wire referred to in FIG. 63.

FIG. 64A is an end view of FIG. 64.

FIG. 65 is an isometric view illustrating a preformed first cladding material referred to in FIG. 63.

FIG. 65A is an end view of FIG. 65.

FIG. 66 is an isometric view illustrating the first cladding material of FIG. 65 encompassing the metallic alloy wire of FIG. 64.

FIG. 66A is an end view of FIG. 66.

FIG. 67 is an isometric view similar to FIG. 66 illustrating the first cladding material being sealed to the metallic alloy wire.

FIG. 67A is an end view of FIG. 67.

FIG. 68 is an isometric view similar to FIG. 67 illustrating the tightening of the first cladding material to the metallic alloy wire in the presence of an inert atmosphere.

FIG. 68A is an end view of FIG. 68.

FIG. 69 is an isometric view similar to FIG. 68 illustrating the first cladding material tightened to the metallic alloy wire.

FIG. 69A is an end view of FIG. 69.

FIG. 70 is an isometric view of the first cladding of FIG. 69 after a first drawing process.

FIG. 70A is an enlarged end view of FIG. 70.

FIG. 71 is an isometric view illustrating an assembly of a multiplicity of the drawn first claddings within a second cladding.

FIG. 71A is an end view of FIG. 71.

FIG. 72 is an isometric view of the second cladding of FIG. 71 after a second drawing process.

FIG. 72A is an enlarged end view of FIG. 72.

FIG. 73 is an isometric view similar to FIG. 72 illustrating the removal of the first and second claddings to provide a multiplicity of fine metallic alloy fibers.

FIG. 73A is an enlarged end view of FIG. 73.

FIG. 74 is a block diagram illustrating an improved process of forming ultra fine fibers through a cladding and drawing process according to the invention.

FIG. 75 is an isometric view of a metallic wire used in the method of FIG. 74.

FIG. 75A is an enlarged end view of FIG. 75.

FIG. 76 is an isometric view of the wire of FIG. 75 with a coating material thereon.

FIG. 76A is an enlarged end view of FIG. 76.

FIG. 77 is an isometric view of an assembly of a plurality of wires of FIG. 76 within a wrapping material.

FIG. 77A is an end view of FIG. 77.

FIG. 78 is an isometric view of the completed assembly of the plurality of wires of FIG. 76 within the wrapping material.

FIG. 78A is an end view of FIG. 78.

FIG. 79 is an isometric view of a cladding being formed around the assembly of FIG. 78.

FIG. 79A is an end view of FIG. 79.

FIG. 80 is an isometric view of the completed cladding FIG. 79.

FIG. 80A is an end view of FIG. 80.

FIG. 81 is an isometric view of the cladding of FIG. 80 after a first drawing process.

FIG. 81A is an enlarged end view of FIG. 81.

FIG. 82 is an isometric view illustrating the mechanical removal of the cladding after the first drawing process of FIG. 8 leaving coated ultra fine fibers.

FIG. 82A is an enlarged end view of FIG. 82.

FIG. 83 is an isometric view of the plurality of the coated metallic fibers of FIG. 82.

FIG. 83A is an enlarged end view of FIG. 83.

FIG. 84 is an isometric view of the plurality of the fine metallic fibers of FIG. 82 after removal of the coating material.

FIG. 84A is an enlarged end view of FIG. 84.

FIG. 85 is a block diagram illustrating a process of converting fibers into a ceramic.

FIG. 86 is a micrograph of an end view magnified 16× of a 310 stainless steel bundle of assemblies.

FIG. 87 is a micrograph of an end view magnified 1,000× of the 310 stainless steel bundle of FIG. 86 showing one of the assemblies.

FIG. 88 is a micrograph of an end view magnified 25,000× of the 310 stainless steel bundle of FIG. 86 showing ends of some of the fibers.

FIG. 89 is a micrograph of a plurality of 316 stainless steel fibers magnified 500×.

FIG. 90 is a micrograph of a plurality of 316 stainless steel fibers magnified 15,000×.

FIG. 91 is a micrograph of a plurality of 316 stainless steel fibers magnified 50,000×.

FIG. 92 is a micrograph of a plurality of stainless steel fibers magnified 5,000×.

### DETAILED DESCRIPTION OF THE PREFERRED EMBODIMENT

A detailed description of an embodiment of the invention is provided below. While the invention is described in conjunction with that preferred embodiment, it should be understood that the invention is not limited to any one embodiment. On the contrary, the scope of the invention is limited only by the appended claims, and the invention encompasses numerous embodiments, alternatives, modifications and equivalents. For the purpose of example, numerous specific details are set forth in the following description in order to provide a thorough understanding of the invention. The invention may be practiced according to the claims without some or all of these specific details.

The metallic fibers as set forth herein are typically manufactured by cladding a metallic wire with a cladding material to provide a first cladding. The first cladding is drawn and annealed for reducing the diameter of the first cladding. A plurality of the first claddings are clad to provide a second cladding. The second cladding is subjected to a multiple drawing and annealing process for reducing the diameter of the second cladding and the corresponding diameter of the first claddings contained therein. Depending upon the desired end diameter of the first cladding, the plurality of second claddings may be clad to provide a third cladding. Multiple drawings of the third cladding reduce the diameter of the first and second claddings to provide metallic fibers within the first claddings of the desired diameter. After the desired diameter of the metallic fibers within the first cladding is achieved, the cladding materials are removed by either an electrolysis or a chemical process thereby providing metallic fibers of the desired final diameter.

In some embodiments, the fibers are made of a stainless steel and are produced by a drawing process. In other embodiments, the fibers are homogeneous metal structures including nickel, gold, platinum, silver, palladium, silicon, titanium and germanium. Two or more concentrically aligned materials that after drawing are inter-diffused by a thermal process can also be used as described in U.S. Pat. No. 6,248,192, the specification of which is hereby incorporated by reference in its entirety. The drawing process comprises cladding a stainless steel wire with a cold roll steel clad material to produce a first cladding. The first cladding is subjected to a series of drawing and annealing processes for reducing the diameter thereof. Thereafter, a plurality of the first claddings are encased within a second cladding material such as cold roll steel for producing a second cladding. The second cladding is subjected to a series of drawing and annealing processes for further reducing the diameter of the second cladding. After the second drawing process, the original wires of the first cladding are reduced to a diameter of 10 to 50 microns that is suitable for some applications. For applications requiring finer metallic fibers, a plurality of second claddings are clad with a third cladding material to provide a third cladding. Third cladding is subjected to a series of drawing and annealing for further reducing the diameter of the original metallic wires.

The cladding material is removed by subjecting the finally drawn cladding to an acid leaching process whereby the acid dissolves the cladding material leaving the metallic fibers. The metallic fibers may be severed to produce metallic sliver or cut metallic fibers or may be used as metallic fiber tow.

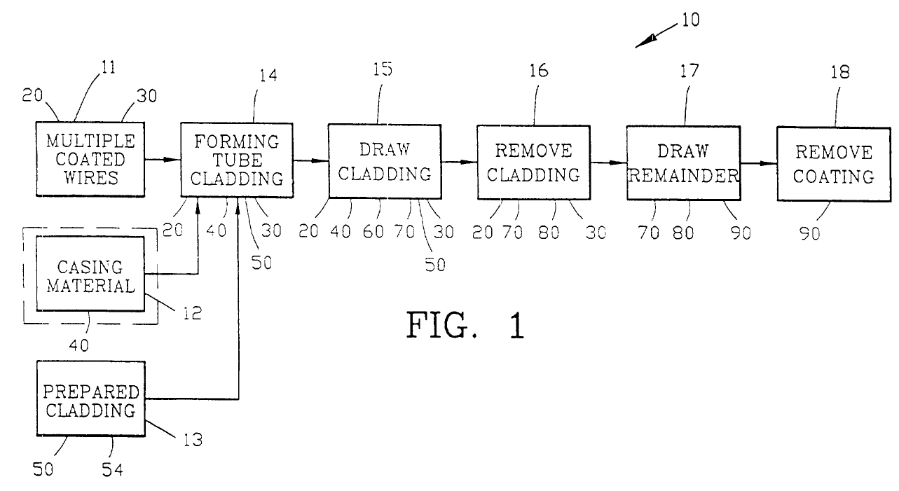

Throughout the several Figures of the drawings, similar reference characters refer to similar parts. FIG. 1 is a block diagram illustrating an improved process 10 for making fine metallic fibers. The improved process 10 of FIG. 1 comprises the process step 11 of providing multiple coated metallic wires 20 with each of the metallic wires 20 having a coating material 30.

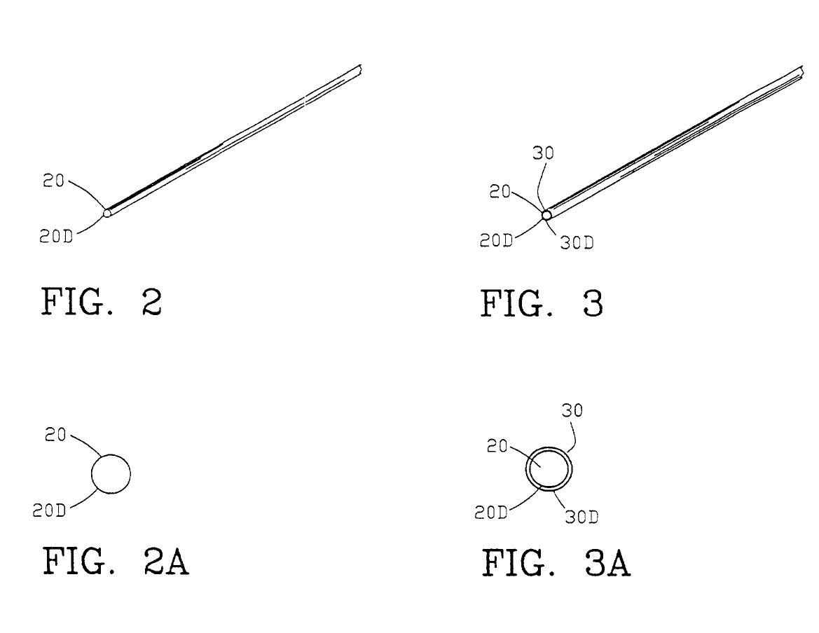

FIG. 2 is an isometric view of the metallic wire 20 referred to in FIG. 1 with FIG. 2A being an enlarged end view of FIG. 2. In this example, the metallic wire 20 is a stainless steel wire having a diameter 20D but it should be understood that various types of metallic wires 20 may be used in the improved process 10.

FIG. 3 is an isometric view of the metallic wire 20 of FIG. 2 with the coating material 30 thereon. FIG. 3A is an enlarged end view of FIG. 3. In this example, the coating material 30 is a copper material but it should be understood that various types of coating materials 30 may be used in the improved process 10.

The process of applying the coating material 30 to the metallic wire 20 may be accomplished in various ways. One preferred process of applying the coating material 30 to the metallic wire 20 is an electroplating process. The coating material 30 defines a coating diameter 30D. Preferably, the coating material 30 represents approximately five percent (5%) by weight of the combined weight of the metallic wire 20 and the coating material 30.

A plurality of the metallic wires 20 with the coating material 30 are formed into an assembly of metallic wires 20. Preferably, 150 to 1200 metallic wires 20 with the coating material 30 are formed into the assembly 34.

FIG. 1 illustrates an optional process step 12 of encasing the assembly 34 of metallic wires 20 with a casing material 40. Preferably, the casing material 40 is the same material as the coating material 30.

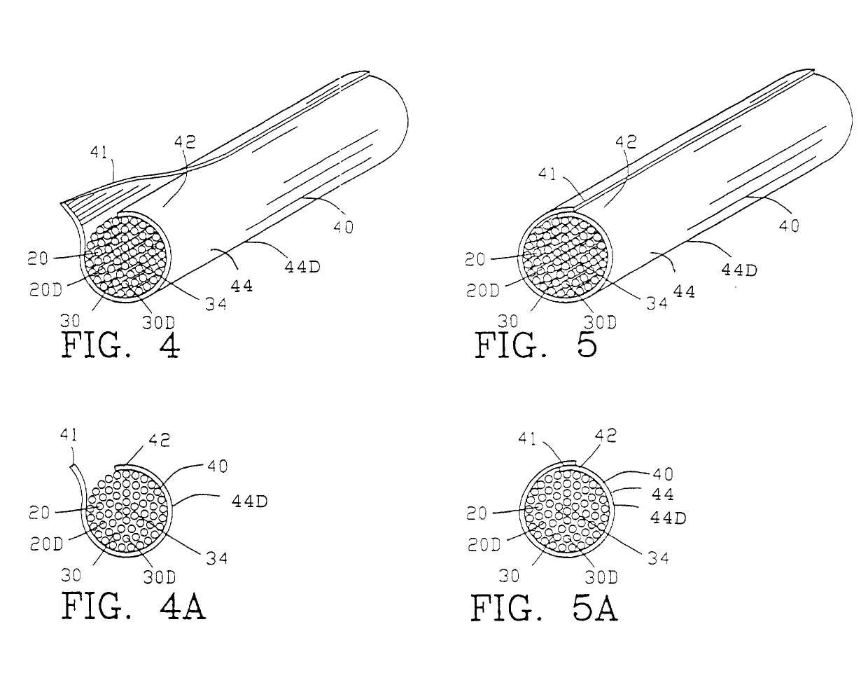

FIG. 4 illustrates an initial step in a first example of the optional process step 12 of encasing the assembly 34 of metallic wires 20 with the casing material 40. FIG. 4A is an end view of FIG. 4. The step of encasing the assembly 34 within the casing material 40 includes bending a first and a second edge 41 and 42 of a longitudinally extending casing material 40 to form the casing 44.

FIG. 5 illustrates the completed process of encasing the assembly 34 of the plurality of the wires 20 within the casing material 40. FIG. 5A is an end view of FIG. 5. The casing material 40 is bent about the assembly 34 of the plurality of the wires 20 with the first edge 41 of the casing material 40 overlapping the second edge 42 of the casing material 42. The assembly 34 of the plurality of the wires 20 are encased within the casing material 40 for providing the casing 44 having a diameter 44D.

FIG. 6 illustrates an initial step in a second example of the optional process step 12 of encasing the assembly 34 of metallic wires 20 with the casing material 40. FIG. 6A is an end view of FIG. 6. The step of encasing the assembly 34 within the casing material 40 includes bending a first and a second edge 41 and 42 of a longitudinally extending casing material 40 to form the casing 44.

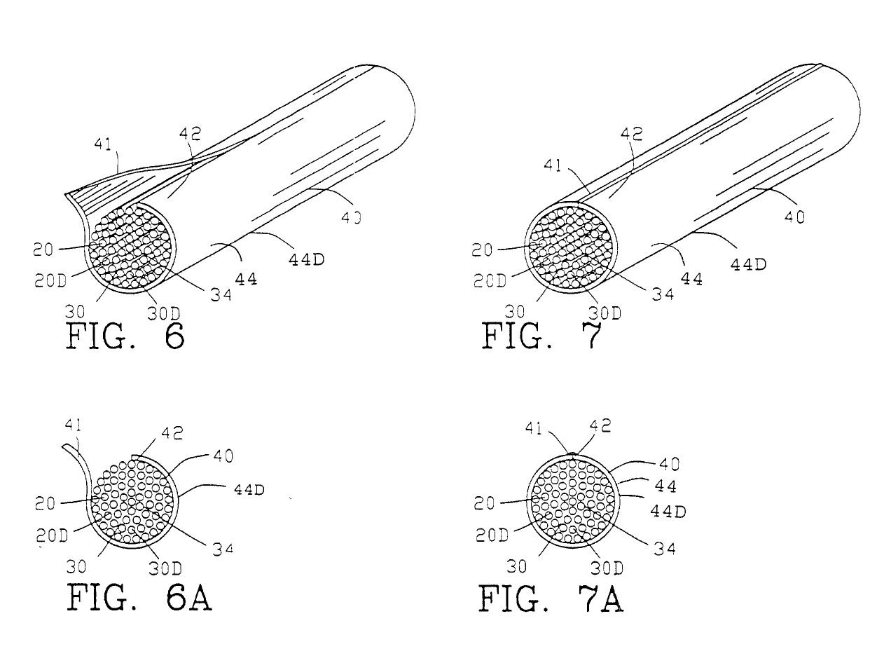

FIG. 7 illustrates the completed process of encasing the assembly 34 of the plurality of the wires 20 within the casing material 40. FIG. 7A is an end view of FIG. 7. The casing material 40 is bent about the assembly 34 of the plurality of the wires 20 with the first edge 41 of the casing material 40 abutting the second edge 42 of the casing material 42. Preferably, the first edge 41 of the casing material 40 is welded to the second edge 42 of the casing material 40 by a weld 46. The assembly 34 of the plurality of the wires 20 are encased within the casing material 40 for providing the casing 44 having a diameter 44D.

FIG. 1 illustrates the process step 13 of preparing a cladding material 50. Preferably, the cladding material 50 is a longitudinally extending cladding material 50 having a first and a second edge 51 and 52. A surface of the cladding material 50 may be treated with a release material 54 to inhibit chemical interaction between the cladding material 50 and the plurality of metallic wires 20 or the casing material 40. The release material 54 may be any suitable material to inhibit chemical interaction between the cladding material 50 and the plurality of metallic wires 20 or the coating material 30 or the casing material 40.

Preferably, the cladding material 50 is made of a carbon steel material. The release material 54 may be titanium dioxide TiO₂, sodium silicate, aluminum oxide, talc or any other suitable material to inhibit chemical interaction between the cladding material 50 and the coating material 30 or the casing material 40. The release material 54 may be suspended within a liquid for enabling the release material 54 to be painted onto the cladding material 50. In the alternative, the release material 54 may be applied by flame spraying or a plasma gun or any other suitable means.

FIG. 1 illustrates the process step 14 of forming a continuous tube 55 of the cladding material 50 about the plurality of metallic wires 20 or the casing material 40. In this example, the cladding material 50 is a carbon steel material with the plurality of metallic wires 20 being made of a stainless steel material. The coating material 30 and the casing material 40 are preferably a copper material.

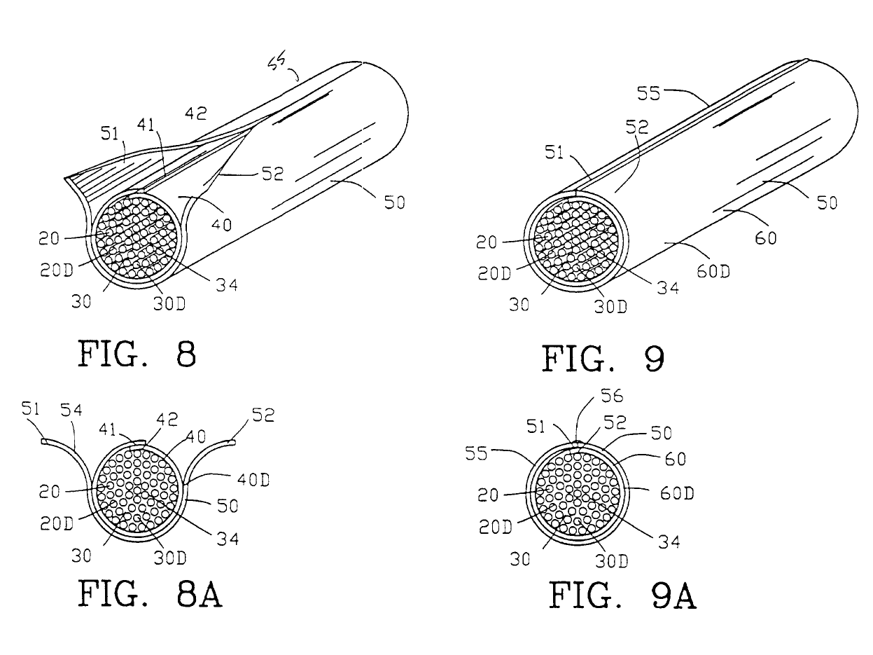

FIG. 8 is an isometric view illustrating an initial process of forming the continuous tube 55 of the cladding material 50 about the plurality of metallic wires 20 and the casing material 40. FIG. 8A is an end view of FIG. 8. The step 14 of forming the tube 55 from the cladding material 50 includes bending the first and second edges 51 and 52 of the longitudinally extending sheet of the cladding material 50 to form a cladding 60 for enclosing the casing material 40. The cladding 60 defines an outer diameter 60D.

FIG. 9 is an isometric view of the completed process of forming the continuous tube 55 of the cladding material 50. FIG. 9A is an end view of FIG. 9. The longitudinally extending sheet of the cladding material 50 is bent with the first edge 51 of the cladding material 50 abutting the second edge 52 of the cladding material 50. The first edge 51 of the cladding material 50 is welded to the second edge 52 of the cladding material 50 by a weld 56.

When the optional casing material 40 is used in the process, the casing material 40 acts as a heat sink to facilitate the welding of the first edge 51 to the second edge 52 of the cladding material 50. Furthermore, the casing material 40 acts as a heat sink to protect the assembly 34 of the plurality of coated wires 20 within the casing material 40 from the heat of the welding process.

FIG. 1 illustrates the process step 15 of drawing the cladding 60. The process step 15 of drawing the cladding 60 provides four effects. Firstly, the process step 15 reduces an outer diameter 60D of the cladding 60. Secondly, the process step 15 reduces the corresponding outer diameter 20D of each of the plurality of metallic wires 20 and the corresponding outer diameter 30D of each of the coating materials 30. Thirdly, the process step 15 causes the coating materials 30 on each of metallic wires 20 to diffusion weld with the coating materials 30 on adjacent metallic wires 20. Fourthly, the process step 15 causes the casing material 40 to diffusion weld with the coating material 30 on the plurality of metallic wires 20.

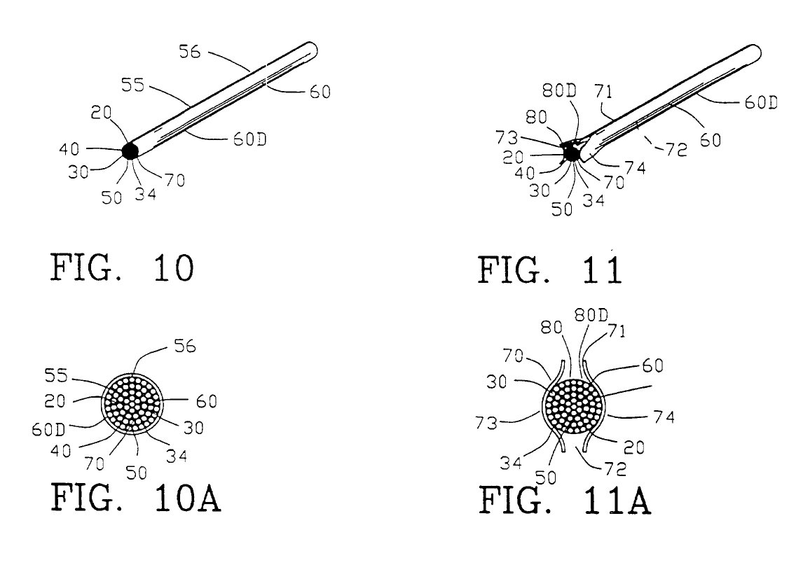

FIG. 10 is an isometric view of the cladding 60 of FIG. 9 after the first drawing process. FIG. 10A is an enlarged end view of FIG. 10. The drawing of the cladding 60 causes the coating material 30 on each of the plurality of metallic wires 20 to diffusion weld with the coating materials 30 on adjacent plurality of metallic wires 20 and to diffusion weld with the casing material 40. The diffusion welding of the coating material 30 and the casing material 40 forms a unitary material 70. After the diffusion welding of the coating material 30 and the casing material 40, the coating material 30 and the casing material 40 are formed into a substantially unitary material 70 extending throughout the interior of the cladding 60. The plurality of metallic wires 20 are contained within the unitary material 70 extending throughout the interior of the cladding 60. Preferably, the coating material 30 and the casing material 40 is a copper material and is diffusion welded within the cladding 60 to form a substantially unitary copper material 70 with the plurality of metallic wires 20 contained therein.

The release material 54 is deposited on the cladding material 50 of the formed tube 55 in a quantity sufficient to inhibit the chemical interaction or bonding between the tube 55 and a plurality of metallic wires 20 and the coating materials 30 and the casing material 40 within the tube 55. However, the release material 54 is deposited on the tube 55 in a quantity insufficient to inhibit the diffusion welding of the coating materials 30 on adjacent metallic wires 20 and the casing material 40.

FIG. 1 illustrates the process step 16 of removing the tube 55. In the preferred form of the process, the step 16 of removing the tube 55 comprises mechanically removing the tube 55.

FIG. 11 is an isometric view illustrating the mechanical removal of the tube 55 with FIG. 11A being an enlarged end view of FIG. 11. In one example of this process step 16, the tube 55 is scored or cut at 71 and 72 by mechanical scorers or cutters (not shown). The scores or cuts at 71 and 72 form tube portions 73 and 74 that are mechanically pulled apart to peel the tube 55 off of a remainder 80. The remainder 80 comprises the substantially unitary coating material 70 with the plurality of metallic wires 20 contained therein. The remainder 80 defines an outer diameter 80D.

FIG. 1 illustrates the process step 17 of drawing the remainder 80 for reducing the outer diameter 80D thereof and for reducing the corresponding outer diameter 20D of the plurality of metallic wires 20 contained therein.

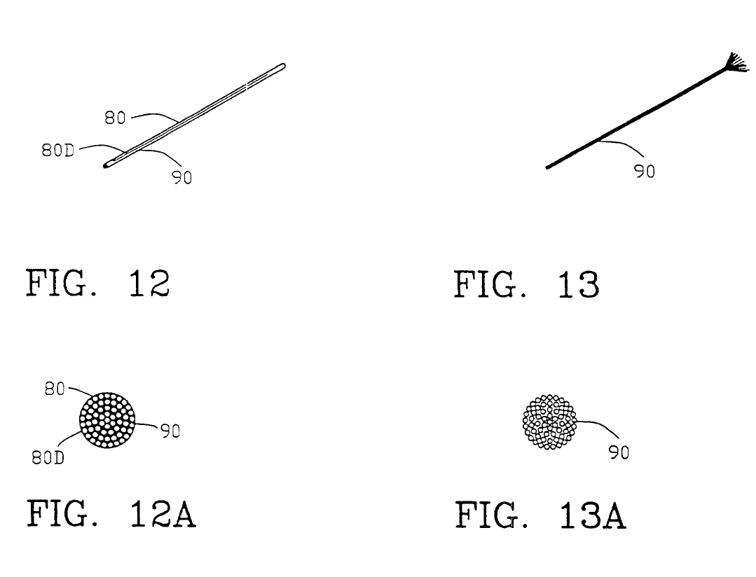

FIG. 12 is an isometric view of the plurality of wires 20 of FIG. 11 reduced into a plurality of fine metallic fibers 90 by the process step 17 of drawing the remainder 80. FIG. 12A is an enlarged end view of FIG. 12. The substantially unitary material 70 provides mechanical strength for the plurality of metallic wires 20 contained therein for enabling the remainder 80 to be drawn without the cladding 60. The substantially unitary coating material 30 and casing material 40 enables the remainder 80 to be drawn for reducing the outer diameter 80D thereof and for providing the plurality of fine metallic fibers 90.

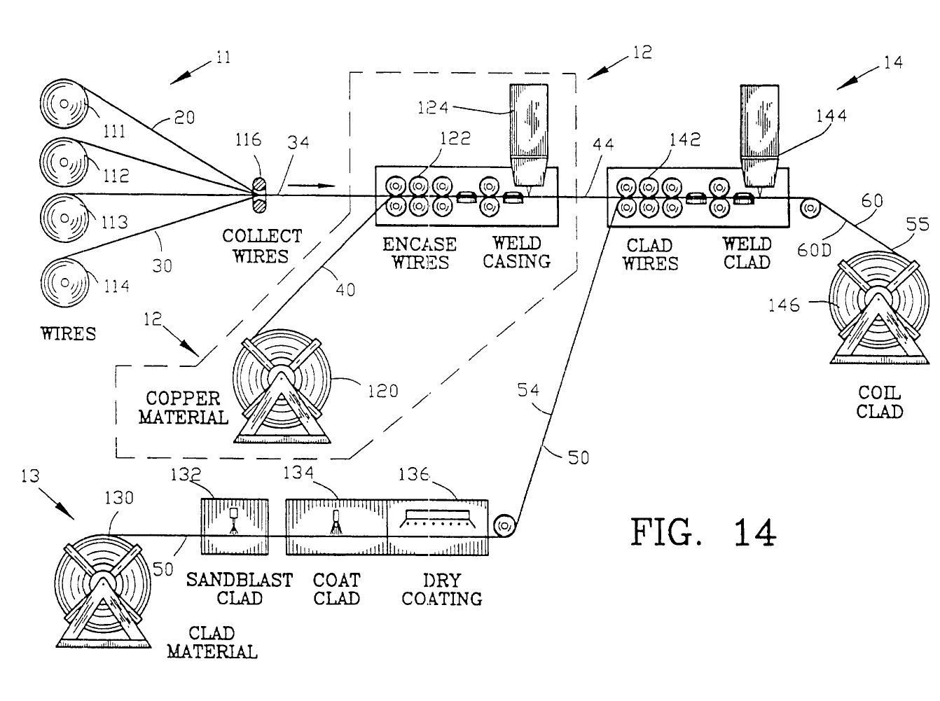

FIG. 13 is an isometric view of the plurality of the fine metallic fibers 90 of FIG. 12 after the process step 18 of removing the unitary material 70. FIG. 13A is an enlarged end view of FIG. 13. Preferably, the unitary material 70 is removed by an acid leaching process for dissolving the unitary copper material 70 to provide a plurality of stainless steel fibers 90.

One example of the process step 18 includes an acid leaching process. The remainder 80 comprising the substantially unitary copper material 30 with the plurality of stainless steel wires 20 is immersed into a solution of 8% to 15% H₂SO₄ and 0.1% to 1.0% H₂O₂ for dissolving the unitary copper material 70 without dissolving the stainless steel fibers 90. The 0.1% to 1.0% H₂O₂ functions as an oxidizing agent to inhibit leaching of stainless steel fibers 90 by the H₂SO₄. Preferably, the 0.5% to 3.0% H₂O₂ is stabilized from decaying in the presence of copper such as PC circuit board grade H₂O₂. It should be appreciated that other oxidizing agents may be used with the present process such as sodium stanate or sodium benzoate or the like.

The above acid leaching process 16 is governed by the reaction illustrated in equation

Cu+H₂O₂+H₂SO₄→CuSO₄+2H₂O

The initial concentration of the H₂SO₄ is 11.0% at a concentration of 20.0 grams per liter of Cu+2 as CuSO₄ at a temperature of 80 degrees F. to 120 degrees F. The concentration is maintained between 8.0% to 11.0% H₂SO₄ and 20.0 to 70.0 grams per liter of Cu⁺² as CuSO₄.

The dissolving of the unitary copper material 70 in the presence of the H₂O₂ dissolves the unitary copper material 70 without dissolving the stainless steel fibers 90. After the unitary copper material 70 is dissolved, the stainless steel fibers 90 are passed to a rinsing process.

The removal process 18 includes rinsing the stainless steel fibers 90 in a rinse solution comprising H₂O having a pH of 2.0 to 3.0 with the pH being adjusted with H₂SO₄. Maintaining the pH of the rinsing solution between a pH of 2.0 to 3.0 inhibits the formation of Fe[OH]₂. After rinsing the stainless steel fibers 90, the stainless steel fibers 90 may be used as cut stainless steel fibers 90 or as stainless steel fiber tow.

FIGS. 14-16 are diagrams illustrating a first through third portions of an apparatus 100 for performing the first improved process 10 of forming fine metallic fibers 90 shown in FIG. 1. The process steps 11-18 are displayed adjacent the respective region of the apparatus 100 accomplishing the respective process step.

FIG. 14 illustrates a plurality of spools 111-114 containing the plurality of metallic wires 20 with the coating material 30. Although FIG. 14 only shows four spools, it should be understood that between 150 to 1200 spools are typically provided in the apparatus 100. The plurality of metallic wires 20 with the coating material 30 are collected by a collar 116 to form the assembly 34 of the plurality of metallic wires 20.

A spool 120 contains the casing material 40 for encasing the assembly 34 of metallic wires 20. The casing material 40 is drawn from the spool 120 by a series of rollers 122. The series of rollers 122 bend the casing material 40 about the assembly 34 of the plurality of the wires 20 with the first edge 41 of the casing material 40 overlapping the second edge 42 of the casing material 42. In the alternative, the series of rollers 122 bend the casing material 40 about the assembly 34 of the plurality of the wires 20 with the first edge 41 of the casing material 40 abutting the second edge 42 of the casing material 42. A welder 124 welds the abutting first and second edges 41 and 42 of the casing material 40.

A spool 130 contains the cladding material 50 for cladding the assembly 34 of metallic wires 20 and the casing material 40. The cladding material 50 is a longitudinally extending cladding material 50 having a first and a second edge 51 and 52. The surface of the cladding material 50 is cleaned by suitable means such as a sandblaster 132. Although the cleaning process has been shown as a sandblaster 132, it should be understood that the surface of the cladding material 50 may be cleaned by other suitable means as should be understood by those skilled in the art.

The surface of the cladding material 50 is treated with a release material 54 to inhibit chemical interaction between the cladding material 50 and the plurality of metallic wires 20 or the casing material 40. In this example, the release material 54 is applied by flame spraying 134 aluminum to the surface of the cladding material 50. The aluminum forms alumina or aluminum oxide that is bonded to the surface of the cladding material 50. In the alternative, the release material 54 may be applied by a plasma gun, painting or any other suitable means. A dryer 136 dries the coated release material 54 on the surface of the cladding material 50.

A series of rollers 142 bends the cladding material 50 to form the continuous tube 55 about the plurality of metallic wires 20 or the casing material 40. In this example, the cladding material 50 is a carbon steel material with the plurality of metallic wires 20 being made of a stainless steel material. The coating material 30 and the casing material 40 are preferably a copper material. The series of rollers 142 bends the first and second edges 51 and 52 of the longitudinally extending sheet of the cladding material 50 to form a cladding 60 for enclosing the casing material 40. The first edge 51 of the cladding material 50 abuts the second edge 52 of the cladding material 50. A welder 144 welds the first edge 51 of the cladding material 50 to the second edge 52 of the cladding material 50 to form the tube 55. The completed cladding 60 is rolled on a spool 146.

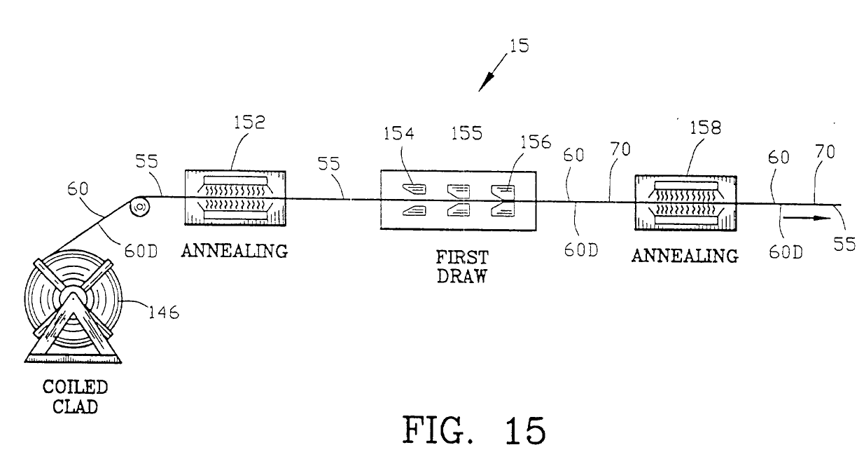

FIG. 15 illustrates the second portion of the apparatus 100 shown in FIG. 1. The cladding 60 unrolled from the spool 146. The cladding 60 is pulled through an annealing oven 152 for annealing the cladding 60.

The cladding 60 is drawn through a series of dies 154-156 for reducing an outer diameter 60D of the cladding 60. In addition, the drawing of the cladding 60 causes the coating materials 30 and the optional casing material 40 to diffusion weld with the coating materials 30 on adjacent metallic wires 20 to form the unitary material 70.

The release material 54 deposited on the cladding material 50 inhibits the chemical interaction or bonding between the tube 55 and a plurality of metallic wires 20 and the coating materials 30 and the casing material 40 within the tube 55.

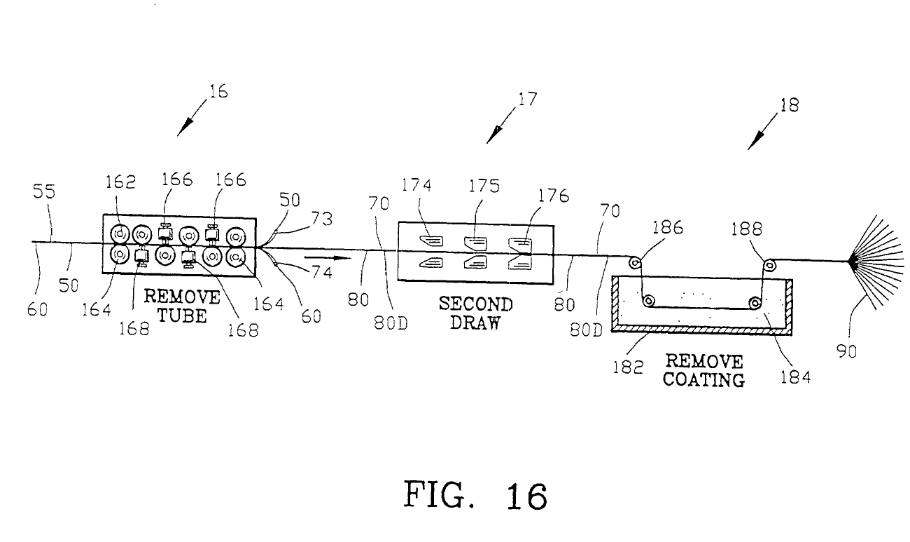

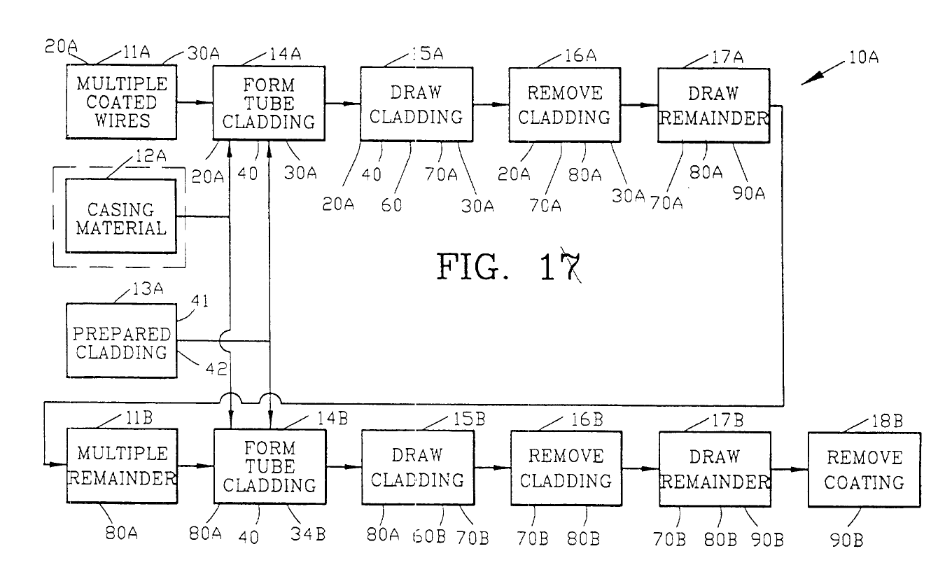

FIG. 16 illustrates the third portion of the apparatus 100 shown in FIG. 1. The tube 55 is passed through a series of upper and lower rollers 162 and 164 for positioning the tube 55 between a series of upper and lower cutting blades 166 and 168. The upper and lower cutting blades 166 and 168 make the scores or cuts 71 and 72 shown in FIG. 11 and 11A in the cladding 60. The tube portions 73 and 74 are mechanically pulled apart to peel the tube 55 off of a remainder 80. The remainder 80 comprises the substantially unitary coating material 70 with the plurality of metallic wires 20 contained therein.

The remainder 80 is drawn through a series of dies 174-176 for reducing an outer diameter 80D of the remainder 80 and for reducing the corresponding outer diameter 20D of the plurality of metallic wires 20 contained therein. The remainder 80 is drawn for reducing the outer diameter 80D of the remainder 80 and for transforming the plurality of metallic wires 20 into a plurality of fine metallic fibers 90.

The plurality of the fine metallic fibers 90 are directed into a reservoir 182 containing a chemical agent 184 by rollers 186 and 188. The chemical agent 184 removes the unitary material 70. Preferably, the chemical agent 184 is an acid for dissolving the unitary material 70 to provide a plurality of metallic fibers 90.

FIG. 17 is a block diagram illustrating a second improved process 10A for making ultra fine metallic fibers that is a variation of the process 10 illustrated in FIG. 1. The initial process steps 11A-17A of the second improved process 10A of FIG. 17 are identical to the initial process steps 11-17 the first improved process 10 of FIG. 1.

The improved process 10A of FIG. 17 comprises the process step 11A of providing multiple coated metallic wires 20A in a manner similar to FIGS. 2 and 2A with each of the metallic wires 20A having a coating material 30A as shown in FIGS. 3 and 3A. The plurality of the metallic wires 20A with the coating material 30A are formed into an assembly 34A of metallic wires 20A.

FIG. 17 illustrates an optional process step 12A of encasing the assembly 34A of metallic wires 20A with a casing material 40. FIGS. 4, 4A, 5 and 5A illustrate similar steps in a first example of the optional process step 12A of encasing the assembly 34A of metallic wires 20A with the casing material 40 to create a first casing 44A. FIGS. 6, 6A, 7 and 7A illustrate similar steps in a second example of the optional process step 12A of encasing the assembly 34A of metallic wires 20A with the casing material 40 to create a first casing 44A.

FIG. 17 illustrates the process step 13A of preparing a cladding material 50 with a release material 54 to inhibit chemical interaction between the cladding material 50 and the plurality of metallic wires 20A or the casing material 40. The release material 54 may be applied in any suitable way and as set forth above.

FIG. 17 illustrates the process step 14A of forming a continuous first tube 55A of the cladding material 50 about the plurality of metallic wires 20A or the casing material 40. FIGS. 8, 8A, 9 and 9A illustrate the process of forming the continuous first tube 55A of the cladding material 50 about the plurality of metallic wires 20A and the casing material 40. The first and second edges 51 and 52 of the cladding material 50 is bent about the plurality of metallic wires 20 and the casing material 40 to form a first cladding 60A.

FIG. 17 illustrates the process step 15A of drawing the first cladding 60A. The process step 15 of drawing the first cladding 60A provides the four effects as set forth above. FIG. 10 illustrates the first cladding 60A after the first drawing process. The drawing of the first cladding 60 causes the diffusion welding of the coating materials 30A on adjacent metallic wires 20A and the casing material 40. The diffusion welding of the coating material 30A and the casing material 40 forms a first unitary material 70A.

FIG. 17 illustrates the process step 16A of mechanically removing the first tube 55A. FIG. 11 shows the mechanical removal of the first tube 55A. The first tube 55A is scored or cut at 71 and 72 by mechanical scorers or cutters and tube portions 73A and 74A are mechanically pulled apart to peel the first tube 55A leaving a first remainder 80A. The first remainder 80A comprises the substantially first unitary material 70 with the plurality of metallic wires 20A contained therein.

FIG. 17 illustrates the process step 17A of drawing the first remainder 80A for reducing the outer diameter 80D thereof and for reducing the corresponding outer diameter 20D of the plurality of metallic wires 20A contained therein. The plurality of wires 20A are reduced into a plurality of fine metallic fibers 90 by the process step 17A of drawing the remainder 80 in a manner similar to FIG. 12.

FIG. 17 illustrates the process step 11B of providing a plurality of the first remainders 80A similar to FIG. 12. The plurality of the first remainders 80A are formed into an assembly 34B. The assembly 34B of the plurality of the first remainders 80A may be encased with the casing material 40.

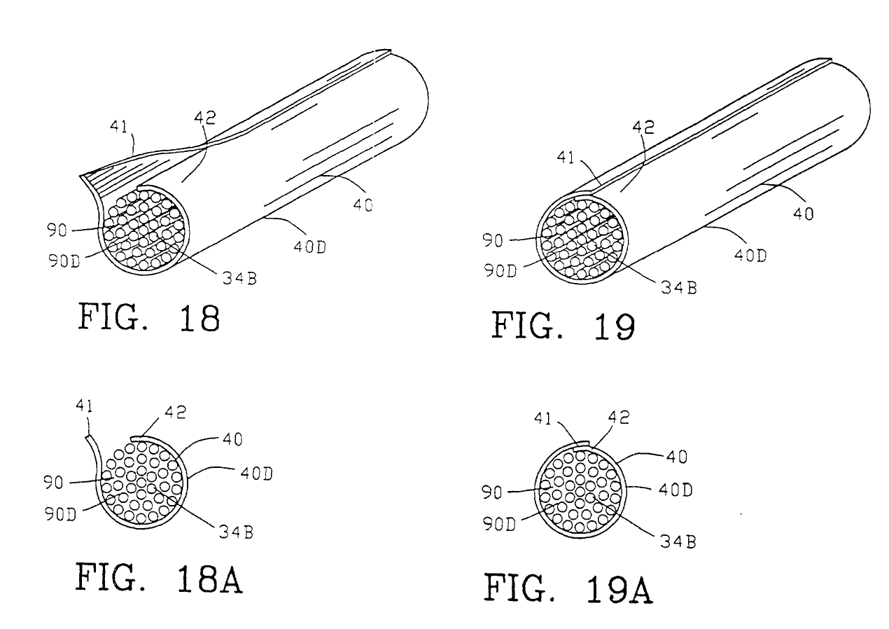

FIGS. 18, 18A, 19 and 19A illustrate the steps in a first example of the optional process of encasing the assembly 34B of the first remainders 80A with the casing material 40 to form a second casing 44B. The first example of the optional process step of encasing the assembly 34B of the first remainders 80A is shown in FIGS. 18, 18A, 19 and 19A is substantially identical to FIGS. 4, 4A, 5 and 5A.

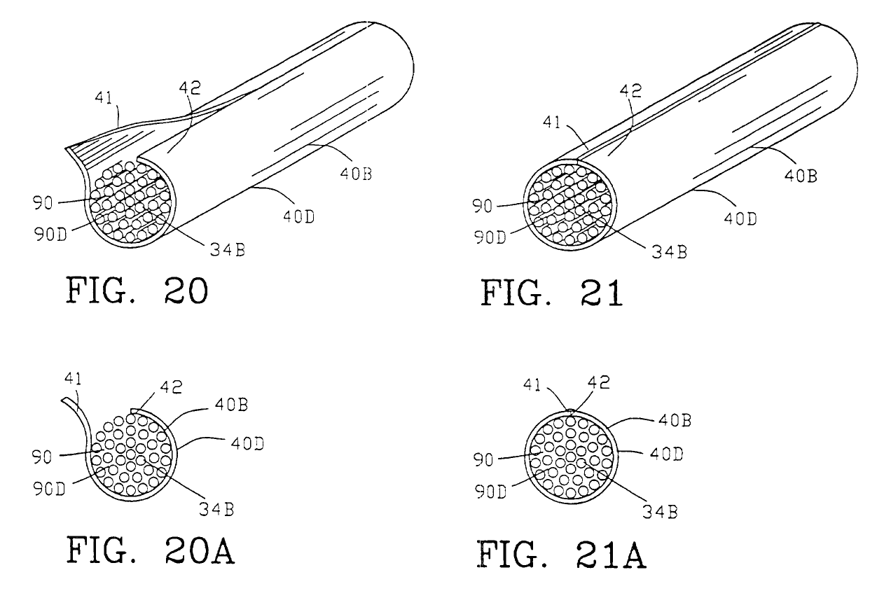

FIGS. 20, 20A, 21 and 21A illustrate the steps in a second example of the optional process of encasing the assembly 34B of the first remainders 80A with the casing material 40 to form a second casing 44B. The second example of the optional process of encasing the assembly 34B of the first remainders 80A in FIGS. 20, 20A, 21 and 21A is substantially identical to FIGS. 6, 6A, 7 and 7A.

FIG. 17 illustrates the process step 13A of preparing a cladding material 50 with a release material 54 to inhibit chemical interaction between the cladding material 50 and the plurality of first remainders 80A or the casing material 40. The process step 13A of preparing a cladding material 50 with a release material 54 is applied prior to the to the process step 14B of forming a second continuous tube 55B of the cladding material 50 about the plurality of the first remainders 80A or the casing material 40.

FIG. 17 illustrates the process step 14B of forming the second continuous tube 55B of the cladding material 50 about the plurality of the first remainders 80A or the casing material 40. The process step 14B of forming the second continuous tube 55B of the cladding material 50 about the plurality of the first remainders 80A or the casing material 40 is substantially identical to the process step 14A of forming the first continuous tube 55A of the cladding material 50 about the plurality of metallic wires 20A and the casing material 40.

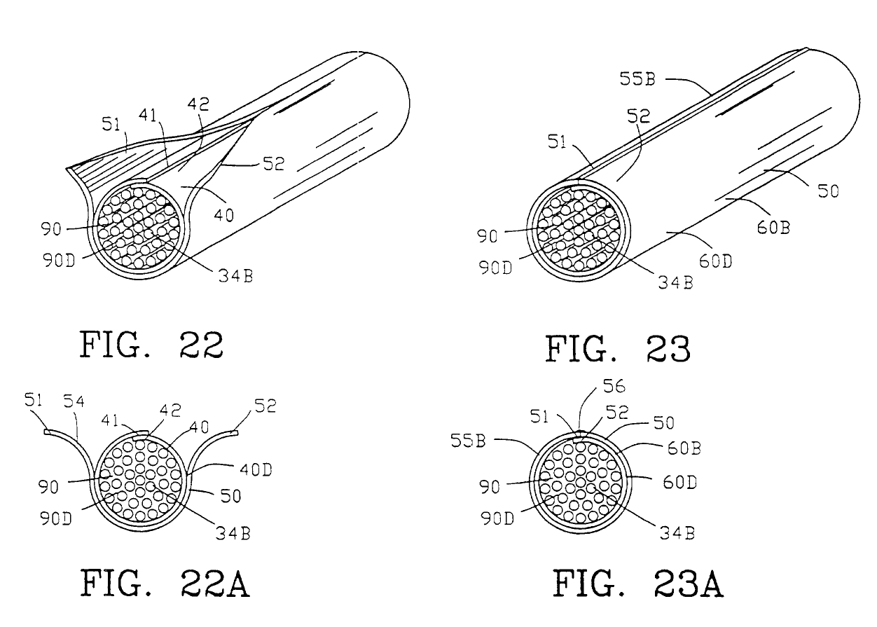

FIGS. 22, 22A, 23 and 23A illustrate the process of forming the second continuous tube 55B of the cladding material 50 about the plurality of first remainders 80A and the casing material 40. The first and second edges 51 and 52 of the cladding material 50 is bent about the plurality of first remainders 80A and the casing material 40 to form a second cladding 60B.

FIG. 17 illustrates the process step 15B of drawing the second cladding 60B. The process step 15 of drawing the second cladding 60B provides the four effects. Firstly, the process step 15B reduces an outer diameter 60D of the second cladding 60B. Secondly, the process step 15B reduces the corresponding outer diameter of each of the plurality of metallic fibers 90 within each of the plurality of first remainders 80A. Thirdly, the process step 15B causes the unitary first material 70A of each of the plurality of first remainders 80A to diffusion weld with the first unitary material 70A of each adjacent plurality of first remainders 80A to form a second unitary material 70B. Fourthly, the process step 15B causes the casing material 40 to diffusion weld with the first unitary material 70A of each adjacent plurality of first remainders 80A.

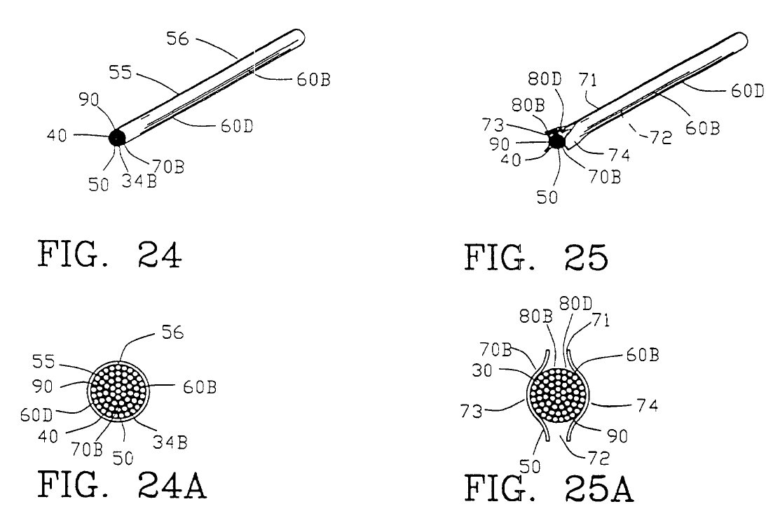

FIGS. 24 and 24A illustrate the second cladding 60B after the third drawing process. The drawing the second cladding 60B causes the diffusion welding of the first unitary material 70A on the adjacent first remainders 80A and the casing material 40. The diffusion welding of the first unitary material 70A on the adjacent first remainders 80A and the casing material 40 forms the second unitary material 70B.

FIGS. 25 and 25A show the mechanical removal of the second tube 55B illustrated by the process step 16B of FIG. 17. The second tube 55B is scored or cut at 71 and 72 by mechanical scorers or cutters and tube portions 73B and 74V are mechanically pulled apart to peel the second tube 55B leaving a second remainder 80B. The second remainder 80B comprises the substantially second unitary material 70B with the plurality of metallic fibers 90 contained therein.

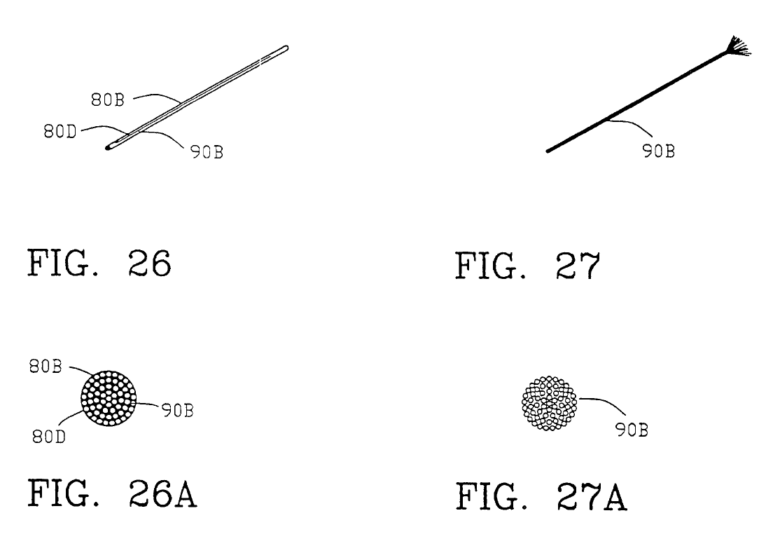

FIG. 26 is an isometric view of the plurality of fibers 90 of FIG. 25 reduced to a plurality of ultra fine metallic fibers 90B by the process step 17B of drawing the second remainder 80B. FIG. 26A is an enlarged end view of FIG. 26. The drawing of the second remainder 80B reduces the outer diameter 80D thereof and reduces the corresponding outer diameter 90D of the plurality of metallic fibers 90 contained therein.

FIG. 27 is an isometric view of the plurality of the ultra fine metallic fibers 90B of FIG. 26 after the process step 18B shown in FIG. 17 of removing the second unitary material 70B. FIG. 27A is an enlarged end view of FIG. 27. Preferably, the second unitary material 70B is removed by an acid leaching process for dissolving the second unitary material 70B to provide a plurality of ultra fine metallic fibers 90B. One example of the process step 18B includes an acid leaching process as set forth heretofore with reference to the process step 18.

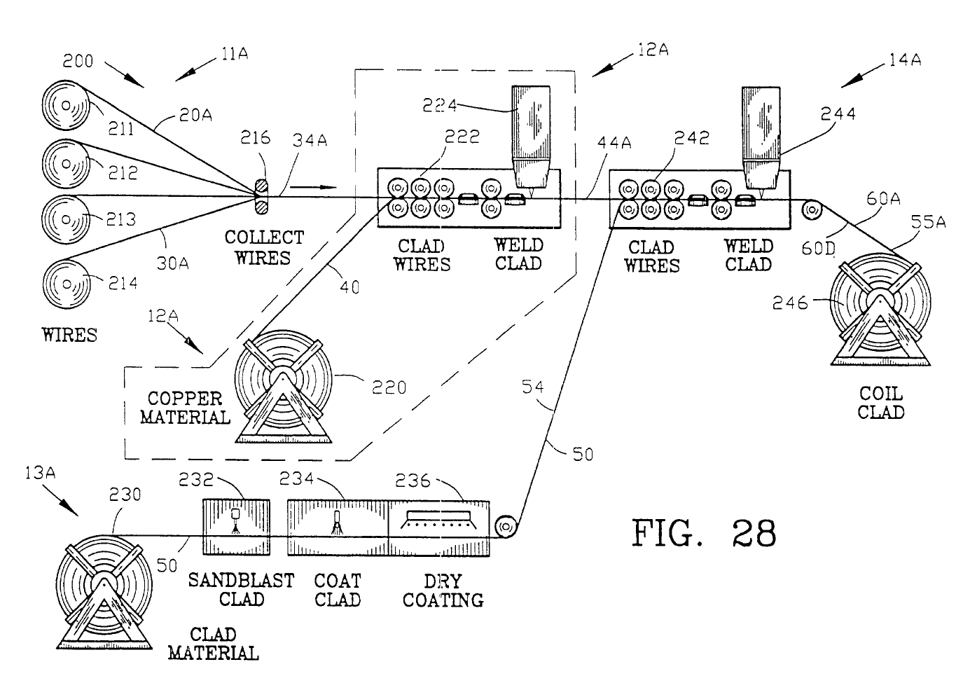

FIGS. 28-33 are diagrams illustrating a first through sixth portions of an apparatus 200 for performing the first improved process 10A of forming the ultra fine metallic fibers 90B shown in FIG. 17. The process steps 111A-17A and 11B-18B are displayed adjacent the respective region of the apparatus 200 accomplishing the respective process step.

FIG. 28 illustrates a plurality of spools 211-214 containing the plurality of metallic wires 20A with the coating material 30A. Although FIG. 28 only shows four spools, it should be understood that between 150 and 1200 spools are typically provided in the apparatus 200. The plurality of metallic wires 20A with the coating material 30A are collected by a collar 216 to form the first assembly 34A of the plurality of metallic wires 20A.

A spool 220 contains the casing material 40 for encasing the first assembly 34A of metallic wires 20A. The casing material 40 is drawn from the spool 220 by a series of rollers 222. The series of rollers 222 bend the casing material 40 about the first assembly 34A of the plurality of the wires 20A with the first edge 41 of the casing material 40 overlapping the second edge 42 of the casing material 42 to form a first casing 44A similar to FIGS. 4, 4A, 5 and 5A. In the alternative, the series of rollers 222 bend the casing material 40 about the first assembly 34A of the plurality of the wires 20A with the first edge 41 of the casing material 40 abutting the second edge 42 of the casing material 42. A welder 224 welds the abutting first and second edges 41 and 42 of the casing material 40 to form the first casing 44A similar to FIGS. 6, 6A, 7, and 7A.

A spool 230 contains the cladding material 50 for cladding the first assembly 34A of metallic wires 20A and the casing material 40. The cladding material 50 is a longitudinally extending cladding material 50 having a first and a second edge 51 and 52. The surface of the cladding material 50 is cleaned by suitable means such as a sandblaster 232. Although the cleaning process has been shown as a sandblaster 232, it should be understood that the surface of the cladding material 50 may be cleaned by other suitable means as should be understood by those skilled in the art.

The surface of the cladding material 50 is treated with a release material 54 to inhibit chemical interaction between the cladding material 50 and the plurality of metallic wires 20A or the casing material 40. In this example, the release material 54 is applied by flame spraying 234 aluminum to the surface of the cladding material 50. The aluminum forms alumina or aluminum oxide that is bonded to the surface of the cladding material 50. In the alternative, the release material 54 may be applied by a plasma gun, painting or any other suitable means. A dryer 236 dries the coated release material 54 on the surface of the cladding material 50.

A series of rollers 242 bends the cladding material 50 to form the continuous first tube 55A about the plurality of metallic wires 20A or the casing material 40. In this example, the cladding material 50 is a carbon steel material with the plurality of metallic wires 20A being made of a stainless steel material. The coating material 30A and the casing material 40 are preferably a copper material. The series of rollers 242 bends the first and second edges 51 and 52 of the longitudinally extending sheet of the cladding material 50 to form a first cladding 60A for enclosing the casing material 40. The first edge 51 of the cladding material 50 abuts the second edge 52 of the cladding material 50. A welder 244 welds the first edge 51 of the cladding material 50 to the second edge 52 of the cladding material 50 to form the first tube 55A. The completed first cladding 60A is rolled on a spool 246.

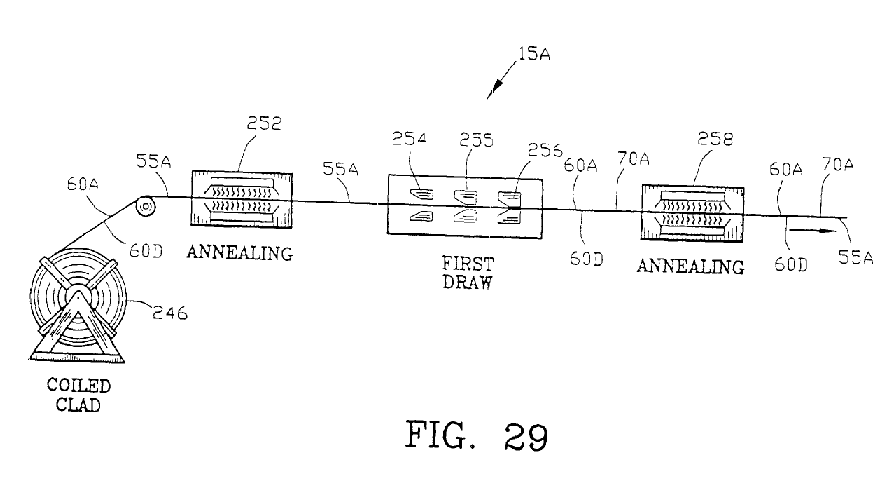

FIG. 29 illustrates the second portion of the apparatus 200 for performing the first improved process 10A shown in FIG. 17. The first cladding 60A is unrolled from the spool 246 and is pulled through an annealing oven 252 for annealing the first cladding 60A.

The first cladding 60A is drawn through a series of dies 254-256 for reducing an outer diameter 60D of the first cladding 60A. In addition, the drawing of the first cladding 60A causes the coating materials 30A and the optional casing material 40 to diffusion weld with the coating materials 30A on adjacent metallic wires 20A to form the first unitary material 70A.

The release material 54 deposited on the cladding material 50 inhibits the chemical interaction or bonding between the first tube 55A and a plurality of metallic wires 20A and the coating materials 30A and the casing material 40 within the first tube 55A. The first cladding 60A is pulled through an annealing oven 258 for annealing the first cladding 60A.

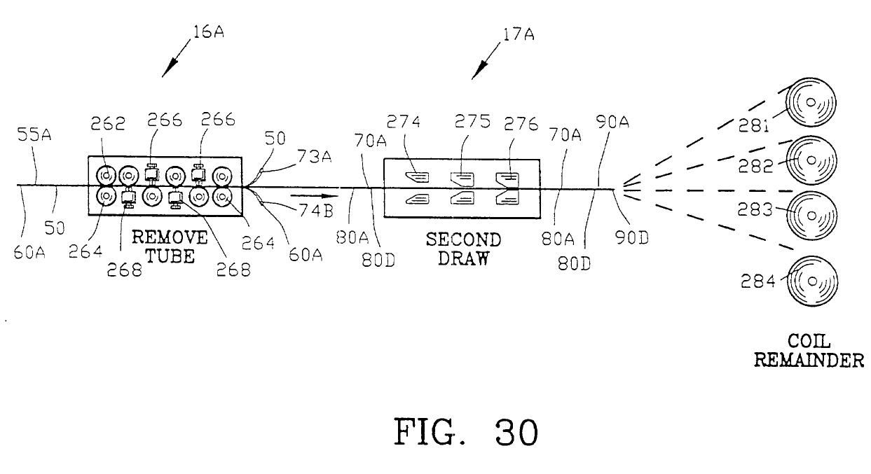

FIG. 30 illustrates the third portion of the apparatus 200 for performing the first improved process 10A shown in FIG. 17. The first tube 55A is passed through a series of upper and lower rollers 262 and 264 for positioning the first tube 55A between a series of upper and lower cutting blades 266 and 268. The upper and lower cutting blades 266 and 268 make the scores or cuts 71 and 72 similar to FIGS. 11 and 11A in the first cladding 60A. The tube portions 73A and 74A are mechanically pulled apart to peel the first tube 55A leaving a first remainder 80A. The first remainder 80A comprises the substantially first unitary material 70A with the plurality of metallic wires 20 contained therein.

The first remainder 80A is drawn through a series of dies 274-276 for reducing an outer diameter 80D of the first remainder 80A and for reducing the corresponding outer diameter 20D of the plurality of metallic wires 20 contained therein. The first remainder 80A is drawn for reducing the outer diameter 80D of the first remainder 80A and for transforming the plurality of metallic wires 20 into a plurality of fine metallic fibers 90A. The first remainder 80A is rolled onto a plurality of spool 281-284.

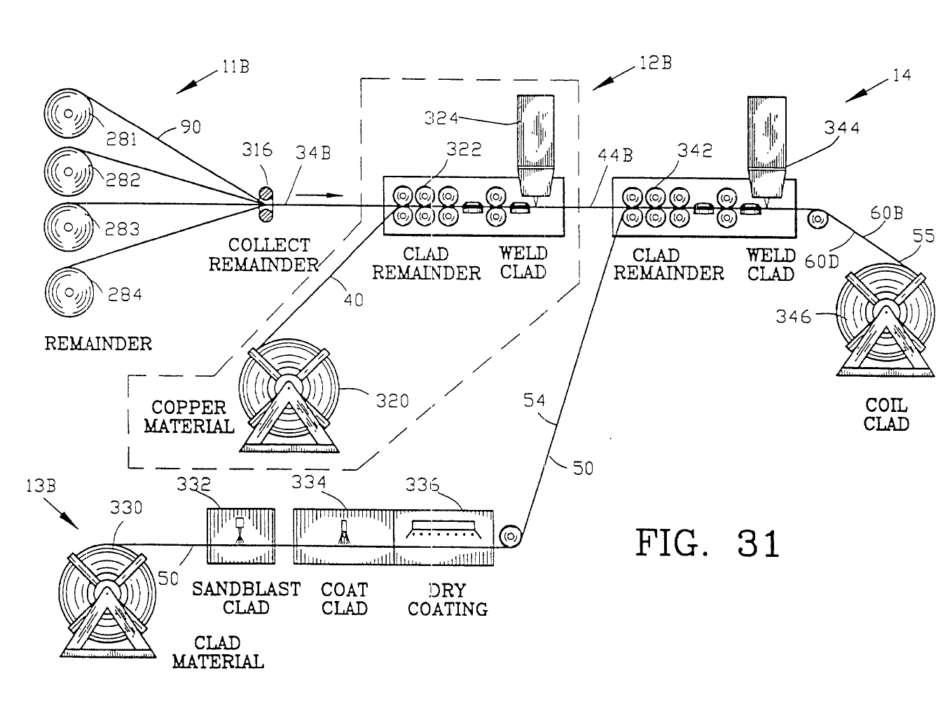

FIG. 31 illustrates the fourth portion of the apparatus 200 for performing the first improved process 10A shown in FIG. 17. Although FIG. 31 only shows four spools containing the plurality of first remainders 80A, it should be understood that between 170 and 1200 spools are typically provided in the apparatus 200. The plurality of first remainders 90A are collected by a collar 316 to form a second assembly 34B of the plurality of first remainders 90A.

A spool 320 contains the casing material 40 for encasing the second assembly 34B of first remainders 90A. The casing material 40 is drawn from the spool 320 by a series of rollers 322. The series of rollers 322 bend the casing material 40 about the second assembly 34B of the first remainders 90A with the first edge 41 of the casing material 40 overlapping the second edge 42 of the casing material 42 to form a second casing 44B shown in FIGS. 18, 18A, 19 and 19A. In the alternative, the series of rollers 322 bend the casing material 40 about the second assembly 34B of the plurality of the first remainders 90A with the first edge 41 of the casing material 40 abutting the second edge 42 of the casing material 42. A welder 324 welds the abutting first and second edges 41 and 42 of the casing material 40 to form the second casing 44B shown in FIGS. 21, 21A, 22 and 23A.

A spool 330 contains the cladding material 50 for cladding the second assembly 34B of the plurality of the first remainders 90A and the casing material 40. The cladding material 50 is a longitudinally extending cladding material 50 having a first and a second edge 51 and 52. The surface of the cladding material 50 is cleaned by suitable means such as a sandblaster 332. The release material 54 is applied by flame spraying 334 aluminum to the surface of the cladding material 50. A dryer 336 dries the coated release material 54 on the surface of the cladding material 50.

A series of rollers 342 bends the cladding material 50 to form the continuous second tube 55B about the plurality of the first remainders 90A or the casing material 40. In this example, the cladding material 50 is a carbon steel material with the plurality of the first remainders 90A being made of a stainless steel material. The series of rollers 342 bends the first and second edges 51 and 52 of the longitudinally extending sheet of the cladding material 50 to form a second cladding 60B for enclosing the casing material 40. A welder 344 welds the first edge 51 of the cladding material 50 to the second edge 52 of the cladding material 50 to form the second tube 55B. The completed first cladding 60A is rolled on a spool 346.

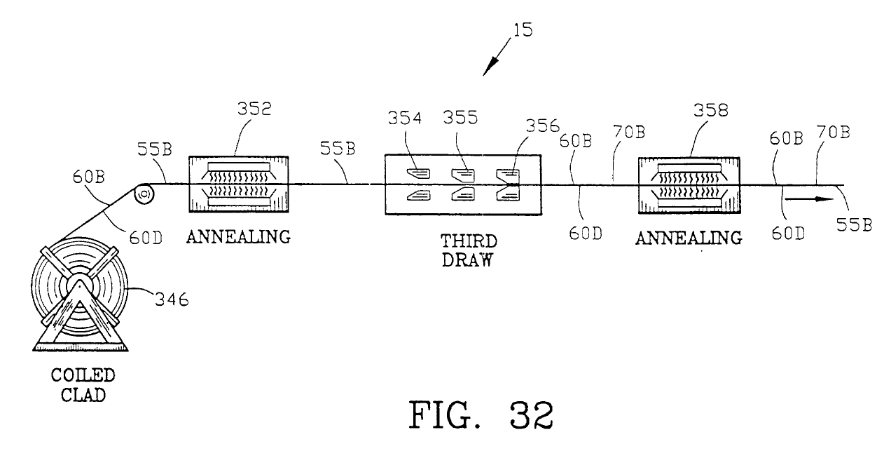

FIG. 32 illustrates the fifth portion of the apparatus 200 for performing the first improved process 10A shown in FIG. 17. The second cladding 60B is unrolled from the spool 346 and is pulled through an annealing oven 352 for annealing the second cladding 60B.

The second cladding 60B is drawn through a series of dies 354-356 for reducing an outer diameter 60D of the second cladding 60B and to form a second unitary material 70B. The second cladding 60B is pulled through an annealing oven 358 for annealing the second cladding 60B.

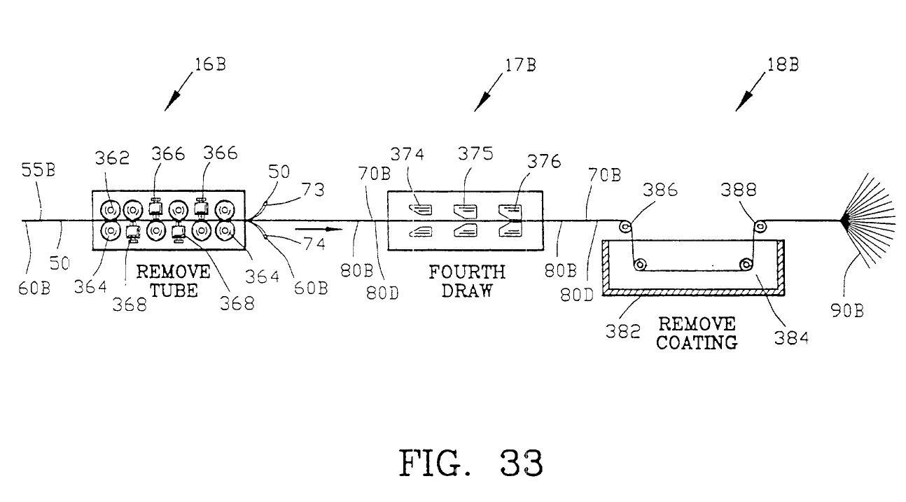

FIG. 33 illustrates the sixth portion of the apparatus 200 for performing the first improved process 10A shown in FIG. 17. The second tube 55B is passed through a series of upper and lower rollers 362 and 364 for positioning the second tube 55B between a series of upper and lower cutting blades 366 and 368. The upper and lower cutting blades 366 and 368 make the scores or cuts 71 and 72 as shown in FIGS. 25 and 25A in the second cladding 60B. The tube portions 73B and 74B are mechanically pulled apart to peel the second tube 55B leaving a second remainder 80B. The second remainder 80B comprises the second unitary material 70B with the plurality of metallic fibers 90A contained therein.

The second remainder 80B is drawn through a series of dies 374-376 for reducing an outer diameter 80D of the second remainder 80B and for transforming the plurality of fine metallic fibers 90A into a plurality of ultra fine metallic fibers 90B.

The plurality of the ultra fine metallic fibers 90B are directed into a reservoir 382 containing a chemical agent 384 by rollers 386 and 388. The chemical agent 384 removes the second unitary material 70B. Preferably, the chemical agent 384 is an acid for dissolving the second unitary material 70B to provide a plurality of ultra fine metallic fibers 90B.

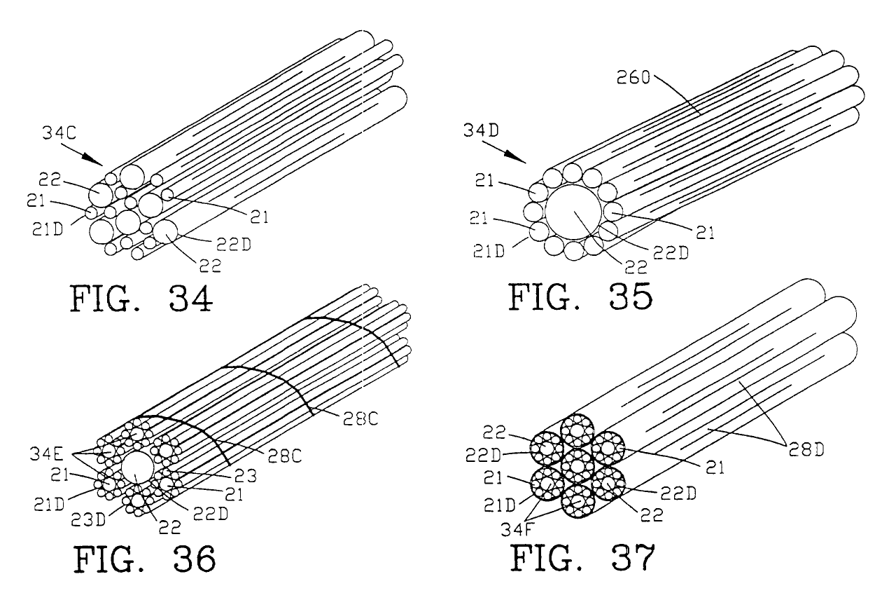

FIG. 34 is an isometric view of a second example of an assembly 34C of a plurality of first and second metallic wires 21 and 22. The first metallic wires 21 have a first diameter 21D whereas the second metallic wires 22 have a second diameter 22D. The first and second metallic wires 21 and 22 may be of the same composition or the first metallic wires 21 may be of a different composition than the second metallic wire 22. The first and second metallic wires 21 and 22 form a mixed assembly 34C suitable for use as the assemblies 34 set forth in FIGS. 1-27. In this example, the first and second metallic wires 21 and 22 are randomly located within the assembly 34C.

FIG. 35 is an isometric view of a third example of an assembly 34D of a plurality of first and second metallic wires 21 and 22. The first metallic wires 21 have a first diameter 21D whereas the second metallic wires 22 have a second diameter 22D. In this example, the ratio of the first and second metallic wires 21 and 22 is altered relative to the assembly 34C of FIG. 34.

In addition, the plurality of first and second metallic wires 21 and 22 are twisted to form a strand. The strand comprises a twisted assembly 34D of the plurality of first and second metallic wires 21 and 22. Preferably, the first and second metallic wires 21 and 22 are twisted into a helical pattern to provide the strand at the rate of 1.5 turns per 2.5 centimeters. The strand 260 may be coiled for example on a spool (not shown) for temporary storage. A multiplicity of the strands 260 may be collected from a multiplicity of the spools (not shown) for forming an array of the strands 260. The array of the strands 260 may be used during the process step 14 of FIG. 1 or 17.

FIG. 36 is an isometric view of a fourth example of an array of assemblies 34E of a first, a second and a third coated metallic wire 21, 22 and 23. The first metallic wires 21 have a first diameter 21D, the second metallic wires 22 have a second diameter 22D and the third metallic wires 23 have a third diameter 23D. In this example, each of the array of the assemblies 34E are bound with a wrapping material 28C for maintaining the integrity of the assembly 34E during the process step 12 in FIGS. 1 and 17. Preferably, the wrapping material 28C is the same material as the coating materials 31 and 32.

FIG. 37 is an isometric view of a fifth example of an array of assemblies 34F of the first, second and third plurality of metallic wires 21, 22 and 23. In this example, a wrapping material 28D binds each of the plurality of assemblies 34F of the first, second and third coated metallic wires 21, 22 and 23. The wrapping material 28D is shown as a continuous sheet of wrapping material 28D for providing a plurality of bound assemblies 34F. Preferably, the wrapping material 28D is made from the same material as the coating materials 31 and 32.

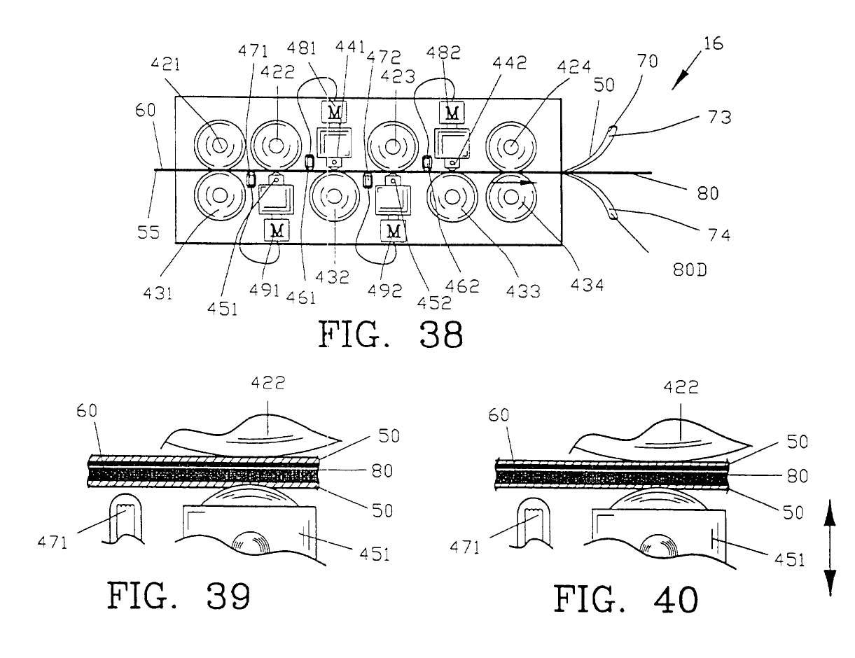

FIG. 38 is an enlarged view of a portion of FIGS. 16, 30 and 33 illustrating a variable cutting assembly for scoring or cutting the cladding material 50. In this embodiment, a series, of upper rollers 421-424 and a series of lower rollers 431-434 position the tube 55 between a series of upper cutting blades 441 and 442 and a series of lower cutting blades 451 and 452.

A series of upper sensors 461 and 462 are located adjacent and upstream from the series of the upper cutting blades 441 and 442. A series of lower sensors 471 and 472 are located adjacent and upstream from the series of lower cutting blades 451 and 452. The upper sensors 461 and 464S are connected through positioners 481 and 482 for controlling the vertical positions of the upper cutting blades 441 and 442. The lower sensors 471 and 472 are connected through positioners 491 and 492 for controlling the vertical positions of the lower cutting blades 451 and 452.

FIGS. 39 and 40 are enlarged views of a portion of FIG. 38 illustrating the upper cutting blades 441 and 442 and the lower cutting blades 451 and 452 in a first and a second position. As the tube 55 passes through the series of upper rollers 421-424 and the lower rollers 431-434, the upper sensors 461 and 462 and the lower sensors 471 and 472 sense the thickness of the upper and lower cladding material 50 of the cladding 60. The upper sensors 461 and 462 actuate the positioners 481 and 482 to adjust the vertical positions of the upper cutting blades 441 and 442 in accordance with the thickness of the upper cladding material 50 of the cladding 60. Similarly, the lower sensors 471 and 472 actuate the positioners 491 and 492 to adjust the vertical positions of the lower cutting blades 451 and 452 in accordance with the thickness of the lower cladding material 50 of the cladding 60.

The invention provides an apparatus and process for constructing fine and ultra fine metallic fibers. A typical example may include the initial cladding of 1200 stainless steel wires each having a diameter of 0.010. The assembly of the 1200 stainless steel wires is drawn to a remainder diameter of 0.009 inches. Thereafter, a second cladding of 1200 remainders is assembled and draw as heretofore described. Reducing second cladding to an overall diameter to 0.006 inches will produce ultra-fine fiber having a diameter of 0.06 microns.

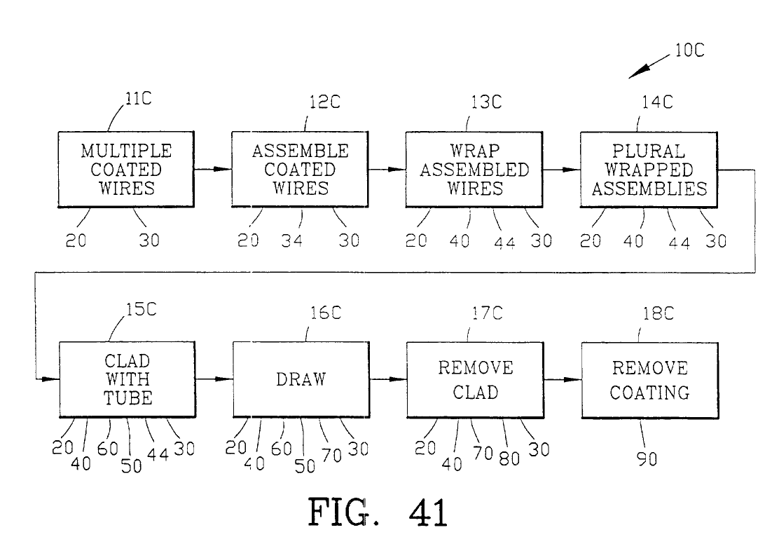

FIG. 41 is a block diagram illustrating a third improved process 10C for making fine metallic fibers that is a variation of the process 10 illustrated in FIG. 1. The improved process 10C of FIG. 41 comprises the process step 11C of providing a multiplicity of coated metallic wires 20 with each of the metallic wires 20 having a coating material 30.

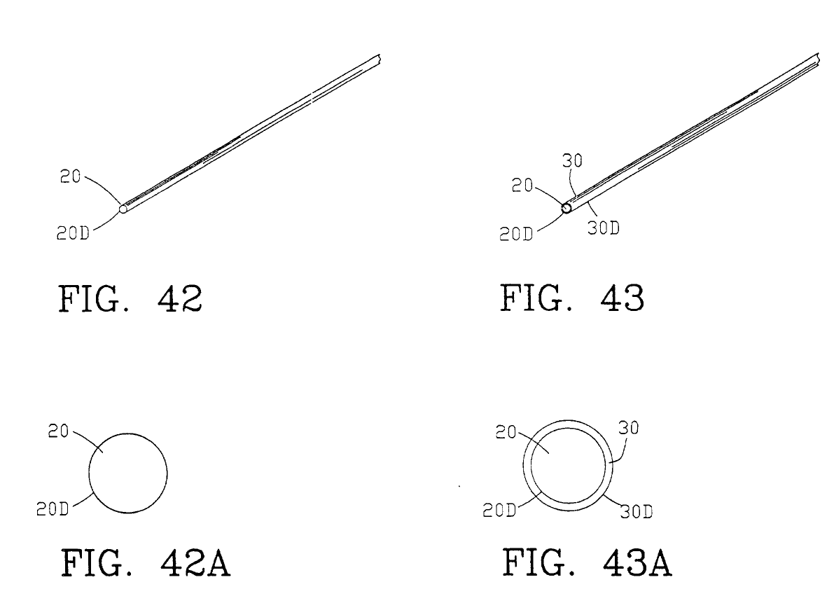

FIG. 42 is an isometric view of the metallic wire 20 referred to in FIG. 41 with FIG. 42A being an enlarged end view of FIG. 42. In this example, the metallic wire 20 is a stainless steel wire having a diameter 20D but it should be understood that various types of metallic wires 20 may be used in the improved process 10.

FIG. 43 is an isometric view of the metallic wire 20 of FIG. 42 with the coating material 30 thereon. FIG. 43A is an enlarged end view of FIG. 43. In this example, the coating material 30 is a copper material but it should be understood that various types of coating materials 30 may be used in the improved process 10C. The process of applying the coating material 30 to the metallic wire 20 may be accomplished in various ways as set forth previously. Preferably, the process of applying the coating material 30 to the metallic wire 20 is accomplished by an electroplating process.

FIG. 41 illustrates the process step 12C of arranging a multiplicity of metallic wires 20 to form an assembly 34 of the metallic wires 20. The multiplicity of metallic wires 20 are arranged in a parallel relationship with the multiplicity of metallic wires 20 being in contact with adjacent metallic wires 20. The assembly 34 of the metallic wires 20 defines an outer diameter 34D. Preferably, 150 to 1200 metallic wires 20 with the coating material 30 are arranged into the assembly 34. In one example of the invention, 425 metallic wires 20 with the coating material 30 are arranged into the assembly 34.

FIG. 41 illustrates the process step 13C of wrapping the assembly 34 of the metallic wires 20 with a wrapping material 40 to form a wrapped assembly 44. The metallic wires 20 with a wrapping material 40 to form a tightly wrapped or wrapped assembly 44 of the metallic wires 20.

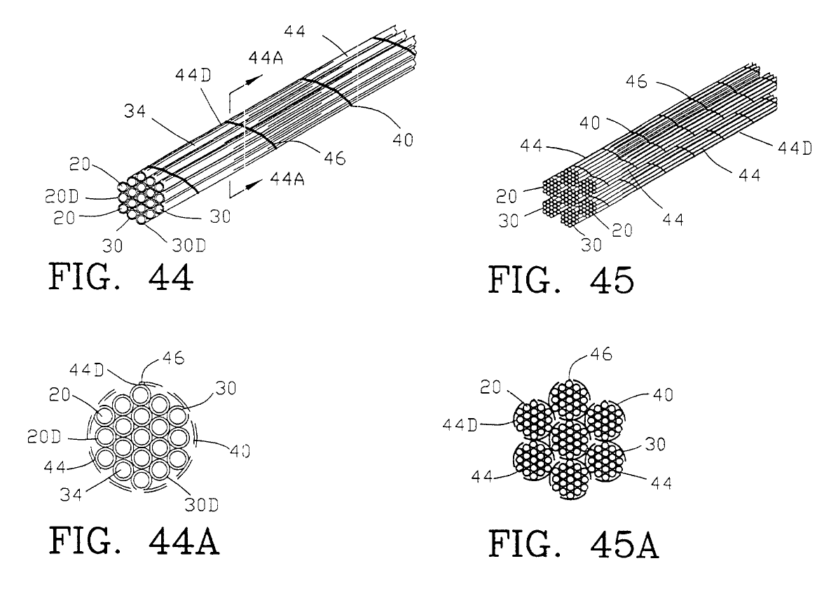

FIG. 44 is an isometric view of the assembly 34 of the multiplicity of metallic wires 20 wrapped with the wrapping material 40 forming a wrapped assembly 44. FIG. 44A is an enlarged end view of FIG. 44. In this example, the wrapping material 40 comprises a metallic stranding wire 46 wound about the assembly 34 of the metallic wires 20. The metallic stranding wire 46 is helically wrapped about the assembly 34 of the metallic wires 20 under tension for maintaining the assembly 34 of the metallic wires 20 in a tightly wrapped assembly 44. The metallic stranding wire 46 wraps the tightly wrapped assembly 44 to have a substantially circular cross-section defining an outer diameter 44D. Preferably, the wrapping material 40 is the same material as the coating material 30.

FIG. 41 illustrates the process step 14D of collecting a plurality of wrapped assemblies 44 of the metallic wires 20. The plurality of wrapped assemblies 44 of the metallic wires 20 are arranged in a parallel relationship.

FIG. 45 is an isometric view of the plurality of wrapped assemblies 44 of the metallic wires 20. FIG. 45A is an enlarged end view of FIG. 45. The metallic stranding wire 46 is helically wrapped about each of the wrapped assemblies 44 under tension for maintaining the wrapped assembly 44 in the substantially circular cross-section.

FIG. 41 illustrates the process step 15C of cladding the plurality of the wrapped assemblies 44 with a cladding material 50. Preferably, the plurality of the wrapped assemblies 44 are simultaneously enclosed within a tube 55 made from the cladding material 50.

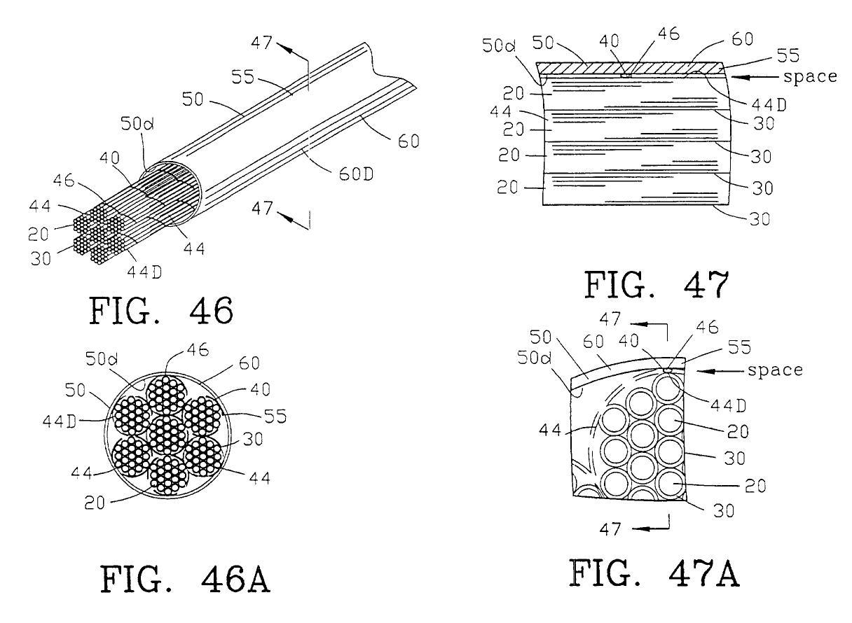

FIG. 46 is an isometric view of the plurality of the bound assemblies 44 being partially clad with the cladding material 50. FIG. 46A is an enlarged end view of FIG. 46. In this example, the plurality of the wrapped assemblies 44 are simultaneously inserted within the tube 55. Preferably, the cladding material 50 is formed into a longitudinally extending tube 55 with an inner diameter 50d being treated with a release material 54 as heretofore describe. In this example of the invention, the plurality of the wrapped assemblies 44 are inserted into a preformed tube 55. In the alternative, a continuous tube 55 may be formed about the plurality of the wrapped assemblies 44 as heretofore described with reference to FIGS. 4-9 and 18-23.

FIGS. 47 and 47A are magnified views of a portion of FIGS. 46 and 46A. The stranding wire 46 wrapped about the wrapped assembly 44 functions in five different ways. Firstly, the stranding wire 46 maintains the multiplicity of the metallic wires 20 in a tightly wrapped assembly 44. The tightly wrapped assembly 44 prevents the multiplicity of wires 20 from springing apart due to the memory of the wires 20 from being stored on a spool. The tightly wrapped assembly 44 creates a space between the outer diameter 44D of each of the plurality of the wrapped assemblies 44 and the inner diameter 50d of the cladding material 50 as indicated in FIGS. 47 and 47A.

Secondly, the stranding wire 46 binds the wrapped assembly 44 of the metallic wires 20 in a tightly wrapped assembly 44 enabling more of the metallic wires 20 to be inserted into a preformed tube 55. Although, it would appear that more metallic wires 20 could be inserted into a preformed tube 55 when the metallic wires 20 are uniformly distributed as shown in FIGS. 4-9 and 18-23, it has been found that seven wrapped assemblies 44 distributed as shown in FIGS. 45-48 enable more metallic wires 20 to be inserted into the preformed tube 55. This result is totally unexpected.

Thirdly, the use of a plurality of wrapped assemblies 44 greatly simplifies the cladding process. For example, seven wrapped assemblies 44 with each of the seven wrapped assemblies 44 having 425 metallic wires 20 will insert 2975 wire within the cladding 60. The insertion of seven wrapped assemblies 44 into the cladding 60 is less difficult than inserting 2975 wire within the cladding 60.

Fourthly, the stranding wire 46 maintains the wrapped assembly 44 of the metallic wires 20 in a tightly wrapped assembly 44 to prevent any wire 20 from interfering with the welding process when a continuous tube 55 is formed about the plurality of the wrapped assemblies 44 as heretofore described with reference to FIGS. 4-9 and 18-23.

Fifthly, the metallic stranding wire 46 interposed between outer diameter 44D of the plurality of the wrapped assemblies 44 and the inner diameter 50d of the cladding material 50 reduces the friction between each of the plurality of the wrapped assemblies 44 and the inner diameter 50d of the cladding material 50. The reduced friction between each of the plurality of the wrapped assemblies 44 and the inner diameter 50d of the cladding material 50 facilitates the insertion and movement of the plurality of the wrapped assemblies 44 within the formed cladding 60.

FIG. 48 is an isometric view similar to FIG. 46 illustrating the complete insertion of the plurality of the wrapped assemblies 44 within the preformed tube 55 for providing the cladding 60. FIG. 48A is a magnified view of a portion of FIG. 48. The cladding 60 defines an outer diameter 60D. The stranding wires 46 maintain the tightly wrapped assemblies 44 in a substantially circular cross-section.

FIG. 41 illustrates the process step 16C of drawing the cladding 60. The process step 16C of drawing the cladding 60 reduces the outer diameter 60D of the cladding 60 and reduces the diameters 20D of each of the multiplicity of metallic wires 20 within the cladding 60.

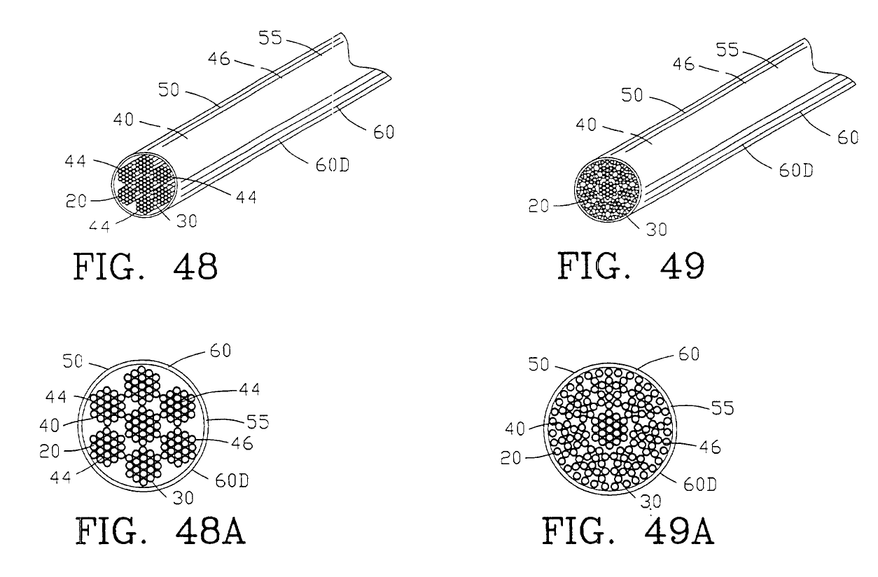

FIG. 49 is an isometric view similar to FIG. 48 illustrating an initial tightening of the cladding 60 about the plurality of the wrapped assemblies 44. FIG. 49A is a magnified view of a portion of FIG. 49. The drawing process 16C includes an initial tightening of the cladding 60 about the plurality of the wrapped assemblies 44. During the initial drawing of the cladding 60, the substantially circular cross-section the plurality of wrapped assemblies 44 shown in FIGS. 44-48 is changed to the substantially homogeneous arrangement shown in FIG. 49.

The drawing process 16C reduces the outer diameter 60D of the cladding 60 and reduces the corresponding outer diameter 20D of each of the plurality of metallic wires 20 and the corresponding outer diameter 30D of each of the coating materials 30. The drawing process 16C transforms the multiplicity of metallic wires 20 into a multiplicity of fine metallic fibers.

The drawing process 16C causes the coating materials 30 on each of metallic wires 20 to diffusion weld with the coating materials 30 on adjacent metallic wires 20. The drawing process 16C causes the wrapping material 40 to diffusion weld with the coating material 30 on the plurality of metallic wires 20. The diffusion welding of the coating material 30 and the wrapping material 40 forms a unitary material.

FIG. 41 illustrates the process step 17C of removing the cladding 60. In the preferred form of the process, the step 17C of removing the cladding 60 may comprise either mechanically or chemically removing the cladding 60.

FIG. 50 is an isometric view after the removal of the cladding 60 of FIG. 49 to provide a remainder 80. FIG. 50A is an enlarged end view of FIG. 50. After the diffusion welding, the coating material 30 and the wrapping material 40 form the substantially unitary material 70. The remainder 80 contains the substantially unitary material 70 containing the plurality of metallic fibers 90. Preferably, the coating material 30 and the wrapping material 40 are both a copper material.

The remainder 80 may be drawn to further reduce the cross-section 80D thereof and for reducing the diameter of the plurality of metallic fibers 90 contained therein. The substantially unitary material 70 provides mechanical strength for enabling the remainder 80 to be drawn without the cladding 60.

FIG. 41 illustrates the process step 18C of removing the unitary material 70. After the removal of the unitary material 70, the plurality of metallic fibers 90 may be used for a variety of different purposes.

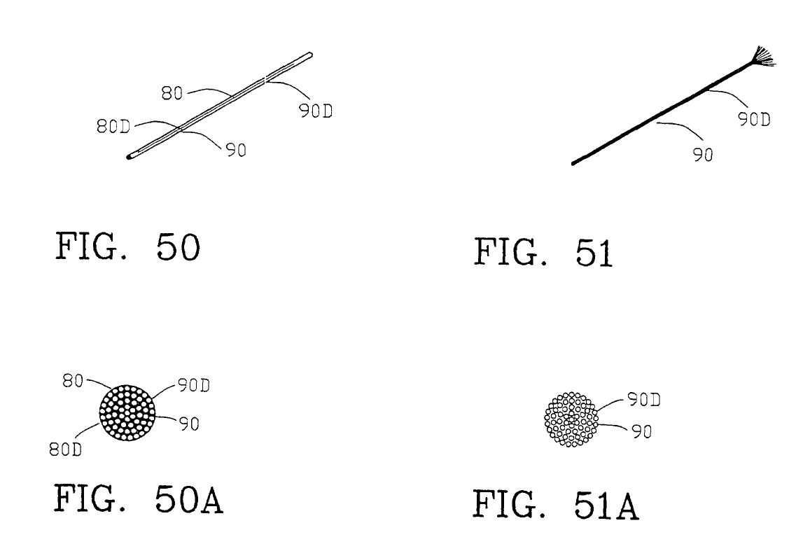

FIG. 51 is an isometric view of the plurality of the fine metallic fibers 90 of FIG. 50 after the process step 18C of removing the unitary material 70. FIG. 51A is an enlarged end view of FIG. 51. Preferably, the unitary material 70 is removed by an acid leaching process for dissolving the unitary copper material 70 to provide a plurality of metallic fibers 90. One example of the process step 18 includes an acid leaching process as heretofore described.

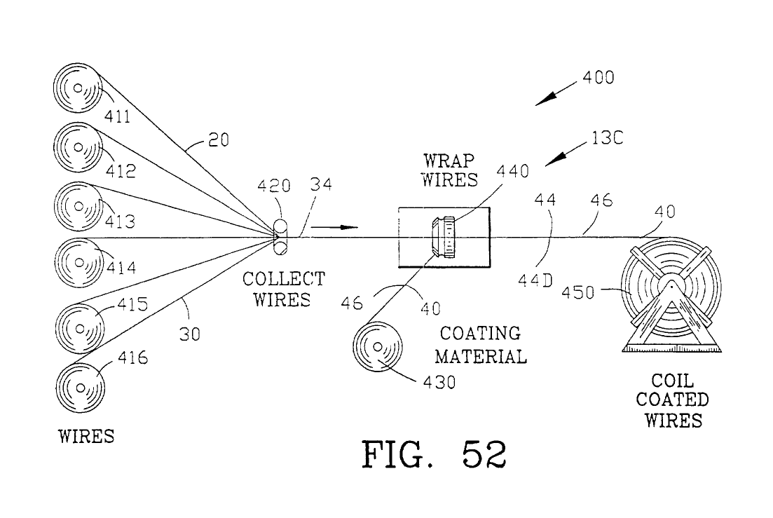

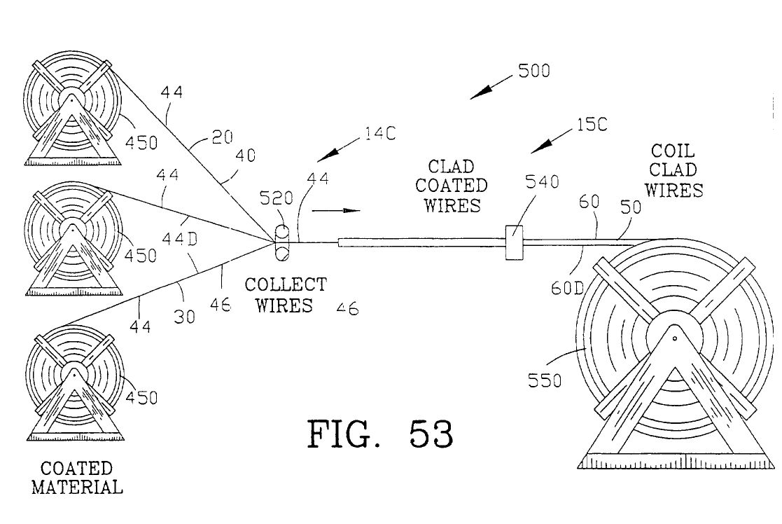

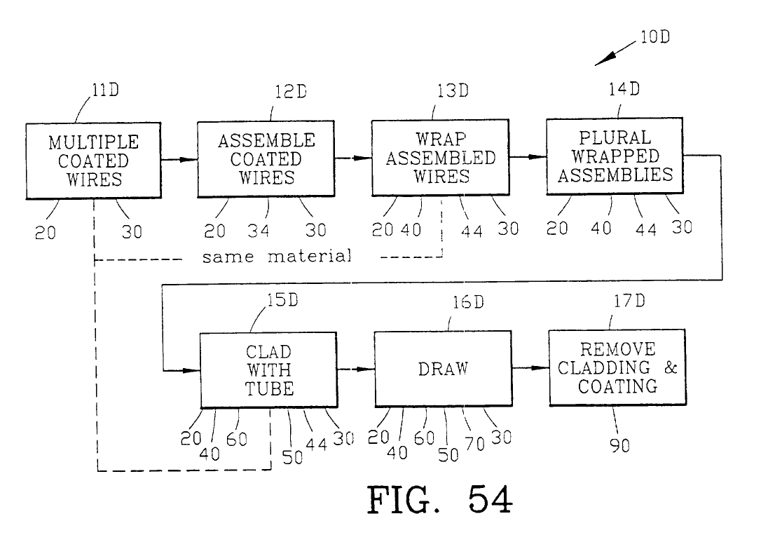

FIG. 52 is a diagram illustrating an apparatus 400 performing the process steps 13C-14C of the third process 10C of forming fine metallic fibers 90 shown in FIG. 41. The apparatus 400 wraps the multiplicity of the metallic wires 20 with the wrapping material 40.

A plurality of spools 411-416 contain the multiplicity of metallic wires 20 with the coating material 30. Although FIG. 52 only shows six spools, it should be understood that between 150 to 1200 spools are typically provided in the apparatus 400. The multiplicity of metallic wires 20 with the coating material 30 are collected by a collar 420 to form the assembly 34 of the multiplicity of metallic wires 20.

A spool 430 contains the wrapping material 40 for wrapping the assembly 34 of metallic wires 20. The wrapping material 40 is drawn from the spool 430 by a wrapping apparatus 440. The wrapping apparatus 440 wraps the wrapping material 40 about the multiplicity of metallic wires 20 as the multiplicity of metallic wires 20 pass by the wrapping apparatus 440 to create the helical wrapping. The wrapped assembly 44 of the multiplicity of metallic wires 20 are coiled on a large drum 450.

FIG. 53 is a diagram illustrating an apparatus 500 for performing the process steps 15C of the third process 10C of forming fine metallic fibers 90 shown in FIG. 41. The apparatus 500 simultaneously inserts the plurality of the wrapped assemblies 44 of FIGS. 45 and 46 within the tube 55.

A plurality of the spools 450 contain the wrapped assemblies 44 of the multiplicity of metallic wires 20 with the coating material 30. Although FIG. 53 only shows three spools, it should be understood that between at least seven spools are typically provided in the apparatus 500. The plurality of wrapped assemblies 44 are collected by a collar 520. The collection of the plurality of wrapped assemblies 44 are pulled within the tube 55 and are affixed to a leading end of the tube 55 (not shown). The tube 55 is pulled through a tightening die 540 by a large drum 550 to form the cladding. In this example, the tube 55 is shown as a preformed tube 55. In the alternative, the tube 55 may be a continuous tube 55 formed about the plurality of wrapped assemblies 44.

FIG. 54 is a block diagram illustrating a fourth improved process 10D of forming fine metallic fibers 90 through a new cladding and drawing process of the invention. The fourth improved process 10D is similar to the third improved process 10C shown in FIG. 41. However, in this fourth embodiment of the invention, the coating material 30, the wrapping material 40, and the cladding material 50 are all formed from the same type of material.

FIG. 54 illustrates the process step 16D of drawing the cladding 60. During the step 16D of drawing the cladding 60, the coating material 30 and the wrapping material 40 and the cladding material 50 diffusion weld to form a substantially unitary first support with the multiplicity of metallic wires 20 contained therein.

FIG. 54 illustrates the process step 17D of removing the coating material 30 and the cladding material 50. The coating material 30 and the wrapping material 40 and the cladding material 50 diffusion weld to form a substantially unitary first support. In this example of the invention, the coating material 30 and the wrapping material 40 and the cladding material 50 are simultaneously removed for providing the multiplicity of fine metallic fibers 90. This fourth embodiment of the invention, provides a process for making fine metallic fibers 90 using only a single chemical removal process of the coating material 30, and the wrapping material 40 and the cladding material 50

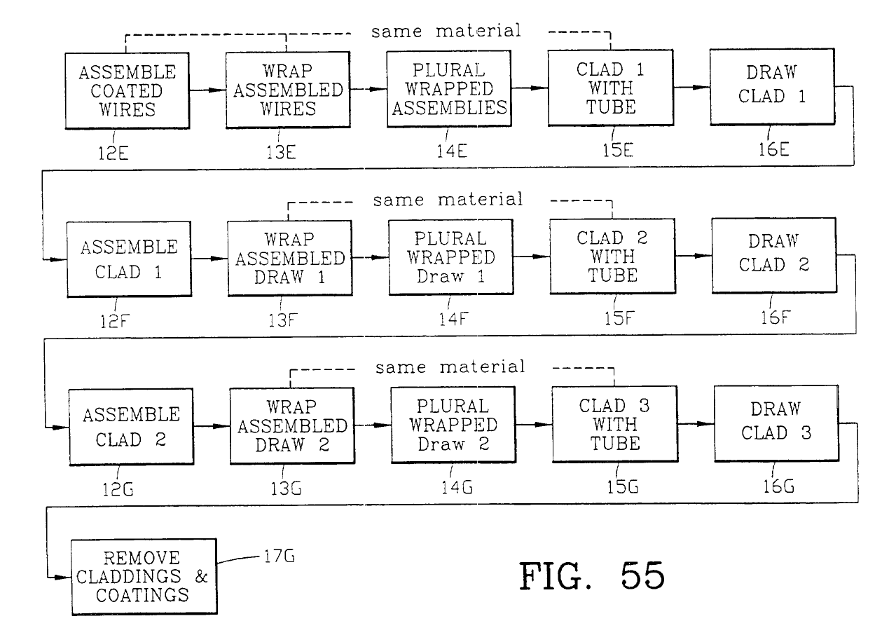

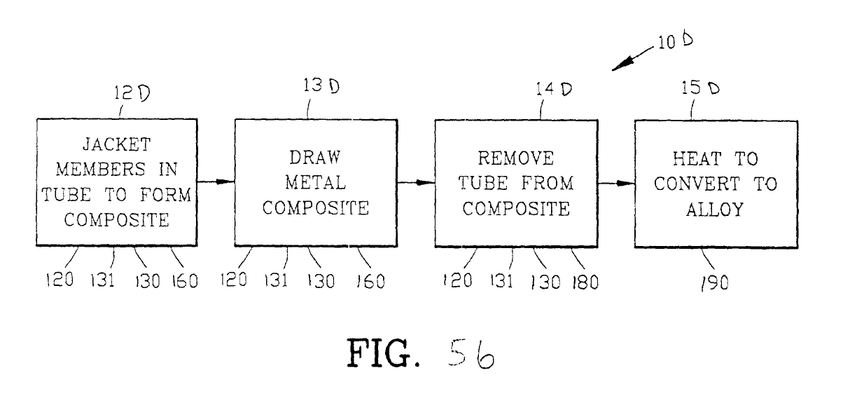

FIG. 55 is a block diagram illustrating a fifth improved process 10E of forming ultra fine metallic fibers through a new cladding and drawing process of the invention. The fifth improved process 10E is similar to the fourth improved process 10D shown in FIG. 54. In this fifth embodiment of the invention, the coating material 30, the wrapping material 40, and the cladding material 50 are all formed from the same type of material.

The fifth improved process 10E comprises the process step 12E of arranging a multiplicity of coated metallic wires 20 in a substantially parallel configuration to form an assembly 34 of the metallic wires.

The fifth improved process 10E comprises the process step 13E of wrapping the assembly 34 of the metallic wires 20 with a wrapping material 40 to form a first wrapped assembly 44. The wrapping material 40 is of the same type of material as the coating material 30.

The fifth improved process 10E comprises the process step 14E of collecting a plurality of first wrapped assemblies 44. The collection of the plurality of first wrapped assemblies 44 is shown in FIG. 53.

The fifth improved process 10E comprises the process step 15E of cladding the plurality of the first wrapped assemblies 44 with a cladding material 50 to provide a first cladding 60. The cladding material 50 is of the same type of material as the coating material 30.

The fifth improved process 10E comprises the process step 16E of drawing the first cladding 60 for reducing the outer diameter thereof and for reducing the cross-section of each of the multiplicity of metallic wires 20 within the first cladding 60. In addition, the process step 16E of drawing the first cladding 60 diffusion welds the coating material 30 and the wrapping material 40 and the cladding material 50 to form a substantially unitary first support with the multiplicity of metallic wires 20 contained therein. The first support may be drawn further for reducing the diameter thereof and for reducing the corresponding cross-section of each of the multiplicity of metallic wires 20 contained therein to transform the multiplicity of metallic wires 20 into a multiplicity of fine metallic fibers 90.

The fifth improved process 10E comprises the process step 12F of arranging a multiplicity of drawn first claddings 60 in a substantially parallel configuration to form an assembly of the drawn first claddings 60.

The fifth improved process 10E comprises the process step 13F of wrapping the assembly of drawn first claddings 60 with a wrapping material 40 to form a second wrapped assembly 44. The wrapping material 40 is of the same type of material as the coating material 30.

The fifth improved process 10E comprises the process step 14F of collecting a plurality of second wrapped assemblies 44.

The fifth improved process 10E comprises the process step 15F of cladding the plurality of the second wrapped assemblies with a cladding material 50 to provide a second cladding 60. The cladding material 50 is of the same type of material as the coating material 30.

The fifth improved process 10E comprises the process step 16F of drawing the second cladding 60 for reducing the outer diameter thereof and for reducing the cross-section of each of the multiplicity of fine fibers 90 within the second cladding. In addition, the process step 16F of drawing the second cladding 60 diffusion welds the coating material 30 and the wrapping material 40 and the cladding material 50 to form a substantially unitary first support with the multiplicity of fine metallic fibers 20 contained therein. The second support may be drawn further for reducing the diameter thereof and for reducing the corresponding cross-section of each of the multiplicity of fine metallic fibers 90 contained therein to transform the multiplicity of fine metallic fibers 90 into a multiplicity of ultra fine metallic fibers 91.

The fifth improved process 10E comprises the process steps 12G-16G processing the second drawn cladding in a manner identical to the process steps 12F-16F with respect to the second drawn cladding. It should be appreciated by those skilled and the art that the process steps 12G-16G may be continued multiple times for further reducing the diameter of the ultrafine metallic fibers 91 within the support. The fifth improved process 10E provides ultra fine metallic fibers of a quality, purity and size heretofore unknown in the art.

The fifth improved process 10E comprises the process step 17G of simultaneously removing the coating material 30 and the cladding material 50 from all of the previous wrapping processes 13E, 13F and 13G and all of the previous cladding processes 15E, 15F and 15G. This fifth embodiment of the invention, provides a process for making ultra fine metallic fibers 90 using only a single chemical removal process of the coating material 30, and the wrapping material 40 and the cladding material 50.

The invention provides fine and ultra-fine fibers. The fibers provide height surface area, high strength, increased holding capacity for the applications to numerous to mention. The fine and ultra fibers are capable of being prepared into media by a wet preparation or a dry preparation process.

The fine fibers may be used as a filter media, catalyst carrier, or any other suitable to a used for such media. The ultra-fine membranes provide nanometer size fibers for use in ultra filtration of liquids and gases. For example ultra-fine fibers may be used in membranes for filtration of gases in the construction of semiconductors as well in various other applications such as the filtration of the blood and other bodily fluids.

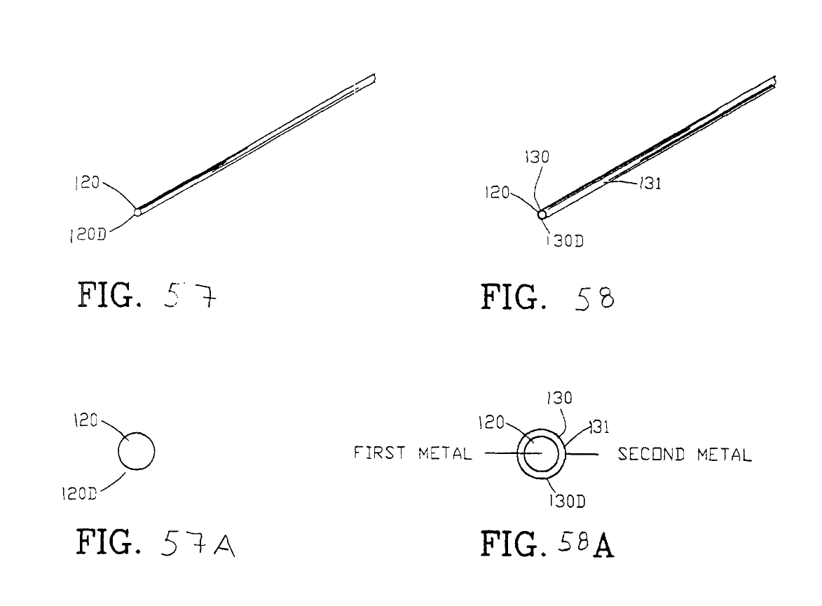

FIG. 56 illustrates a process 10F includes cladding a plurality of at least two types of metal members with a tube. Each metal member, can have any number take a number of forms, including a metal wire form, a metal coated wire form, a multiple coated wire form, a drawn metal coated wire form, or a drawn multiple coated wire form. The metal members may have varied diameters. The at least two types of metal members are comprised of different metals. A plurality of metal members are jacketed with tubing to form a metal composite. This metal composite is then drawn to reduce the diameter of the composite. The tube and optionally any number of the metal coatings are then removed, physically and/or chemically, and the remainder is then heated to convert the remainder to alloy.

In a first general embodiment of the present invention, the metal members are comprised of a wire that is jacketed by a tubing, and a plurality of these metal members are then jacketed by a second tubing to form a metal composite.

FIG. 57 is an isometric view of a metal wire 120, with FIG. 57A being an enlarged cross sectional view of FIG. 57. The metal wire has a diameter 120D.

Preferably, the wire is made of a metal selected from the group of aluminum, nickel, iron, and titanium, although any metal wire may be used. The wire may be comprised of an alloy. In one preferred embodiment, the wire is comprised of an aluminum boron alloy, or a nickel chromium alloy.

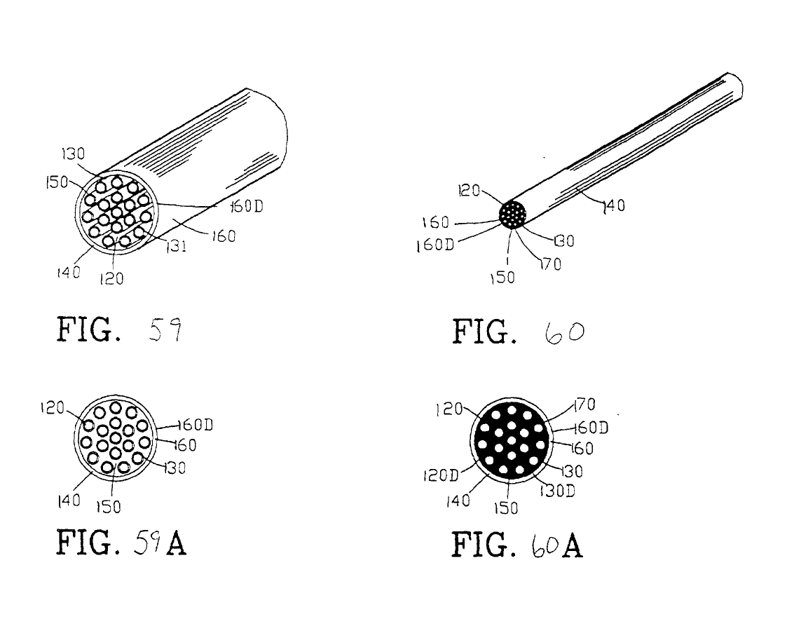

FIG. 58 is an isometric view of the metal wire 120 referred to in FIG. 57 encased in a tube 130 to thereby form a metal member 131 referred to in FIG. 56. The tube 130 is comprised of a different metal than the metal wire 120. Preferably, the tubing is comprised of a metal selected from the group of aluminum, nickel, iron and titanium although any metal can be used. The tube 130 may be comprised of an alloy. In a preferred embodiment, the alloy is selected from a nickel-chromium alloy or an aluminum-boron alloy. The tube 130 has an outer diameter 130D. FIG. 58A is an enlarged cross-sectional view of FIG. 58.

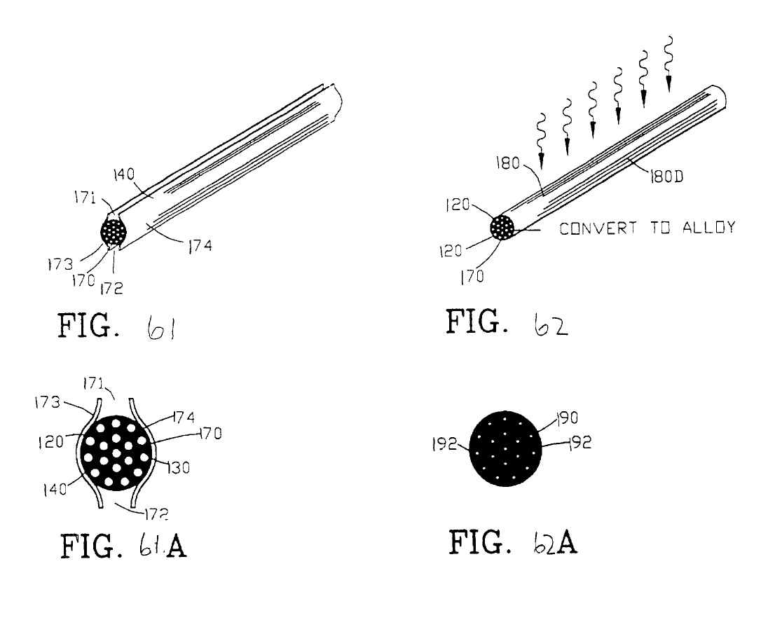

FIG. 56 illustrates the process step 12F of cladding a plurality of metal members 120 with a tube 140. FIG. 59 is an isometric view of a plurality of metal members 120 jacketed or inserted within a composite tube 140 with FIG. 59A being a cross sectional view of FIG. 59. In this embodiment of the invention, the composite tube 140 is a preformed tube. Preferably, the preformed composite tube 140 is made of a carbon steel material.

The plurality of metal members 131 are assembled in an array 50. The array 150 of the plurality of metal members 131 are jacketed within the tube 140 for providing a metal composite 160 having a diameter 160D.

Although the composite tube 140 is disclosed as a preformed carbon steel tube, the array 150 of the plurality of metal members 120 may be encased within the tube 140 through a conventional cladding process. Preferably, approximately one thousand (1000) metallic members 131 are inserted within the composite tube 140.

FIG. 56 illustrates the process step 13F of drawing the metal composite 60. The process step 13 of drawing the metal composite 160 provides three effects. Firstly, the process step 13F reduces an outer diameter 60D of the metal composite 160. Secondly, the process step 13 reduces the corresponding outer diameter 120D of each of the plurality of metal wires 120 and the corresponding outer diameter 130D of each of the wire tubings 130. Thirdly, the process step 13F causes the coating materials 130 on each of metal wires 120 to diffusion weld with the tubings 130 cladding adjacent metallic wires 120.

The drawing procedure may by performed more than once to draw the metal composite down to a desired diameter. This is necessary to control the amount of heat generated in the drawing process, which could prematurely cause the wire and tubing metals to react to form an alloy.

FIG. 60 is an isometric view of the plurality of the metal members 131 inserted within the preformed tube 140 after the process step 13F of drawing the metal composite 160. FIG. 60A is an enlarged end view of FIG. 60. Drawing the metal composite 160 causes the tubing 130 on each metal wire 120 to diffusion weld with the tubing 130 on adjacent metal wires 120. The diffusion welding of the cladding tubings 130 on adjacent metal wires 120 forms a unitary cladding material 170 that extends throughout the interior of the metal composite 160. The plurality of metal wires 120 are contained within the unitary cladding material 170 extending throughout the interior of the metal composite 160.

FIG. 56 illustrates the process step 14F of removing the composite tube 140. In the preferred form of the process, the step 14F of removing the composite tube 140 comprises mechanically removing the composite tube 140.

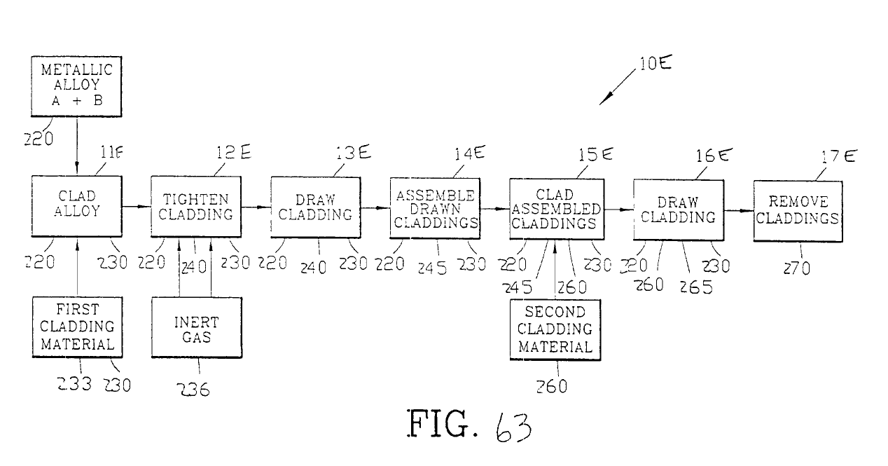

FIG. 61 is an isometric view illustrating the mechanical removal of the preformed composite tube 140 with FIG. 61A being an enlarged end view of FIG. 61. In one example of this process step 14, the composite tube 140 is scored or cut at 171 and 172 by mechanical scorers or cutters (not shown). The scores or cuts at 171 and 172 form composite tube portions 173 and 174 that are mechanically pulled apart to peel the composite tube 140 off of the metal composite 160 to leave a remainder 180. Alternatively, the composite tube can be chemically removed from the composite to leave a remainder 180.

FIG. 56 illustrates the process step 15F of heating the remainder 180 minus the composite tubing 140 to convert the remainder to alloy. In the preferred form of the process, the remainder 180 is heated to a temperature in the range of 1000 degrees C. to 1300 degrees C. so as to convert the metal remainder 180 to an alloy.

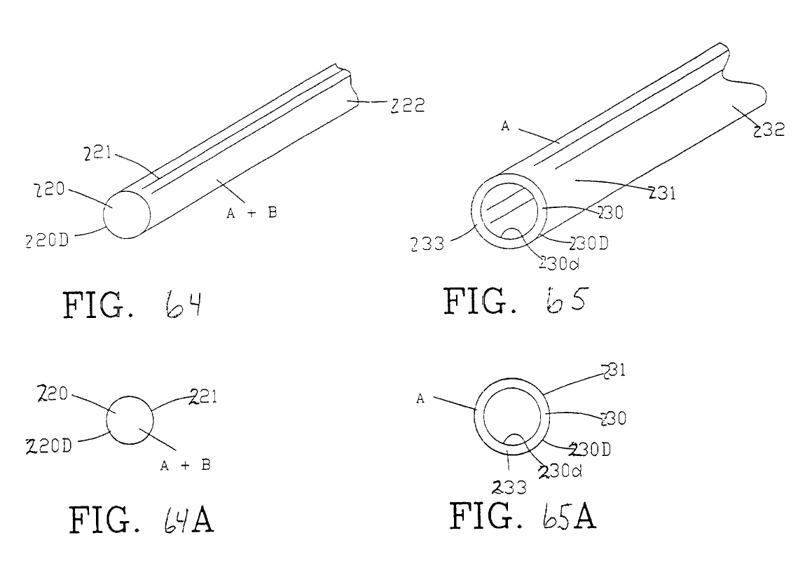

FIG. 62 is an isometric view illustrating the remainder 180 upon complete removal of the tube 140. The remainder 180 comprises substantially unitary cladding material 170 with the plurality of metallic wires 120 contained therein. The remainder 180 defines an outer diameter 180D. The spiraling arrows represent the general application of heat to the remainder 180. As heat is applied to the remainder 180, the metals of the unitary cladding material and the metal wires combine to form a new metal alloy 190.

FIG. 62A is an enlarged cross sectional view of the alloy product 190 of the heated remainder 180 of FIG. 62. The alloy 190 is a single strand product. The product has a high ductility.

In a preferred embodiment, the alloy is Ni₃Al. In this embodiment, the metal wire diameter and composite tubing thickness (one comprised of nickel and the other of aluminum) are chosen so that the final product contains seventy-five atomic percent Ni and twenty-five atomic percent Al. The reactants must have roughly 86.7% by weight nickel and 13.3% by weight aluminum. The alloy product has a number of randomly oriented pores 92 which can be attributed to the lower density of Ni₃Al in comparison to the densities of nickel or aluminum alone. The product has a high ductility for an alloy of normally low ductility.

In another embodiment, the alloy product is NiAl. In this embodiment, the metal wire diameter and composite tubing thickness are chosen so that the final product contains fifty atomic percent Ni and fifty atomic percent Al.

In yet another embodiment, the alloy product is Fe₃Al. The metal wire diameter and composite tubing thickness (one comprised of iron and the other of aluminum) are chosen so that the final product contains seventy-five atomic percent Fe and twenty-five atomic percent Al.

In another embodiment, the alloy product is FeAl. In this embodiment, the metal wire diameter and composite tubing thickness are chosen so that the final product contains fifty atomic percent Fe and fifty atomic percent Al.

FIG. 63 is a block diagram illustrating a first embodiment of an improved process 10G for making a fine metallic alloy fiber. In this embodiment of the invention, the improved process 10G is capable of simultaneously making a multiplicity of fine metallic alloy fibers. The first embodiment of the improved process 10G is capable of simultaneously making thousands of individual metallic alloy fibers. The improved process 10G of FIG. 63 utilizes a metallic alloy 220 and a cladding material. The metallic alloy 220 is shown being formed from a first alloy component (A) and a second alloy component (B).

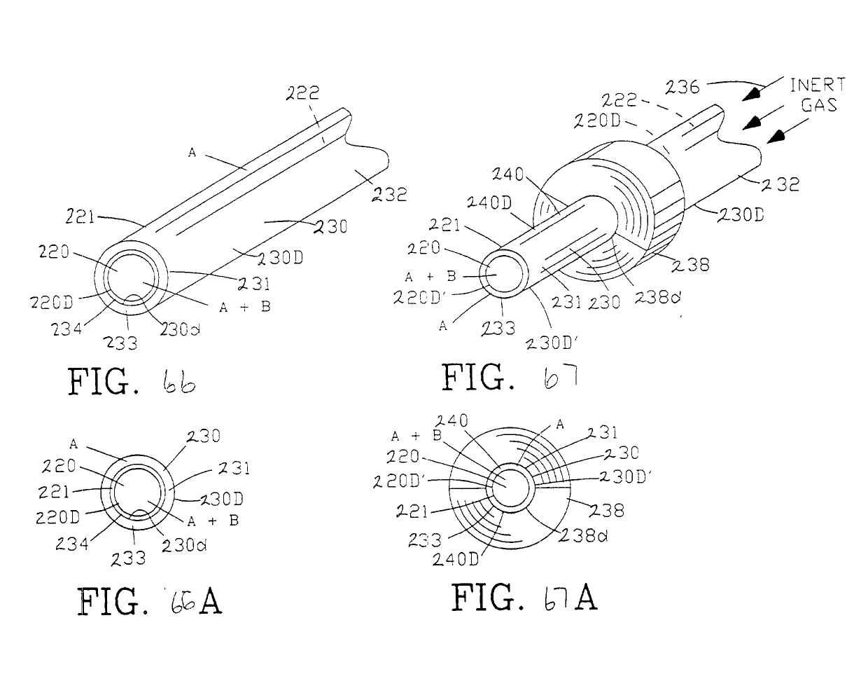

FIG. 64 is an isometric view of the metallic alloy wire 220 referred to in FIG. 63 with FIG. 64A being an end view of FIG. 64. The metallic alloy wire 220 extends between a first end 221 and a second end 222. The metallic alloy wire 220 defines an outer diameter 220D. The metallic alloy 220 is shown being formed from the first alloy component (A) and the second alloy component (B) to be representative of the two alloy components of a selected two alloy component alloy material. Although the metallic alloy 220 is disclosed as a metallic alloy having two components, it should be appreciated that the metallic alloy 220 may have any number of components. Preferably, the metallic alloy 220 is in the form of a wire or a similar configuration.

The process 10G of the invention has been found to work with various types of metallic alloys. In one example of the invention, the metallic alloy wire 220 is selected from the group consisting of Haynes C-22, Haynes C-2000, Haynes HR-120, Haynes HR-160, Haynes 188, Haynes 556, Haynes 214, Haynes 230, Fecralloy Hoskins 875, Fecralloy M, Fecralloy 27-7 and Hastelloy X. Although the process 10E of the invention has been found useful in forming a fine metallic fiber from the above metallic alloys, it should be understood that the process 10E of the invention may be used with various other types of metallic alloys.

FIG. 65 is an isometric view illustrating a first cladding material 230 referred to in FIG. 63. The first cladding material 230 extends between a first and a second end 231 and 232. In this example of the process 10G of the invention, the first cladding material 230 is shown as a preformed tube 233 having an outer diameter 230D and an inner diameter 230d.

FIG. 65A is an enlarged end view of FIG. 65. The inner diameter 230d of the preformed tube 233 of the first cladding material 230 is dimensioned to slidably receive the outer diameter 120D of the metallic alloy wire 220.

The first cladding material 230 is made of a material which is suitable for use with the selected metallic alloy 220. The first cladding material 230 may be formed from one of the first alloy component (A) and the second alloy component (B). In some embodiments, the first cladding material 230 is formed from the first alloy component (A). Of course, one skilled in the art will recognize that the cladding material also may be formed from other components. The cladding material may be an alloy material or a non-alloy material. The surface properties of the fine metallic alloy fiber can be in accordance with the properties of the cladding material.

In the alternative, the first cladding material 230 is made of other materials which are suitable for use with the selected metallic alloy 120. In one example of the process 10G, the first cladding material 230 is selected from the group including low carbon steel, copper, pure nickel and Monel 400 alloy. Although the above group of materials has been found useful for the first cladding material 30, it should be understood that the process 10E of the invention should not be limited to the specific examples of materials set forth herein.

FIG. 63 illustrates the process step 11G of cladding the metallic alloy wire 220 with the first cladding material 30. In this example of the invention, the metallic alloy wire 220 is inserted into the preformed tube 233 of the first cladding material 30.

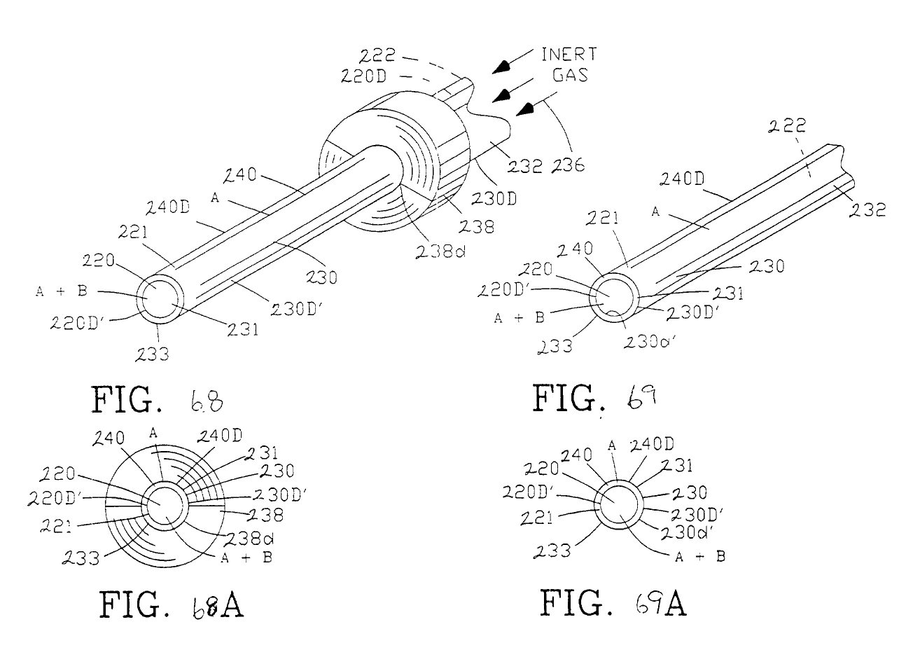

FIG. 66 is an isometric view similar to FIG. 65 illustrating the first cladding material 230 encompassing the metallic alloy wire 220. The inner diameter 230d of the preformed tube 233 of the first cladding material 230 slidably receives the outer diameter 220D of the metallic alloy wire 220. The first end 231 of the first cladding material 230 overlies the first end 221 of the metallic alloy wire 220.

FIG. 66A is an enlarged end view of FIG. 66. The difference between the inner diameter 230d of the preformed tube 233 and the outer diameter 220D of the metallic alloy wire 220 creates a space 234 therebetween. Preferably, the space 234 is minimized but is sufficient to enable insertion of the metallic alloy wire 220 within the first cladding material 30.

FIG. 63 illustrates the process step 12G of tightening the first cladding material 230 about the metallic alloy wire 220. In this example of the invention, the preformed tube 233 of the first cladding material 230 is tightened about the metallic alloy wire 220 in the presence of an inert gas 236.

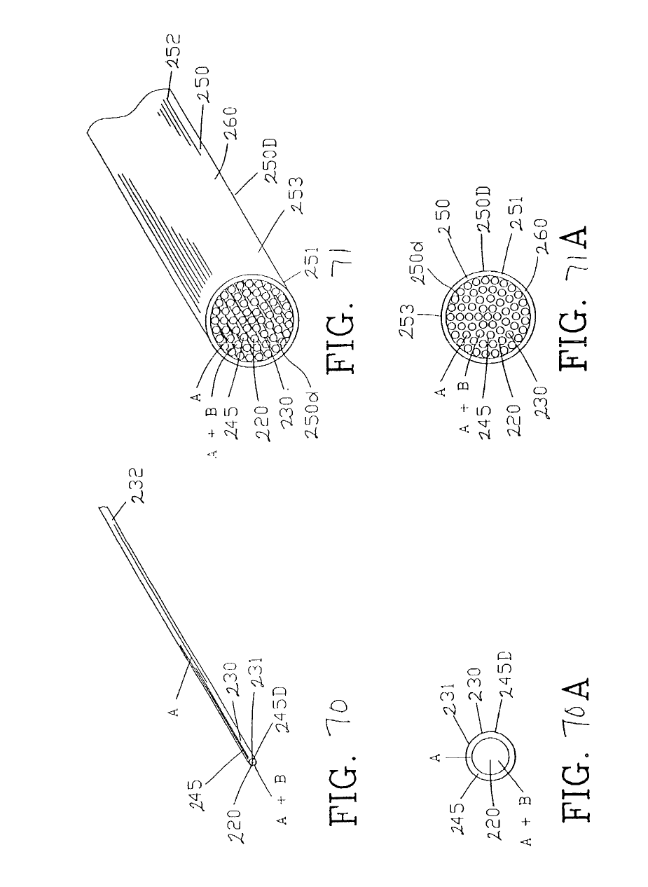

FIG. 67 is an isometric view similar to FIG. 66 illustrating the first cladding material 230 being sealed to the metallic alloy wire 220. Preferably, the preformed tube 233 of the first cladding material 230 is sealed to the metallic alloy wire 220 in the presence of the inert gas 236.

FIG. 67A is an enlarged end view of FIG. 67. A reducing die 238 seals the first end 231 of the first cladding material 230 to the first end 221 of the metallic alloy wire 220. More specifically, the reducing die has an inner diameter 238d that is smaller than the outer diameter 230D of the first cladding material 230 and is smaller than the outer diameter 220D of the metallic alloy wire 220. The reducing die 238 reduces the first cladding material 230 and the metallic alloy wire 220 therein to have a reduced outer diameter of 230D′ at the first end 231.

The insert gas 236 is injected into the space 234 between the inner diameter 230d of the preformed tube 233 and the outer diameter 220D of the metallic alloy wire 220 from the second end 232 of the first cladding material 30. The inert gas 236 purges the space 234 of ambient atmosphere and completely fills the space 234 with the inert gas 236. In one example of the invention, the inert gas 236 is selected from the group VIIIA of the Periodic table. In many cases, the inert gas 236 is selected from the group VIIIA of the Periodic table on the basis of economy, such as argon, helium or neon.

FIG. 68 is an isometric view similar to FIG. 67 illustrating the tightening of the first cladding material 230 to the metallic alloy wire 220 in the presence of the insert gas 236. After the space 234 is purged with the inert gas 236, the remainder of the first cladding material 230 is tightened onto the metallic alloy wire 220 up to the second end 232 of the first cladding material 230. The inert gas 236 insures that there is no reactive gas is interposed between the metallic alloy wire 220 and the first cladding material 230.

FIG. 68A is an enlarged end view of FIG. 68. As the first cladding material 230 is tightened against the metallic alloy wire 220 from the first end 231 to the second end 232, most of the inert gas 236 is squeezed from the space 234 between the metallic alloy wire 220 and the first cladding material 230. After the first cladding material 230 is tightened against the metallic alloy wire 220, the combination forms a first cladding 240 having an outer diameter 240D.

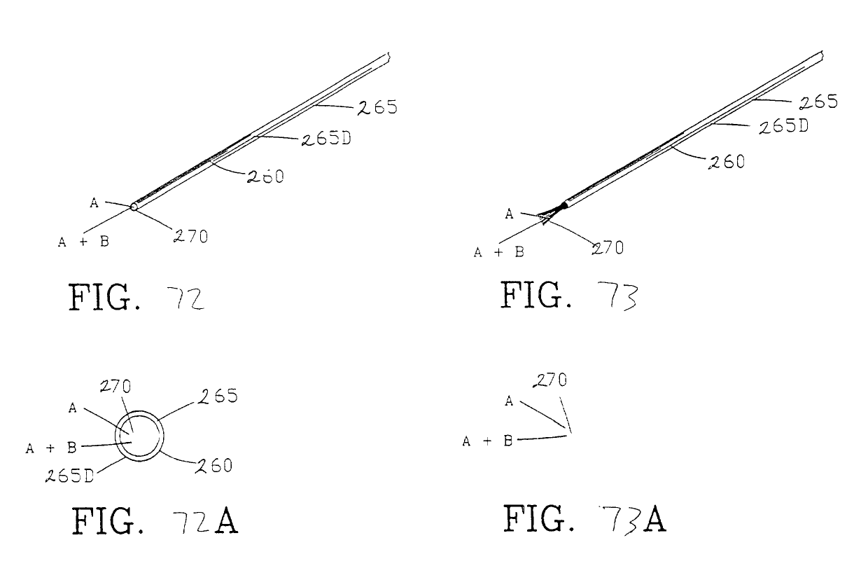

FIG. 69 is an isometric view similar to FIG. 68 illustrating the first cladding material 230 tightened to the metallic alloy wire 220. The metallic alloy wire 220 has a reduced outer diameter 220D′ whereas the first cladding material 230 has a reduced outer and inner diameter 230D′ and 230d′, respectively. The first cladding 240 has an outer diameter 240D.

FIG. 69A is an enlarged end view of FIG. 69. The first cladding material 230 is shown tightened onto the metallic alloy wire 220. Any minute voids between the between the metallic alloy wire 220 and the first cladding material 230 are filled with the inert gas 236.

FIG. 63 illustrates the process step 13G of drawing the first cladding 240 for reducing the outer diameter 240D thereof and for reducing the diameter 220D′ of the metallic alloy wire 220 within the first cladding 240 to provide a drawn first cladding 245.

FIG. 70 is an isometric view of the first cladding 240 of FIG. 69 after a first drawing process 13G to provide the drawn first cladding 245. The drawn first cladding 245 defines an outer diameter 245D. The outer diameter 220D of the metallic alloy wire 220 is correspondingly reduced during the first drawing process 13G.

FIG. 70A is an enlarged end view of FIG. 70. Preferably, the first drawing process 13G includes successively drawing the first cladding 240 followed by successive annealing of the first cladding 240. In the preferred form of the invention, the annealing of the first cladding 240 takes place within a specialized atmosphere such as a reducing atmosphere.

In some embodiments, the first cladding 240 is rapidly heated within the reducing atmosphere. In one example of the invention, a mixture of hydrogen gas and nitrogen gas is used as the reducing atmosphere during the annealing of the first cladding 240. The first cladding 240 may be heated rapidly by a conventional furnace or may be heated rapidly by infrared heating or induction heating. The annealing may be accomplished in either a batch process or a continuous process.

Preferably, the annealed first cladding 240 is rapidly cooled within the heat conducting fluid. The first cladding 240 may be cooled rapidly by a quenching annealed first cladding 240 in a high thermoconductive fluid. The high thermoconductive fluid may be a liquid such as water or oil or a high thermoconductive gas such a hydrogen gas. In one example, the thermoconductive gas comprises twenty percent (20%) to one hundred percent (100%) hydrogen to rapidly cool the first cladding 240.

FIG. 63 illustrates the process step 14G of assembling a multiplicity of the drawn first claddings 245. Typically, 400 to 1000 of the drawn first claddings 245 are assembled with the process 10G of the invention.

FIG. 63 illustrates the process step 15 of cladding the assembly of the multiplicity of the drawn first claddings 245 within a second cladding 250. The quantity of 400 to 1000 of the drawn first claddings 245 are assembled within the second cladding 250.

FIG. 71 is an isometric view illustrating the assembly of a multiplicity of the drawn first claddings 245 within the second cladding 250. The second cladding 250 extends between a first end 251 and a second end 252.

FIG. 71A is an enlarged end view of FIG. 71. In this example, the second cladding 250 is shown as a preformed tube 253 having an outer diameter 250D and an inner diameter 250d. In the alternative, the second cladding 250 may be formed about the assembly of a multiplicity of the drawn first claddings 245. The second cladding 250 is formed from a second cladding material 260 which is suitable for use with the selected metallic alloy wire 220. In addition, the second cladding material 260 is made of a material which is suitable for use with the selected first cladding material 230. In one example, the second cladding material 260 is selected from the group consisting of low carbon steel, copper, pure nickel and Monel 400 alloy. Although the above group of the materials has been found useful for the second cladding material 260, it should be understood that the process 10G of the invention may be used with various other types of materials for the second cladding material 260.

FIG. 63 illustrates the process step 16G of drawing the second cladding 250 for reducing the outer diameter 250D thereof. The second drawing process 16 reduces the diameter 245D of the drawn first claddings 245 and the metallic alloy wire 220 within the second cladding 250 to provide a drawn second cladding 265.

FIG. 72 is an isometric view of the second cladding 250 of FIG. 71 after a second drawing process 16G to provide the drawn second cladding 265. The drawn second cladding 65 defines an outer diameter 265D. The outer diameter 220D of the metallic alloy wire 220 is correspondingly reduced during the second drawing process 16G. The drawing of the second cladding 250 transforms the multiplicity of metallic alloy wires 220 into a multiplicity of fine metallic alloy fibers 270.

FIG. 72A is an enlarged end view of FIG. 72. Preferably, the second drawing process 16G includes successively drawing the second cladding 250 followed by successive annealing of the second cladding 250. In the preferred form of the invention, the annealing of the second cladding 250 takes place within a specialized atmosphere such as a reducing atmosphere as set forth above.

FIG. 63 illustrates the process step 17G of removing the first and second cladding materials 230 and 260 from the multiplicity of fine metallic alloy fibers 270. Preferably, the first and second cladding materials 230 and 260 are removed from the multiplicity of fine metallic alloy fibers 270 by a chemical or an electrochemical process.

FIG. 73 is an isometric view similar to FIG. 72 illustrating the removal of the first and second claddings 230 and 260. The removal of the first and second claddings 230 and 260 provides a multiplicity of fine metallic alloy fibers 270. The process step 17G of removing the first and second cladding materials 230 and 260 from the multiplicity of fine metallic alloy fibers 270 may include leaching the first and second drawn claddings 245 and 265 for chemically removing the first and second cladding materials 230 and 260.

FIG. 73A is an enlarged end view of FIG. 73. The multiplicity of fine metallic alloy fibers 270 may contain thousands of individual metallic alloy fibers 270.

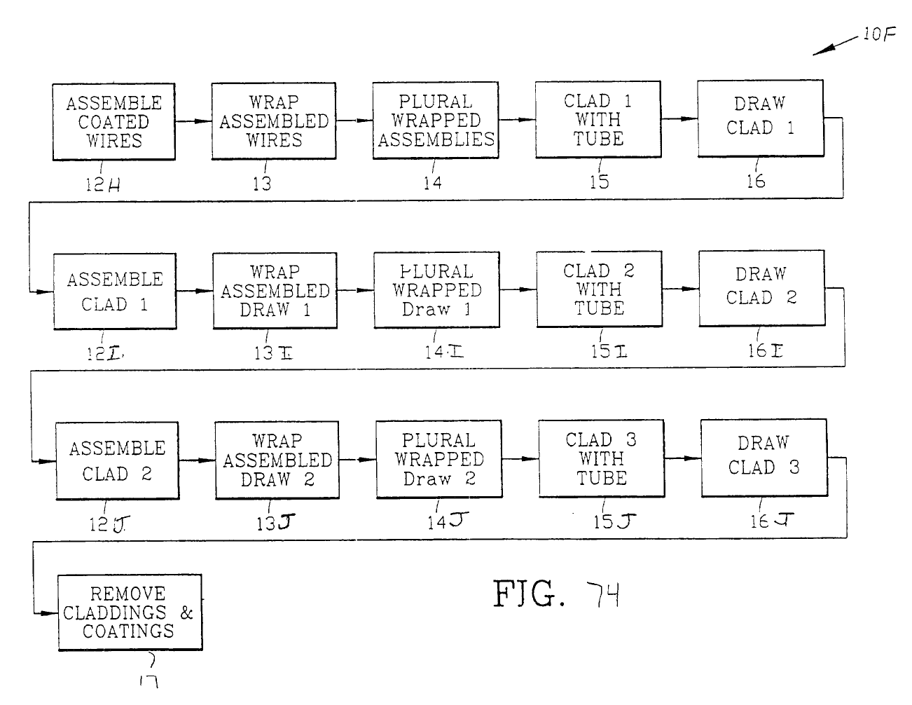

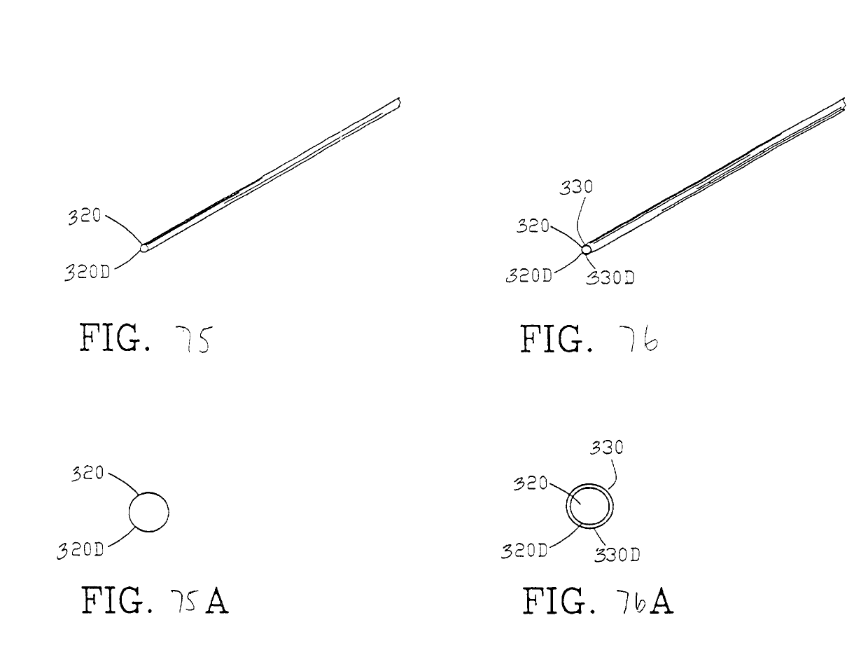

FIG. 74 is a block diagram illustrating a process 10H for making ultra fine fibers. Preferably, metallic fibers with a diameter of about 100 nanometers or less are made with process 10H. In some embodiments, the process 10F of FIG. 74 comprises the process step 12H of assembling multiple coated metallic wires. In some embodiments, the process 10F is capable of simultaneously making a multiplicity of ultra fine fibers.

FIG. 75 is an isometric view of a metallic wire 320 referred to in FIG. 74 with FIG. 75A being an enlarged end view of FIG. 75. In some embodiments, the metallic wire 320 is a stainless steel wire having a diameter 320D, but it should be understood that various types of metallic wires 320 may be used in the process 10H. For example, in other embodiments, the wires are made of other materials including nickel, gold, platinum, silver, palladium, silicon, germanium, any other metallic or semi metallic material set forth above or any transition metal or refractory metal. Additionally, wires made of alloys, such as an aluminum boron alloy, a nickel chromium alloy or other alloys can be used. Alternately, metal wires for making alloys can be used as described in U.S. Pat. No. 6,248,192 entitled “Process for Making an Alloy,” the specification of which is hereby incorporated by reference in its entirety. Additionally, wires made of cadmium tellurium or selenium can be used. In the alternative, the metal wire 320 has a core made of a first metal, such as an inexpensive metal, and is coated with a layer that is made of a second material, such as a second, more expensive metal. In one example, the metal wire 320 is made of stainless steel and is coated with a layer of platinum. Of course, the wire can be coated with other metals, such as gold, nickel and the like. In some embodiments, the coating layer is made from a catalytically active material. In some embodiments, the catalytically active material has properties that include one or more of the following properties: high reactivity, chemical selectivity, high surface area, nonfouling, permeable structure, mechanically self supporting, thermally and mechanically shock resistant. In some embodiments, the metallic wire 320 has a diameter between 0.10 and 200 microns. In other embodiments, the metallic wire 320 has a diameter between 1, 3, 5, 7, 9, 10, 12, 14, or 16 microns and 180, 160, 140, 120, 100, 90, 80, 70, or 60 microns. Preferably, the metallic wire 320 has a diameter between 18, 20, or 22 microns and 50, 45, 40, or 35 microns. More preferably, the metallic wire 320 has a diameter between 25 and 30 microns.

FIG. 76 is an isometric view of the metallic wire 320 of FIG. 75 and illustrates that each of the metallic wires 320 has a sacrificial coating material 330 thereon. FIG. 76A is an enlarged end view of FIG. 76. In some embodiments, the sacrificial coating material 330 is a copper material but it should be understood that various types of sacrificial coating materials 330, such as, for example, aluminum, silver, nickel, iron, titanium, combinations thereof, and compounds containing such materials, and the like, may be used in the process 10H. Additionally, polymers such as Teflon, Kynar and ceramics such as alumina, titania, and the like can be used for the sacrificial coating material 330. In some embodiments, using a polymer as a sacrificial coating material 330 results in carborization of the material during an annealing step. This outcome is advantageous in situations in which it is desirable to have a source of carbon dispersed along the bundle for further reactions. This permits formation of, for example, silicon carbide or other carbides on a nano scale, using the methods disclosed herein. Conditions for pyrolysis of carbon-based polymers during an annealing step, and subsequent conditions for reacting carborized materials with core materials in the fiber bundle are readily selectable by those of skill in the art, based upon the desired final composition of the particular carbide, boride, or other compound to be made. This is therefore a nano-scale application of the Acheson process which is known in the art but which has heretofore not been achievable with nano-scale fiber structures. In some embodiments, the sacrificial coating material 330 is chosen as a source of material for diffusion into the material of the wire 320 as disclosed in U.S. Pat. No. 6,248,192 entitled “Process for Making an Alloy,” the specification of which has been incorporated by reference in its entirety. Preferably, the sacrificial material 330 has an equal or decreased work-hardening rate than that of the metallic wire 320. In some embodiments, the sacrificial material 330 is selected from a material that forms continuous solid solutions with the material selected for the metallic wire 320. In preferred embodiments, the sacrificial material 330 does not form intermetallic compounds with the material selected for the metallic wire 320.

The process of applying the sacrificial coating material 330 to the metallic wire 320 may be accomplished in various ways. In some embodiments, the sacrificial coating material 330 is applied to the metallic wire 320 in an electroplating process. The sacrificial coating material 330 defines a coating diameter 330D. In some embodiments, the sacrificial coating material 330 represents approximately 5% to 50%, or more, by volume of the combined volume of the metallic wire 320 and the sacrificial coating material 330. In other embodiments, the coating material 330 represents approximately 2%, 3%, 4%, 10%, 20%, 25%, 30%, 35%, 40%, 45%, or more, of the combined volume of the metallic wire 320 and the sacrificial coating material 330 depending on the nature of the coating material and other process conditions.

FIG. 74 illustrates a process step 13H of wrapping the assembled wires with a wrapping material. In some embodiments, the wrapping material is the same material as the sacrificial coating material 330. In other embodiments, the wrapping material can be made of a different material that the sacrificial coating material. The wrapping material can be any material that is desired to be solid state diffused into the metallic wire 320. For example, silver, nickel, monel, titanium, aluminum, iron, nichrome, inconel are used in embodiments of the invention.

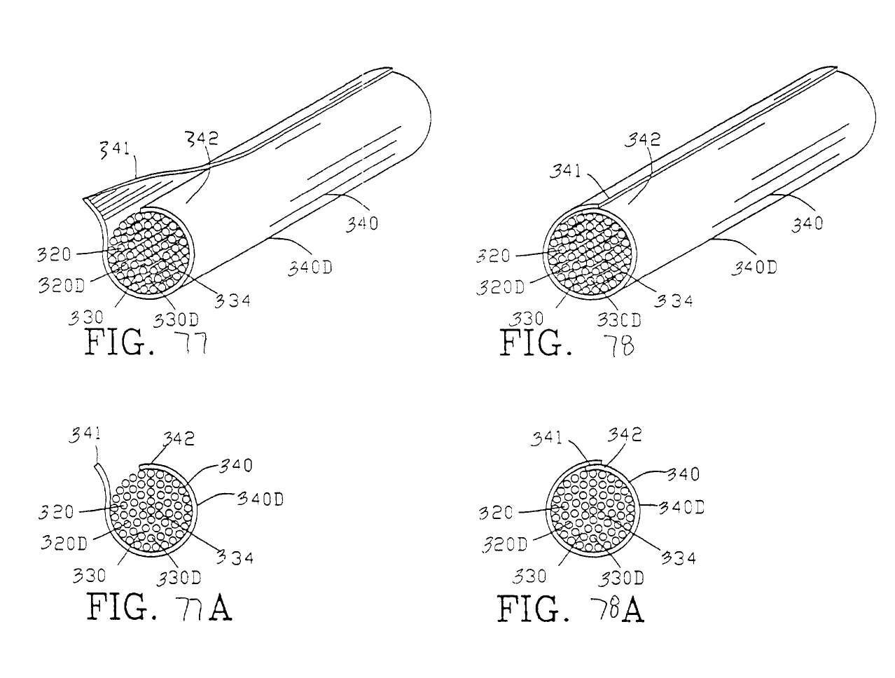

As shown in FIG. 77, a plurality of the metallic wires 320 with the sacrificial coating material 330 are formed into an assembly 334 of metallic wires 320. The wires 320 in the assembly are encased with a wrapping material 340. FIG. 77A is an end view of FIG. 77. In some embodiments, the step of encasing the assembly 334 within the wrapping material 340 includes bending a first and a second edge 341 and 342 of a longitudinally extending wrapping material 340 to form a tube. In some embodiments, the wires 320 have the same composition. Alternately, two or more types of wire of different composition are formed into the assembly 334. The assembly 334 is formed with 150 to 30,000 metallic wires 320, and more preferably with between 20,000 and 25,000 wires 320. In some embodiments, the assembly is formed with 25,000 metallic wires 320. In another embodiment, the assembly is formed with between 2,500 and 5,00 metallic wires 320, and more preferably with about 3,000 metallic wires 320.

FIG. 74 illustrates a process step 14H of bundling multiple assemblies together. For example, twenty-five metallic wires 320 are paid off spools though a collecting die and wrapped with sacrificial wrapping material 340 to form a bundle. Then, twenty-five bundles of the twenty-five wires 320 are pulled through a collecting die using a similar technique forming a bundle with 625 metallic wires 320. Next, forty bundles with the 625 metallic wires are pulled through a collecting die using a similar technique to form the assembly 334 with 25,000 metallic wires. Preferably, the individual wires 320 have a parallel arrangement in the assembly 334 and are of substantially the same length. Additionally, it is desirable that the metallic wires 320 be maintained under tension during formation of the assembly 334 using any of several methods known in the art.

FIG. 78 illustrates an embodiment of the completed assembly 334 of the plurality of the wires 320 within the wrapping material 340. FIG. 78A is an end view of FIG. 78. The wrapping material 340 is bent about the assembly 334 of the plurality of the wires 320 with the first edge 341 of the wrapping material 340 preferably overlapping the second edge 342 of the wrapping material 340. The assembly 334 of the plurality of the wires 320 is encased within the wrapping material 340 having a diameter 340D. In some embodiments, the diameter 340D is between 0.25 and 1.0 inches. In embodiments of the invention, the diameter can be approximately 0.25 inches, 0.35 inches, 0.50 inches, 0.75 inches and 1.0 inch. Alternately, the wrapping material 340 is bent about the assembly 334 of the plurality of the wires 320 with the first edge 341 of the wrapping material 340 abutting the second edge 342 of the wrapping material 340 and the edges are welded together. Of course, other methods of wrapping the assembly 334, such as spot welding, seam welding and those taught in U.S. patent application Ser. No. 09/654,980, the disclosure of which has been incorporated by reference, can be used.

FIG. 74 illustrates the process step 15H of forming a continuous cladding of a cladding material about the plurality of metallic wires 320. In some embodiments, the cladding material is a carbon steel material with the plurality of metallic wires 320 being made of a stainless steel material. In another embodiment, the cladding material is silver with the plurality of metallic wires 320 being made of gold. One skilled in the art will understand that other cladding material can also be selected such as monel, copper alloys, nickel alloys, and materials that diffuse slowly into the metallic wire 320 or the wrapping material 340.

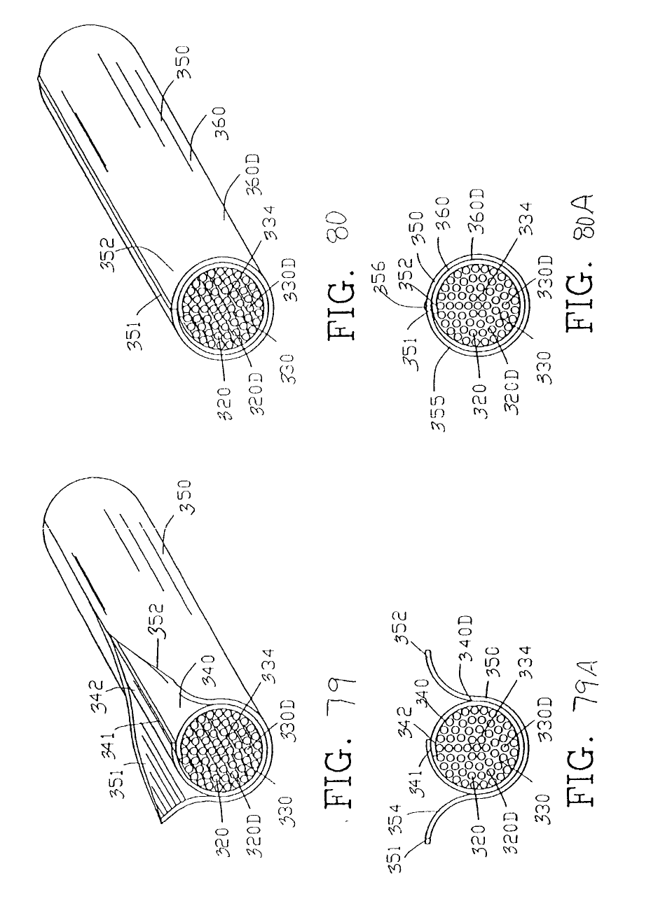

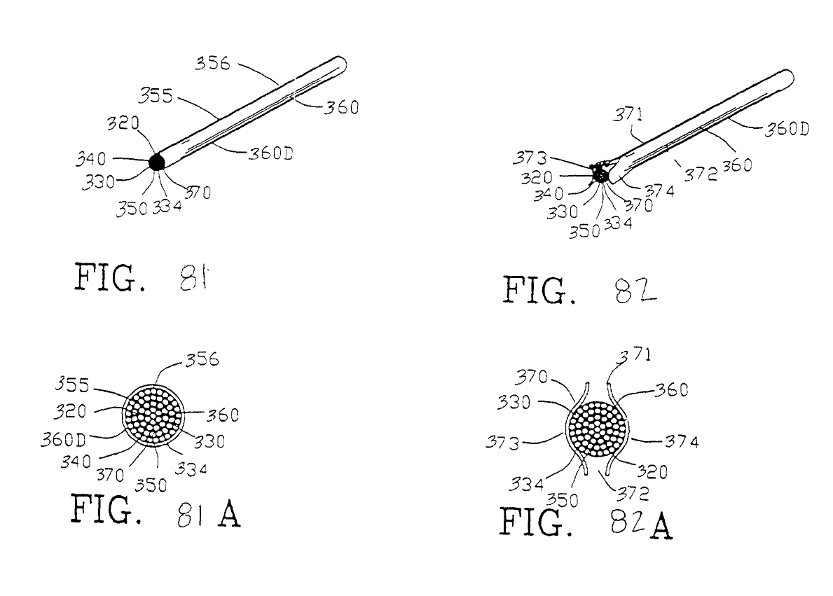

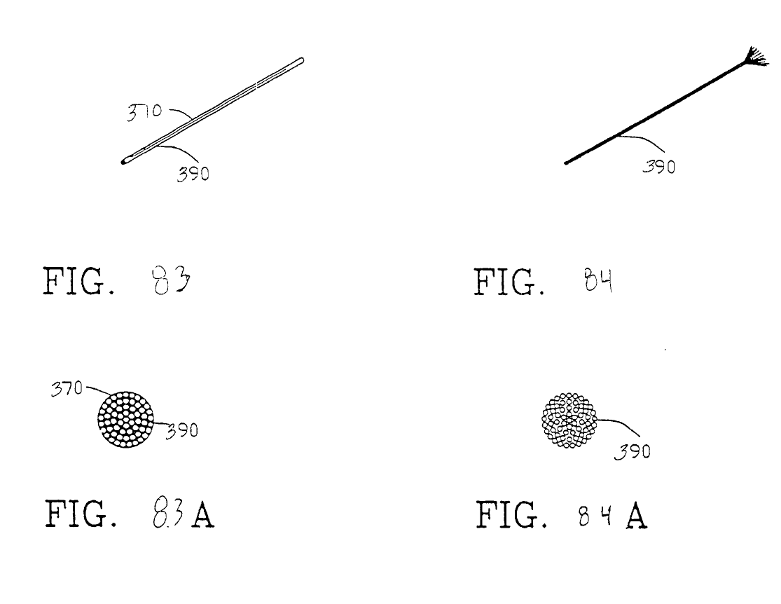

FIG. 79 is an isometric view illustrating the process step 15H of forming a continuous cladding 360 of a cladding material 350 about the plurality of metallic wires 320 and the wrapping material 340. FIG. 79A is an end view of FIG. 79. In some embodiments, the cladding 360 is a longitudinally extending tube having a first and a second edge 351 and 352. The step 15H of forming the cladding 360 from the cladding material 350 includes bending the first and second edges 351 and 352 of the longitudinally extending sheet of the cladding material 350 to form a cladding 360 for enclosing the assembly 334.

A surface of the cladding material 350 may be treated with a release material 354 to inhibit chemical interaction between the cladding material 350 and the plurality of metallic wires 320 or the wrapping material 340. The release material 354 may be any suitable material to inhibit chemical interaction between the cladding material 350 and the plurality of metallic wires 320 or the sacrificial coating material 330 or the wrapping material 340. The release material 354 may be titanium dioxide TiO₂, sodium silicate, aluminum oxide, talc or any other suitable material to inhibit chemical interaction between the cladding material 350 and the sacrificial coating material 330 or the wrapping material 340. The release material 354 may be suspended within a liquid such as a water base gel or sol gel, for enabling the release material 354 to be painted onto the cladding material 350. In the alternative, the release material 354 may be applied by flame spraying or a plasma gun, painting or any other suitable means.

FIG. 80 is an isometric view illustrating the completed process of forming the continuous cladding 360 of the cladding material 350. FIG. 80A is an end view of FIG. 80. The longitudinally extending sheet of the cladding material 350 is bent with the first edge 351 of the cladding material 350 abutting the second edge 352 of the cladding material 350. The first edge 351 of the cladding material 350 is welded to the second edge 352 of the cladding material 350 by a weld 356. Alternately, the cladding material 350 is a hollow tube and the metallic wires 320 are pulled through the tube. The cladding 360 defines an outer diameter 360D.

FIG. 74 illustrates the process step 16H of drawing the cladding 360. The process step 16H reduces the outer diameter 360D of the cladding 360 and the corresponding outer diameter 220D of each of the plurality of metallic wires 320 and the corresponding outer diameter 330D of each of the sacrificial coating materials 30. The cladding 360 is drawn in any manner disclosed above.

In some embodiments, the drawing process 16H includes successively drawing the cladding 360 followed by successively annealing the cladding 360. In some embodiments of the invention, annealing of the cladding 360 takes place within a specialized atmosphere such as a reducing atmosphere. The drawing process 16H can include multiple drawings and anneals of the cladding 360. For embodiments made from materials with low work hardening rates or where it is desirable to maintain the purity of metal wires 320, such as gold or aluminum, fewer anneals is preferred. In an embodiment where it is desired to keep the material of the wire 320 pure, it is preferred to use a low annealing temperature, such as a temperature between 0.6 and 0.69 of the melting point of the fiber material, such as 0.60, 0.62, 0.65, 0.67 and 0.69. If it desired to promote diffusion of the sacrificial coating material 330 into the wire 320, higher annealing temperatures are preferred, such as between 0.7 and 0.8 of the melting point of the material of the metallic wire 320. In embodiments, annealing is performed at 0.70, 0.73, 0.75, 0.78 and 0.80 of the melting point of the metallic wire 320. Additionally, one skilled in the art will understand that adjusting the time and/or temperature of the annealing can control the amount of diffusion of the source material into the parent material.

The reduction ratio of the drawing process can range between approximately 5% to 35%. In an embodiment where the metallic wire 320 is gold, preferably the reduction ratio is 10%. In other embodiments, reduction ration can be approximately 5%, 8%, 15%, 20%, 25% 30% or 35%. In embodiments where it is desirable to maintain the purity of metal wires 320, smaller reduction rates are preferable to lessen the diffusion of the cladding material 350 and sacrificial coating 30 into the metallic wire 320.

FIG. 81 is an isometric view of the cladding 360 of FIG. 7 after the first drawing process. FIG. 81A is an enlarged end view of FIG. 81. The drawing of the cladding 360 causes the sacrificial coating material 330 on each of the plurality of metallic wires 320 to diffusion bond with the sacrificial coating materials 130 on adjacent plurality of metallic wires 320 and to diffusion bond with the wrapping material 340. The diffusion bonding of the sacrificial coating material 330 and the wrapping material 340 forms a unitary material 370. After the diffusion bonding of the sacrificial coating material 330 and the wrapping material 340, the sacrificial coating material 330 and the wrapping material 340 are formed into a substantially unitary material 370 extending throughout the interior of the cladding 360. The plurality of metallic wires 320 are contained within the unitary material 370 extending throughout the interior of the cladding 360. In some embodiments, the sacrificial coating material 330 and the wrapping material 340 is a copper material and is diffusion bonded within the cladding material 350 to form a substantially unitary copper material 370 with the plurality of metallic wires 320 contained therein.

In some embodiments, it is preferable that the release material 354 is deposited on the cladding material 350 of the formed cladding 360 in a quantity sufficient to inhibit the chemical interaction or bonding between the cladding 360 and a plurality of metallic wires 320 and the sacrificial coating materials 330 and the wrapping material 340 within the cladding 360. In one embodiment, titanium dioxide with a concentration of between 2% and 25% or greater is used as the release material. However, the release material 354 preferably is deposited on the cladding 360 in a quantity insufficient to inhibit the diffusion bonding of the sacrificial coating materials 30 on adjacent metallic wires 320 and the wrapping material 340. After the cladding 360 is drawn, the cladding material 350 can be removed by a chemical or mechanical process. For example, if the cladding material becomes excessively work hardened, it can be removed.

FIG. 74 illustrates the process step 121 assembling a plurality of the drawn claddings 360. FIG. 74 illustrates process steps 131 and 141 of wrapping the drawn claddings with a wrapping material. In some embodiments, the wrapping material 340 is the same material as the sacrificial coating material 330. The process step 13G wraps the drawn claddings 360 as was previously described above with respect to wrapping the assemblies 334 of FIG. 77. The number of drawn claddings 360 wrapped together can range from approximately 100 to 6,000 or more. In some embodiments, approximately 300 of the drawn claddings are wrapped together. In other embodiments, approximately 500, 1000, 1500, 2000 and 3000 drawn claddings are wrapped together.

FIG. 74 illustrates the process step 151 of forming a second continuous cladding 360 of a cladding material 350 about the plurality of drawn claddings 360. In some embodiments, the cladding 360 is a longitudinally extending tube as was described above with reference to the first continuous cladding 360. In some embodiments, the diameter of the cladding 360B is between 0.10 and 1.0 inches, and more preferably between 0.25 and 0.50 inches. In embodiments of the invention, the diameter can be approximately 0.25 inches, 0.35 inches, 0.50 inches, 0.75 inches and 1.0 inch.

In some embodiments, the cladding material 350B is a carbon steel material with the plurality of metallic wires 320 being made of a stainless steel material. In another embodiment, the cladding material 350 is silver with the plurality of metallic wires 320 being made of gold. Preferably, the cladding material 350 has the same or higher work hardening rate than the metallic wires 320 and first cladding material 350. In some embodiments, the second cladding material 350 preferably has a higher tensile strength in annealed condition than the metallic wires 320 and the first cladding material 350. In other embodiments it is preferable for the second cladding material to have a lower tensile strength in annealed condition than the metallic wire 320 and the first cladding material 350. Further, in still other embodiments, the first cladding material and the second cladding material are the same or substantially the same. Selection of the appropriate cladding material is determined by the nature of the material to be produced, as will be appreciated by one skilled in the art.

FIG. 74 illustrates the process step 161 of drawing the second cladding 360B. The process step 161 further reduces the corresponding outer diameter 320D of each of the plurality of metallic wires 320 and the corresponding outer diameter 330D of each of the sacrificial coating materials 330. The cladding 360B is drawn in any method disclosed above.

In some embodiments, the drawing process 161 includes successively drawing the cladding 360 followed by successive annealing of the cladding 360 as described above. In some embodiments of the invention, annealing of the cladding 360 takes place within a specialized atmosphere such as a reducing atmosphere. In some embodiments, the reducing atmosphere is 94% hydrogen and 6% argon or nitrogen. Other reducing atmospheres such as dissociated ammonia gas and inert gases such as argon, helium, and the like, can be used as will be known to one skilled in the art. The drawing process 161 can include multiple drawings and anneals of the cladding. In an embodiment with stainless steel metallic wires 320, the cladding is annealed between five and ten times during the process 10F. In some embodiments, the cladding is annealed six times. For embodiments with low work hardening rates such as gold or aluminum, the number of anneals is preferably reduced to two. In embodiments where it is desirable to maintain the purity of metal wires 320, fewer anneals are preferred. In practice, any number of annealing steps appropriate for the material to be made is contemplated by the present invention.

FIG. 74 illustrates the process steps 12J-16J for assembling the second claddings 360B and performing an additional drawing process using methods substantially the same as those described above. One skilled in the art will understand that several drawing processes can be used based upon factors such as the desired final diameter of the wires 320, the initial diameter of the metallic wires 320 and the material that the metallic wires are made from. In embodiments where it is desirable to maintain the purity of wires 320, fewer drawing steps are preferred.

FIG. 74 illustrates the process step 17H of removing the claddings 360 and coating 330. One example of the process step 17H includes an acid leaching and rinsing process as described in U.S. Pat. No. 6,112,395, the disclosure of which has been incorporated by reference. For example, the coating material 330 with the plurality of stainless steel wires 320 is immersed into a solution of 1% to 15% H₂SO₄ and 0.1% to 3.0% H₂O₂ for dissolving the unitary material 370 without dissolving the fibers. The 0.1% to 3.0% H₂O₂ participates in the sacrificial material dissolution process as well as creates an oxidizing environment that inhibits the leaching of fibers 390 by the H₂SO₄. In some embodiments, the 0.1% to 3.0% H₂O₂ is stabilized from decaying in the presence of copper such as PC circuit board grade H₂O₂. In embodiments, solutions with about 1%, 5%, 8%, 10%, 12% and 15% H₂SO₄ and about 0.1%, 0.5%, 1.0% 1.5%, 2.0%, 2.5% and 3.0% are used. It should be appreciated that stabilizing agents such as sodium stanate or sodium benzoate or the like may be used with the present process. The dissolving step dissolves the sacrificial material 330 without dissolving the fibers. After the sacrificial material 330 is dissolved, the fibers 390 are passed to a rinsing process.

In one embodiment, the sacrificial material 330 is leached in a wet environment and the recovered fibers 390 are formed into a cake. Fibers can then be extracted from the cake. In another embodiment, the coating material 330 with the plurality of stainless steel wires 320 is collected on a spool and the sacrificial material is leached from the fibers 390 with the wires collected or wound on the spool. The fibers are then recovered as a continuous filament collected on the spool following the leaching process. The process of recovering the continuous filament or fiber from the sacrificial material while wound on a spool is described in detail in U.S. patent application Ser. No. 09/950,446 entitled APPARATUS AND PROCESS FOR PRODUCING HIGH QUALITY METALLIC FIBER TOW, filed Sep. 10, 2001, Publication No. U.S. 2002/0029453 published Mar. 14, 2002, the disclosure of which is hereby incorporated by reference in its entirety.

FIG. 82 is an isometric view illustrating the mechanical removal of the cladding 360 with FIG. 82A being an enlarged end view of FIG. 82. In one example of this process step 17H, the cladding 360B or 360C is scored or cut at 371 and 372 by mechanical scorers or cutters (not shown). The scores or cuts at 371 and 372 form tube portions 373 and 374 that are mechanically pulled apart to peel the cladding 360. Alternately, if the cladding 360 becomes excessively work hardened, it can be removed either chemically or mechanically and replaced by a new cladding. The new cladding can be of the same or a different cladding material 350.

In some embodiments, the cladding 360 is rapidly heated within the reducing atmosphere. In one example of the invention, a mixture of hydrogen gas and nitrogen gas is used as the reducing atmosphere during the annealing of the cladding 360. In one embodiment, a mixture of 94% hydrogen and 6% nitrogen is used, however, one skilled in the art will understand that other concentrations can be used. The cladding 360 may be heated rapidly by a conventional furnace or may be heated rapidly by infrared heating or induction heating. In one embodiment, the cladding 360 is heated to a temperature between 1000 and 2000 degrees F. Preferably, the cladding 360 is heated to a temperature between 1200 and 2000 degrees F. and more preferably between 1650 and 1950 degrees F. The annealing may be accomplished in either a batch process or a continuous process.

In some embodiments, the annealed cladding 360 is rapidly cooled within the heat conducting fluid. The cladding 360 may be cooled rapidly by quenching the annealed cladding 360 in a high thermoconductive fluid. The high thermoconductive fluid may be a liquid such as water or oil or a high thermoconductive gas such a hydrogen gas. In one example, the thermoconductive gas includes 20% to 100% hydrogen to rapidly cool the cladding 360. In embodiments, the thermoconductive gas includes about 20%, 30%, 50%, 70%, 90% and 100% hydrogen.

FIG. 83 is an isometric view of the plurality of wires 320 of FIG. 75 reduced into a plurality of ultra fine fibers 390 by the process steps 16H, 16I and 16J of drawing the metallic wires 320. FIG. 83A is an enlarged end view of FIG. 83.

FIG. 84 is an isometric view of the plurality of the ultra fine fibers 390 after the process step 17H shown in FIG. 74 of removing the sacrificial material 330. FIG. 84A is an enlarged end view of FIG. 84. It is preferable that the fibers 390 are free of contaminates such as foreign debris.

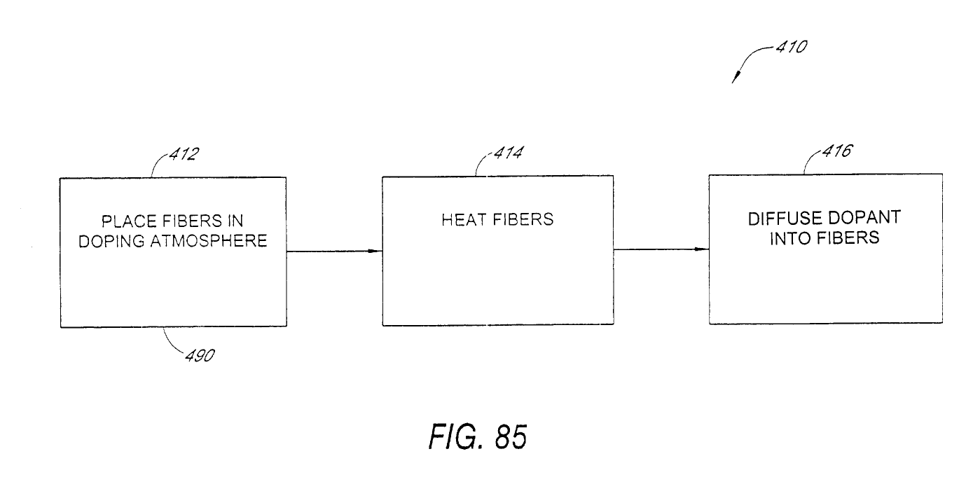

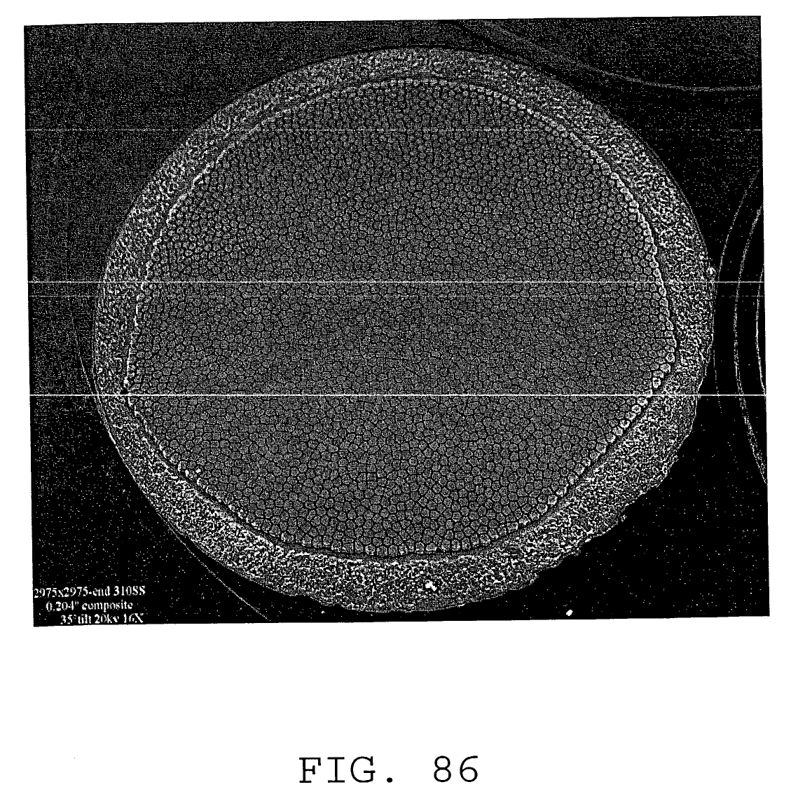

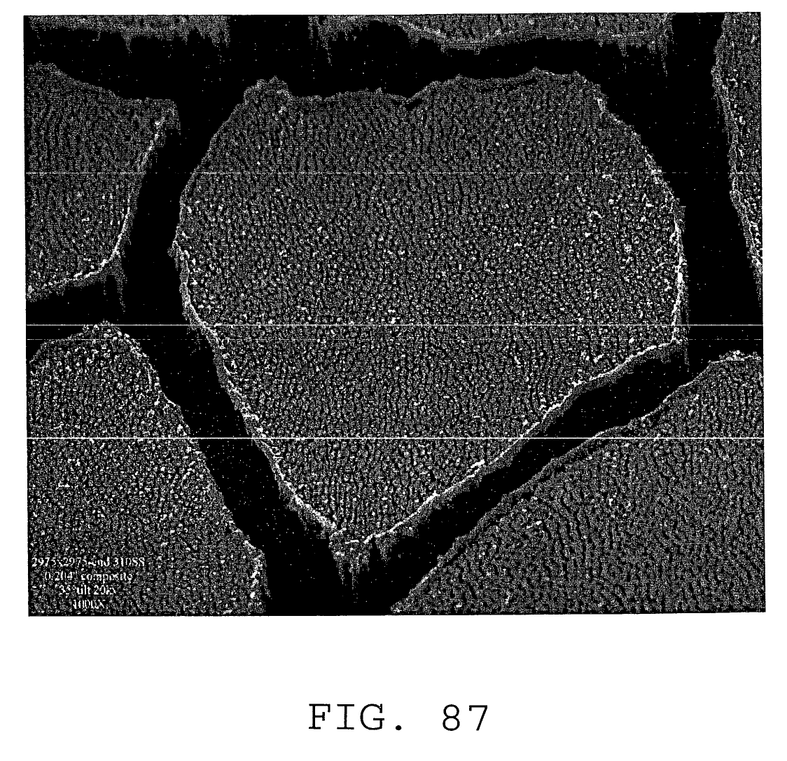

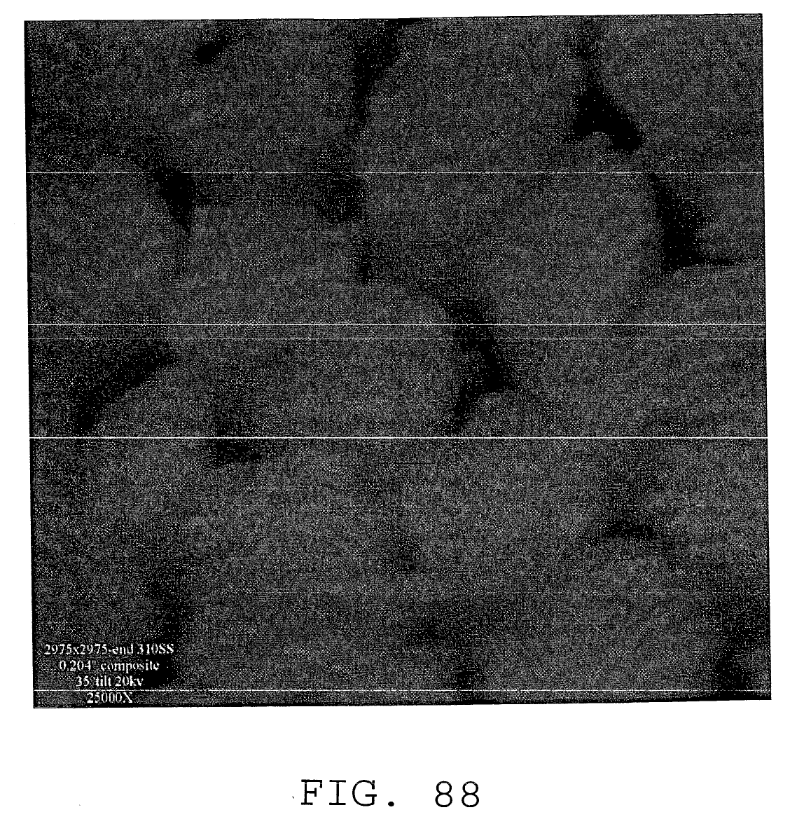

FIG. 85 is a block diagram illustrating a process 410 of converting the ultra fine fibers by diffusing doping elements into the fibers. In some embodiments, fibers formed from any of the processes set forth above are converted by process 410 into ceramic fibers. Alternately, a portion of a fiber less than the entire fiber, such as an outside layer of a fiber or stripes of zones along a length of a fiber are converted into ceramic portions. Preferably, the sacrificial coatings and/or claddings are removed from the fiber before performing the conversion process 410. In some embodiments, nanofiber having a diameter of less than 100 nanometers are converted.

FIG. 85 illustrates a step 412 of placing fibers 490 in a specialized atmosphere. The specialized atmosphere contains elements that diffuse into the material of the fibers 490 to form a ceramic material or create a ceramic layer on the fibers. In some embodiments, the fibers 490 are placed in an atmosphere containing nitrogen gas. However, one skilled in the art of ceramics will understand that other gases can be used as the dopant in the atmosphere during the conversion of the fibers. For example, gases containing elements including, for example, nitrogen, oxygen, hydrogen, carbon, boron, phosphorus, aluminum, silicon, sulfur, gallium, germanium, and the like, such as, for example, methane, carbon dioxide, di-borane, metallo-organics and the like and combinations of any of these gases can be used.

FIG. 85 illustrates the step 414 of heating the fibers. The fibers 490 may be heated rapidly by a conventional furnace or may be heated rapidly by infrared heating or induction heating. In some embodiments, the fibers are heated to a temperature at which dimers of the gas in the specialized atmosphere break apart into separate atoms.

FIG. 85 illustrates the step 416 of diffusing the disassociated atoms into the fiber. The temperature at which the dimers of a gas break apart is known to those skilled in the art of ceramics. In another embodiment, the fibers are heated to a temperature such that the gas in the specialized atmosphere is absorbed by the fiber to create a surface layer, such as an oxide layer on the fiber.

In some embodiments, titanium fibers are heated in an atmosphere containing nitrogen gas at a temperature that the diatomic nitrogen gas dissociates into nitrogen atoms. The nitrogen diatomic molecule absorbs into the titanium metal and dissociates into atomic or ionic nitrogen. In some embodiments, the fibers are preferably heated to a temperature between 250 and 750 degrees C., and more preferably to a temperature of about 400 degrees C. In embodiments, the fibers are heated to a temperature of about 250, 300, 400, 500, 600, 700 and 750 degrees C. In known nitriding processes, surface reactions are overcome by use of energy sources, in addition to thermal sources, to accelerate the dissociation, remove surface barriers and in some cases implant the nitrogen in a near surface layer. Therefore, nitriding of titanium can occur at temperatures of 250C-750C, which is well below the melting point of titanium, which is 1668 C. In other embodiments, fibers and gases are selected to form other ceramic fibers, including fibers of nickel carbide, nickel oxide, nickel boride, nickel phosphide and the like.

The rate of absorption of the dopant into the surface of the fiber is determined by surface properties, such as an oxide coatings on the surface of the nanofiber. Also, as one skilled in the art will understand, the concentration of gas dissolved is proportional to the square root of the partial pressure of the gas species. Therefore, increasing the gas pressure increases the absorption rate of the dopant.

In another embodiment, localized zones on the fibers 490 are heated to promote localized regions of doping. The localized zones or stripes on the fiber can be doped such that different regions along a longitudinal axis of the fiber have different properties. Thermal sources that heat localized areas, such as electron beams and lasers, are known in the art. Zones on the fibers can be doped with different dopants to create varying properties in zones on the same fiber. For example, a single fiber can have a conductor zone, a semiconductor zone and an insulator zone or any combination thereof.

Thus, methods of making ultra fine fibers and drawn ultra fine fibers have been disclosed. The drawn ultra fine fibers can be metallic fibers or can be other types of fibers depending on the processing steps. The process of producing ultra fine fibers using a drawing process can produce ultra fine fibers at a cost and quality previously unattainable. Ultra fine drawn metallic fibers can be produced having diameters less than 100 nanometers. The length of the drawn fibers is only limited by the ability to provide a continuous wire to the process, and can easily be on the order of hundreds or thousands of meters in length, or more. In contrast, nanofibers produced by growing a fiber on a substrate, imprinting with a platen, forming in a metal salt mixture, or forming in a gas jet stream are typically short in length. For example, a fiber grown on a substrate seldom is able to reach a length of one centimeter. The volume of fibers produced in a unit of time using the disclosed processes is a vast improvement over the volume of fibers produced using substrate or mixture growth techniques.

Ultra fine fibers produced using the methods disclosed herein can be cylindrical in cross section or can have some other controlled cross section. Additionally, the fibers have a substantially uniform cross section throughout their lengths. The fibers produced using the disclosed processes can have a diameter of between 25-70 nanometers and thus are of a sufficient size to allow ease of use and handling in a commercial process.

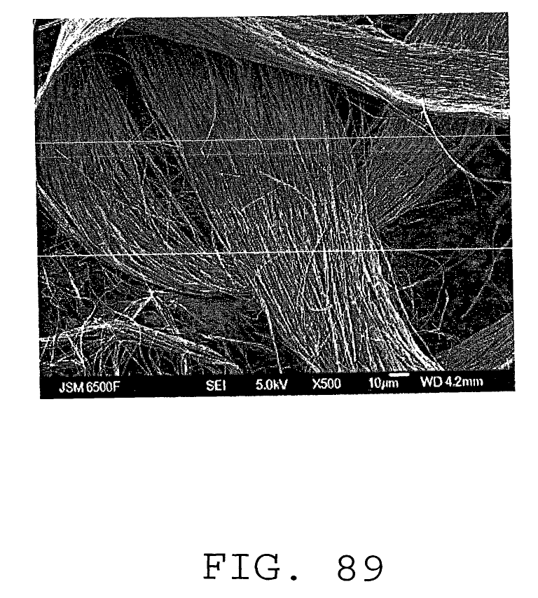

FIG. 86 shows an end view of a bundle of wires that have been processed through at least two drawing processes to create a plurality of ultra fine fibers. FIG. 86 shows a 16× magnification of a 0.204″ bundle. The end view in FIG. 86 shows approximately 3,000 bundles of 310 stainless steel. Each of the bundles represents a multiple wire assembly having approximately 3,000 310 stainless steel wires. Thus, the process is able to produce a bundle having approximately 9 million ultra fine stainless steel fibers.

FIG. 87 shows a further magnified end view of the bundle of the wires shown in FIG. 86. The end view of FIG. 87 is a 1,000× magnification of the same bundle shown in FIG. 86. The view illustrates how each of the assemblies forming the bundle depicted in FIG. 86 is an assembly of approximately 3,000 fibers.

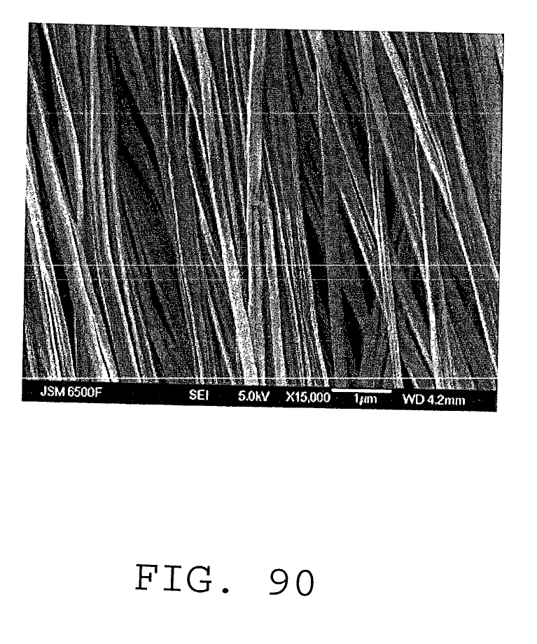

FIG. 88 is a further magnified end view of the bundle of wires shown in FIG. 86. The view of FIG. 88 is magnified 25,000× and illustrates the uniform structure of each of the stainless steel fibers in one of the assemblies as shown in FIG. 87.

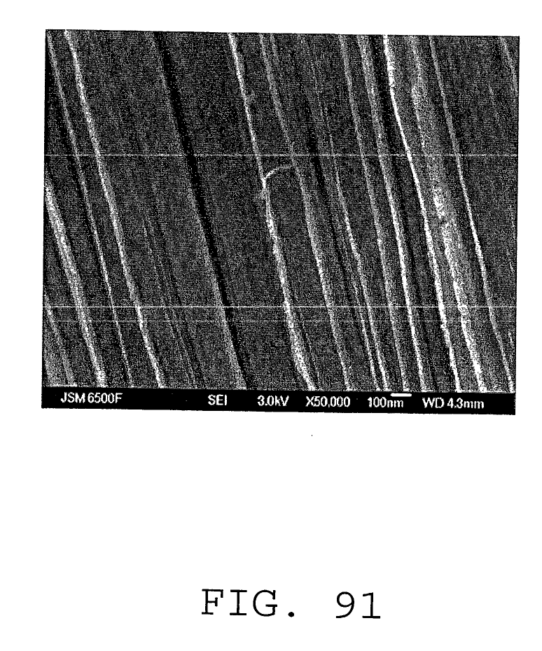

FIG. 89 shows a 500× magnified view of 316 stainless steel fibers manufactured according to one of the multiple drawing processes described above. The stainless fibers are shown with sacrificial material removed from the fibers, such that the fibers are no longer bound together in a structure.

FIG. 90 shows a further magnified view of the bundle of 316 stainless steel fibers shown in FIG. 89. The fibers are shown magnified 15,000× in FIG. 90. The fibers can be seen to be nearly uniform throughout its length. Additionally, all of the fibers can be seen to have nearly identical proportions.

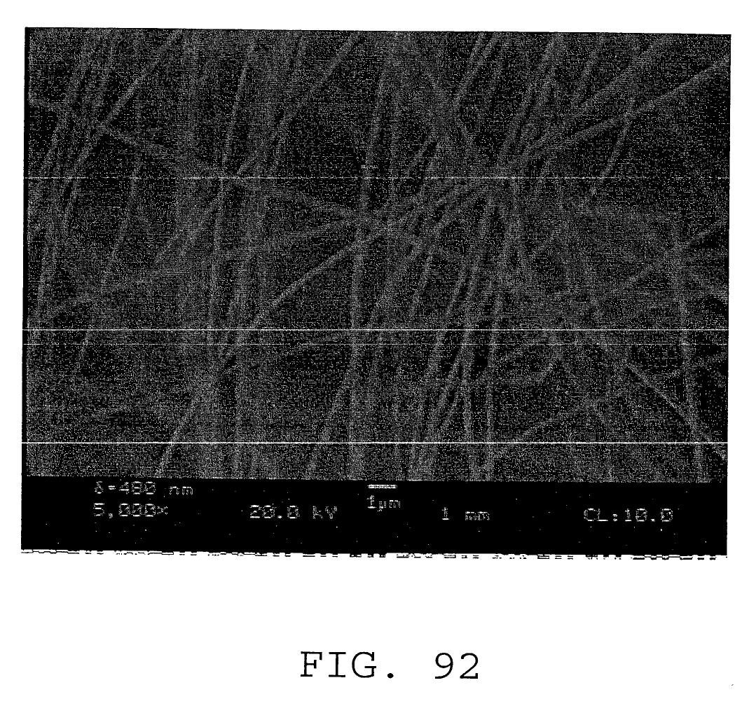

FIG. 91 shows a further magnified view of the fibers shown in FIG. 89, where the fibers are magnified by 50,000×. The uniform thickness of the fibers can be seen in this further magnified view.

FIG. 92 shows a magnified view of drawn stainless steel fibers. The view is magnified 5,000× and shows the relative uniformity of the fiber dimensions.

While the invention has as preferred embodiments the doping or other modifications to the composition of nanofibers that are made as described herein, in some embodiments, the composition and properties of fibers made by other means can also be also be modified by the methods of the invention. Such fibers can include fibers as disclosed in U.S. Pat. Nos. 6,322,713, 6,346,136, 6,382,526, and 6,407,443 each of which is hereby incorporated by reference in its entirety.

Industrial Applicability

The metallic wire 320 used is polycrystalline, and as one skilled in the art will understand each crystal will initially have dimensions on the order of 10 microns. The methods described herein draw the fibers to a diameter of less than 100 nanometers. In one embodiment, the described drawing process produces fibers containing a long single crystal on the order of 2 meters in length. Homogenous metal structures including nickel, gold, platinum, silver, palladium, silicon, germanium can be processed into the nano-structures. Also, alloys are made by co-drawing two or more concentrically aligned materials that after drawing are inter-diffused by a thermal process. The depth of interdiffusion is controlled by the time and temperature of the conversion process to convert the surface of the fiber resulting in a nano-heterostructure. In addition, the use of controlled atmospheres during the conversion process, or after the conversion process can be used to convert the metal into a ceramic or to create a ceramic layer.

In some embodiments, the fibers are used in filtration membranes. The membranes have metallic nanofibers that are ductile and corrosion resistant and can be used in high temperature environments. In some embodiments, the membranes have pore sizes capable of excluding particles of 100,000 Da, 10,000 Da, 1000 Da, 100 Da, or less. In other embodiments the membranes exclude particles of 1, 5, 10, 50, 100, or 500 nm. In still other embodiments, the membranes exclude particles of 0.1, 0.5, 1, 5, 10 microns, or more. Useful thicknesses of the membranes range from 2.5 microns, or less, to 25 mm, or more; generally from about 10 to 1500 microns, preferably from about 25 to 1000 microns, more preferably from about 50 to 500 microns, and still more preferably from about 100 to 250 microns. Membranes made from the nanofibers of the invention can be useful at any achievable bulk porosity, ranging from 1% to 99%, typically from 5% to 95%, generally from 15% to 90%, preferably from 25% to 85%, more preferably from 35% to 80%, and still more preferably from 40%, 45%, 50%, or 55% to 60%, 65%, 70%, or 75%. Such membranes can contain components, including nanofibers, that are capable of functioning as catalysts for oxidation, reduction, hydrogenation, and isomerization reactions, and the like.

In some embodiments, nanofibers can be used in energy devices such as micro fuel cell arrays such as those disclosed in U.S. patent application Ser. No. 10/006,186 entitled “Micro Fuel Cell Array,” filed on Dec. 10, 2001, the specification of which is hereby incorporated by reference in its entirety. In one embodiment zirconium fibers doped with yttrium are used. The fibers are oxidized to create yttria-stabilized zirconia fibers for use as the fuel cell ion transport membrane or as components of such membranes.

It is preferable to maintain the surfaces of the nanofibers clean of foreign material. In some embodiments, if oxidation of the surface of the nanofiber is prevented, for example, by drying leached fibers in the same gas environment that the fibers are doped with, nitriding is very rapid and occurs at extremely low temperatures. One skilled in the art of materials science would appreciate that gas doping technologies include chemical vapor deposition, physical vapor deposition (sputtering), electron beam, laser assist, solution contact with component soluble in the fiber, solution contact and evaporation of a solvent leaving a solute behind, dipping in a molten metal, and the like. Additionally, focused energy sources such as electron beam and laser can be used to localize the gas-solid doping region along the nanofiber length.

These methods of forming ultra fine fibers and the fibers themselves are expected to find various uses, such as, but not limited to, filters, sensors, capacitors, transistors, diodes, rectifiers, nano-switches, semiconductors, fuel cells, nanogears, nanomechanical devices, nanochemical devices, nanoelectrical devices, nanoelectromechanical systems, nanosprings, logic circuits, memory circuits, photoconductors and nanoscale connectors. Examples of an electronic sensor using ultra fine fibers are a piezo-resistive sensor, a chemo-resistive sensor, a nano-computer switch, a thermo-resistive sensor, a nano-transmitter, a nano-receiver, a thermocouple, and a nano-antenna.

The ultra fine fibers can be used in a biomedical sensor. An example of the biomedical sensor is a glucose sensor. The ultra fine fibers can be used in an opto-electronic converter, such as photovoltaic cell. The ultra fine fibers can be used in a filtration device. Examples of a filtration device are, but not limited to, a nano-catalytically enhanced filtration device, an aerosol filter device, and a nano-filtration membrane.

The ultra fine fibers can be used in an energy device. Examples of an energy device are, but not limited to, a nano-fuel cell array; a nano-storage capacitor; an infrared energy sensor, an ultraviolet energy sensor, a microwave energy sensor, an RF energy sensor, a thermocouple, and a nano-heater. The ultra fine fibers can be used in a chemical device. Examples of a chemical device are, but not limited to, a nano-engineered catalyst structure, a nano-chemical sensor, and a nano-chemical analyzer.

The ultra fine fibers can be used in a mechanical device. Examples of mechanical devices are, but not limited to, a nano-electro-mechanical system, a nano-spring, a nano-lever, a nano-diaphragm, a nano cable and a nanogear. The ultra fine fibers can be used in an electronic device. Examples of an electronic device are, but not limited to, a transistor, a diode, an LED, a nanotorus, a cathode emitter, a rectifier, a resistor, an inductor, a nanocomputer, and a nanomemory circuit. The ultra fine fibers can also be used in a quantum well device, a quantum cascade device, a ceramic superconductor, a nanowire laser.

Nanotechnology is a cluster of technologies directed to making, studying and manipulating structures of the size of ˜1-100 nanometer (1 nanometer=0.001 micrometer=one millionth of a millimeter). The size of such structures is roughly in between that of small molecules (<1 nm) and that of objects that are just too small to be seen with even the best light microscope. There are two ways to approach things of this size: (1) Top-down: making things smaller and smaller. Examples can be found in lithography and electronics. (2) Bottom-up: building nanostructures from atoms or molecules. Man-made examples of molecular nanostructures are fullerenes (for example bucky ball C₆₀), carbon nanotubes, monodisperse macromolecules like dendrimers, etc.

Mechanical techniques that allow for operation at the nanometer scale include the scanning tunneling microscope (STM) and the atomic force microscope (AFM). Individual molecules can be detected, positioned, or addressed on, for example, a surface of crystalline material using these techniques.

Piezoresistive Sensors

Piezoresistive materials display mechanical-stress-induced changes in electrical resistance, and are, accordingly, used in signal transducers. Piezoresistive sensors are used in, for example, scanning probe microscopy (SPM), accelerometers, and chemical sensors, as will be described in greater detail below. Micro-scale piezoresistive sensors have been formed lithographically using conventional silicon microchip fabrication technology. These sensors are typically on the scale of micrometers to tens of micrometers . Such sensors typically are V- or U-shaped silicon cantilevers in which each leg of the V is attached to an electrode on the body of the device and the vertex of the V is cantilevered. A sensing means can be attached at the vertex of the V. When the sensing means is deflected, the force is transmitted to the cantilever. The sensing means is distal to the body of the device, maximizing the torque on the cantilever, and consequently, increasing the stress on the sensor. The deformation causes a measurable change in resistance in the sensor.

The ultra fine fibers described herein may be fabricated from piezoresistive materials. At least two types of piezoresistive materials may be fabricated from the disclosed fibers: metal and ceramic. Metals such as, for example, gold and germanium, are piezoresistive. For example, gold fibers may be fabricated into analogous cantilever structures using SPM techniques. See, e.g., J. Lefebvre et al., Appl. Phys. Let. 75:3014-3016 (Nov. 8, 1999) and S. B. Carlsson et al., Appl. Phys. Let. 75:1461-1463 Sep. 6, 1999, the disclosures of which are hereby incorporated by reference in their entirety, for methods of moving objects with SPM techniques. Piezoresistive ceramics include, for example, titanates, zirconates, nithenium(IV) oxide, gallium nitride, and molybdenum carbide. Metal fibers of the appropriate composition may be fabricated into nanocantilevers as described above and converted into piezoresistive ceramics as disclosed herein by, for example, converting the metal into an oxide, nitride, or carbide. Electrical contacts to the legs of the nanodevice may be fabricated by, for example, lithographic techniques used in semiconductor fabrication. Because the scale of these nanoscale cantilevers is on the order of tens to hundreds of nanometers, they are more sensitive and have faster response times than their microscale counterparts.

The cantilever itself is the sensing means for an accelerometer. To fabricate a chemical sensor, the cantilever is coated with a material that binds with the desired analyte. For example, a gold cantilever may be coated with single-stranded DNA modified with thiolate ends, as in known in the art. When a complementary strand of DNA or RNA binds to the DNA attached to the cantilever, the addition weight deflects the cantilever. Through appropriate standardization, the technique may be used quantitatively. If desired, the bound strand may be washed from the sensor, by denaturing the DNA, for example, regenerating the sensor. In another embodiment, the cantilever is coated with a material that reacts with the analyte irreversibly, for example, heme, which irreversibly binds carbon monoxide. The design and selection of chemical sensing means for cantilever-type piezoresistive sensors is well known in the art. In yet another embodiment, the wire itself is selected to react with the analyte, either reversibly or irreversibly. For example, a palladium wire may be used to detect hydrogen gas.

Macro- and micro-piezoresistive sensors have also been constructed by attaching a piezoresistive material to a diaphragm. Deflecting the diaphragm induces stress on the piezoresistive material, generating a measurable signal. Such devices are commonly used as pressure sensors. Nanoscale sensors of this design may be constructed from the ultra fine fibers disclosed herein. An ultra fine wire made from a piezoresistive material is anchored to a diaphragm. For example, a gold nanowire may be anchored to a bacterial cell wall by coating with known cell wall anchoring proteins modified with thiolate tails. This coated gold nanowire is then attached to a cell wall through the cell wall anchoring proteins. Changes in the turgor pressure of the cell result in changes in the resistance of the wire, which are converted into pressure units.

Because the disclosed ultra fine fibers are on the order of tens of nanometers in diameter, a piezoresistive sensor may be constructed by simply bridging a suitably wide gap with a fiber of piezoresistive material. The required gap will, of course, vary with the physical properties of the material, but may be ascertained by one of ordinary skill from the known physical properties of the selected material without undue experimentation. The fiber is then modified to form a sensing means of the type discussed for the cantilever-type sensors. These straight sensors are easier to construct than the cantilever-type and may be used for similar applications. Because the ultra fine wire is so thin, a tiny perturbation, for example, a few hundreds or even tens of molecules of analyte, is sufficient to generate a signal.

The disclosed sensors are especially useful in microfluidics devices because they allow the continuous monitoring of the fluid stream without sampling. Microfluidics devices often use spectroscopic means to detect analytes. The disclosed chemical sensors are complementary to the spectroscopic means, and allow the detection of analytes that do not have chromophores. The sensors may further be integrated into the control system of the microfluidic device to control the fluid flow depending on the composition of the fluid.

Chemoresistive Sensors

Certain materials are known to change electrical resistance when exposed to an analyte. These materials are called chemoresistive. In U.S. Pat. No. 3,933,028, a chemoresistive cobalt monoxide ceramic material is used in an oxygen sensor. In U.S. Pat. No. 5,518,603, the disclosure of which is hereby incorporated by reference in its entirety, a chemoresistive stabilized zirconia ceramic is used in an oxygen sensor. Because the ultra fine fibers may be locally modified to form ceramic phases, as described herein, chemoresistive sensors of this type are readily fabricated. For example, a section of a cobalt fiber may be converted into cobalt monoxide by controlled laser-heating of the fiber in an oxygen plasma. The cobalt monoxide section of the ultra fine wire is a chemoresistive material sensitive to oxygen concentration. Electrical connections for the sensor portion are preformed because the sensor is made from a portion of a wire. The sensor may be used as described in the referenced patents to determine oxygen concentration in a gas stream. For example, the sensor is placed in a housing in fluid contact with the exhaust gases from an internal combustion engine. The housing also comprises a heating element that maintains the temperature of the nanosensor above about 900° C. The sensor is connected to a device for monitoring the electrical resistance of the sensor. Through appropriate calibration, the oxygen concentration of the exhaust gases may be determined. A key advantage of nanochemoresistive sensors is the ability to detect the analyte at lower concentrations and a faster response time than the macroscale devices presently used.

Chemical Sensors

Another type of chemical sensor is based upon a selection of components that permit the analyte to destroy the ultra fine fiber, i.e., the electrical resistance becomes infinite. In this case, the fiber material is selected to react with the analyte destructively. Because the disclosed fibers are ultrathin, an extremely low concentration of the analyte can destroy the fiber and break an electrical circuit. By deploying a series of fibers of increasing diameter, one may construct a sensor array that integrates the total amount of analyte to which the sensor is exposed. In such a sensor array, the thinnest fiber will fail after contact with a certain amount of analvte. As the sensor array is exposed to additional analyte, successively thicker fibers will fail. This type of sensor may be used as a dosimeter. The sensor array may be monitored continuously, i.e., connected to a device that detects the successive failure of wires as they occur, or intermittently, i.e., the sensor array is carried into the hazardous environment, then returned to a monitoring station to determine the chemical exposure in that environment. For example, ultra fine nickel wires as disclosed herein may be used to detect exposure to carbon monoxide. In one preferred embodiment, a sensor array is constructed from a series of nickel wires of known diameter, for example 50, 60, 70, and 80 nm, mounted in parallel such that the first end of each nickel wire is attached to a common first electrode and the second end of each wire is attached to a common second electrode. The sensor array is heated to about 50° C. The resistance of the array between the common electrodes is monitored. If CO is present, it will react with the nickel to form Ni(CO)₄, a gas. After exposure to a sufficient quantity of CO, the thinnest wire will break, causing an increase in resistance. Additional CO will cause additional wires to break. Selection of a particular appropriate wire material to detect a particular analyte is within the scope of the skilled artisan, in keeping with the principles of the foregoing discussion.

Electronic Noses

Combinations of the disclosed chemical-sensors may be used to manufacture an “electronic nose.” An electronic nose is a device comprising a plurality of chemical sensors, wherein the chemical sensors are specific to different analytes, for example, as described in U.S. Pat. No. 6,411,905, the disclosure of which is hereby incorporated by reference in its entirety. In one embodiment, the electronic nose is attached to a computing device, for example, a neural network device, which is “trained” by exposure to known odors, usually a mixture of analytes, for example, 18-year-old scotch or an American Beauty rose. After sufficient training, the electronic nose may be used to classify unknown odors, or even to determine the quality of an odor, for example, the ripeness of brie or if a sample of a unique perfume is counterfeit.

Because of their nano dimensionality, the chemical sensors made according to the disclosure herein have significant advantages in the construction of electronic noses. First, many more small sensors may be packed into the same volume as fewer large sensors. A higher density of different sensors permits a greater variety of analytes to be measured. The more analytes, the more discriminating the nose. Second, the nanoscale sensors are more sensitive, because the nanoscale sensors disclosed herein can, under some conditions, detect tens to hundreds of molecules.

Nanoantenna, Receiver, Transmitter

Two continuing issues in the design of nanoscale devices, particularly autonomous nanoscale robots, are (1) communicating with the robot, and (2) powering the robot. For example, proposed nanorobots would be injected into the bloodstream or implanted where they would monitor, for example, insulin levels. These nanorobots typically have a way of communicating with the outside world and typically also have a power source. The ultra fine fibers disclosed herein have utility in both applications. For communicating with the outside world, the ultra fine fibers may be used as antennae, both for transmitting and receiving information. A theoretical framework for micro dipole antenna design is provided in U.S. Pat. No. 4,631,473, the disclosure of which is hereby incorporated by reference in its entirety. Furthermore, the disclosed ultra fine fibers may be used to power the nanorobots. An ultra fine conductive wire with an insulating coating, as disclosed herein, may be formed into a coil. Exposing the coil to an RF field will generate an AC current in the coil. A coil may have any number of turns, and may be made, for example, using SPM methods, as discussed above. In one embodiment, a coaxial ultra fine wire comprising, for example, a platinum core and an aluminum outer layer is coiled, then the aluminum outer layer is converted into an insulating alumina layer as described herein. In another embodiment, an ultra fine wire is formed into a coil and treated such that only the surface of the wire is converted into an insulating layer.

Nanoswitch, Transistor

An example of a field-effect transistor based on the ultra fine wires disclosed herein, made using processing methods known in the silicon photolithography arts follows. A silicon oxide film is formed on a silicon gate. A germanium ultra fine wire as disclosed herein is placed on the silicon dioxide film. The germanium wire may be n- or p-doped as disclosed herein, before or after the fabrication of the device. A source electrode is deposited on a first portion of the germanium wire and a drain electrode on a second portion. In operation, applying an appropriate voltage to the silicon gate switches the germanium wire, allowing current to pass from the source to the drain electrodes. In another embodiment, the gate is a second ultra fine wire. Preferably, the surface layer of the gate wire is an electrically insulating layer, the fabrication of which is disclosed herein.

The ultra fine germanium wires disclosed herein have advantages over single-wall carbon nanotubes (SWNTs) in transistor applications. SWNTs may be metallic or semiconducting. Currently, there exists no method of synthesizing only one type or the other. Accordingly, a batch of SWNTs is typically a mixture of both types. Moreover, no method exists to determine whether any particular SWNT is metallic or semiconducting short of testing it, by for example, making a device from it. The ultra fine germanium wires of the present invention, on the other hand, have known physical properties, which may be further controlled by doping. Consequently, the ultra fine wires disclosed herein provide more predictable behavior in transistors than currently available SWNTs.

Nanocatalysts

Heterogeneous catalysts are commonly used in industrial applications, for example, for reforming naphtha for gasoline manufacture (Platforming), synthesizing ammonia from nitrogen and hydrogen (Bom-Haber process), and polyethylene synthesis (Zigler-Natta). Many heterogeneous catalysts are metals or metal oxides disposed of on a support, for example, alumina or silica, which, inter alia, provides a large surface area for a small amount of catalyst. Heterogeneous catalysts have a number of advantages over homogeneous catalysts: ease of product separation, continuous flow processing, and faster rates, and are sometimes the only known catalyst for a process. Heterogeneous catalysts also have some disadvantages: the catalytic species are often poorly characterized and catalyst leaching, for example. The characterization issue makes it difficult to monitor the catalytic activity by means other than throughput. Accordingly, in many cases, the activity of a new, unused batch of catalyst cannot be predicted. Furthermore, the precise composition of the catalytic species is often unknown.

Heterogeneous catalysts based on the disclosed ultra fine wires overcome many of the disadvantages of heterogeneous catalysts, while retaining the advantages. The composition of the disclosed ultra fine wires may be completely controlled. For example, chemically pure wires may be made by the disclosed process. Alloy wires may be made either from alloy starting wires or the alloy may be formed in the drawing process by alloying of the wire and the coating, as disclosed herein. The disclosed ultra fine wires may also be modified post-drawing. Wires may be doped as described herein, for example. Oxides, nitrides, and carbides of the metal(s) may also be made. Combinations of these processes may be applied to the disclosed wires. Unlike a heterogeneous catalyst dispersed on an inert support, the precise chemical compositions of the disclosed ultra fine wires may be ascertained. The precise composition will depend on the reaction or process in question. For example, many catalytic reactions use noble metal catalysts, including platinum, palladium, and rhodium. Others use, for example, iron or nickel. Selection of the appropriate catalyst is within the scope of the skilled artisan without undue experimentation.

Changes in the composition of the wire with time are also easily monitored. Accordingly, the activity of the catalyst may be correlated to a physical property of the catalyst other than turnover. Such studies are also useful in optimizing or developing catalysts. Also, deposition of side products, for example, coking, is more easily monitored.

The ultra fine wires have a large surface area to volume ratio, which provides one of the advantages generally associated with dispersing a catalyst on a support. Unlike a supported catalyst, however, an ultra fine wire catalyst will not leach as easily since the catalyst and the support are one and the same, and not a catalyst simply absorbed on a support. Furthermore, leaching may be monitored by simple weighing.

Another advantage of a catalyst comprising ultra fine wires compared with a supported catalyst is ease in recycling the spent catalyst. The inert support, which often comprises the majority of the catalyst system, often makes recycling the active component of the system difficult. Because the support in the ultra fine wire is the wire itself, recycling is simplified. Moreover, the inert support in conventional catalysts is often not recyclable, increasing waste disposal costs.

In one embodiment, the wires are woven into a fabric through which the reactants are flowed. The reactants may be in a liquid phase, a gas phase, a supercritical phase, or any combination thereof. In another embodiment, the catalyst is used as a “wool.”

The disclosed ultra fine wires are also useful as electrodes for electrochemical reactions. Platinum is a preferred metal for this application, but other metals and alloys are also useful as will be apparent to the skilled artisan. The large surface to volume ratio of the ultra fine wires provides faster reaction rates compared to micro- or macroscale electrodes.

Biomedical Sensor

The ultra fine fibers can be used in a number of areas related to biomedical applications of nanotechnology. Biomedical applications include diagnostic or monitoring, drug delivery devices, and prostheses and implants.

Diagnostic sensors or devices may be used either in-vitro or in-vivo. In-vitro devices utilize a “laboratory-on-a-chip” approach in which the device extracts blood or other substances from the body and subsequently performs relatively complex laboratory analyses. This is all performed inside of a package that is small enough to be carried by the subject. In-vivo devices can be either implanted at some site inside the body or transported within the body, such as within the digestive, cardiovascular, or other bodily system. Delivery devices entail the use of nano and micro scale pumps, transport systems, and other supporting hardware and electronics

In-vivo diagnostic devices such as nanorobots are contemplated as working machines with characteristic sizes of 0.5-3 micrometers that are built from smaller component parts in the range of 1-100 nanometers. The 3 micrometer upper limit is considered small enough to clear the narrowest human capillaries. Ultra fine fibers in the range of 10 to 100 nanometers in diameter can be use as structural components providing a framework for such devices. Such fibers also can serve as component parts in actuators, sensors, and receptor sites. For example, a bimetallic fiber can be produced such that its form or length is sensitive to temperature. Alternatively, a force or pressure sensor can be produced by rigidly attaching stiff ultra fine fibers to form a cantilever beam. The magnitude of external forces on this nano-beam can be determined by sensing the amount of deflection. Using this approach, force resolutions of less than 10⁻¹⁹ N have been reported using a 230-micron long, 60-nm thick, silicon cantilever. Structural, material, or chemical properties of the ultra fine fibers can also be utilized as receptors for certain chemicals or biological substances that are measured or analyzed by a nanorobot.

Other in-vivo devices include implants for applications such as glucose monitoring or delivery. Ultra fine fibers are again used in such devices to form sub-systems such as nano and micro scale pumps. Ultra fine fibers may also be used for form a mesh through which insulin or other substances flow into the body or bloodstream at slow, controlled rates. Material properties of the fibers themselves or in combination with other mesh components can be utilized to control the rate of delivery. In the case of an insulin delivery mesh, for instance, the mesh comes into contact with glucose in the blood, which can automatically trigger the mesh to expand or contract depending of the glucose level. A low level of glucose can cause the pores to open more, thus releasing insulin and/or any selected composition enabling the body to better absorb insulin. In another embodiment, shorter ultra fine fibers of substantially equal length are arranged such that the ends of the fibers are bundled together, thus forming a filter or screen through which smaller molecules or substances may pass.

Nanodrugs constitute another key area in which ultra fine fibers may be utilized. Ultra fine fibers can be used along with buckyballs and nanotubes as drug delivery vehicles since their small size enables them to more easily pass through the body. Active substance can be bonded to the surface of an ultra thin fiber or contained inside a structure formed either from ultra fine fibers alone or in combination with other components. A related use involves the formation of monocrystalline materials such as zinc oxide for use in sunscreen products. Particles in the range of 3 to 200 nanometers are currently used for such purposes.

Another biomedical application of ultra fine fibers is in the area of prostheses and implants. Prostheses based upon the use of nanostructures are currently being investigated in an effort to improve the quality and lifetime of such devises. For instance, one group of researchers have developed a new generation of alumina-zirconia nanocomposites having a high resistance to crack propagation, and as a consequence improving lifetime and reliability of ceramic joint prostheses. Ultra fine fibers made of such materials, according to the present invention, can be advantageous in such structures.

Nano-Filtration Membrane

Ultra fine fibers may also be utilized in the area of membrane filtration. Membrane filters separate substances contained in a fluid through the use of a polymeric or inorganic material containing pores so small that a significant fluid pressure is required to drive the liquid through them. The resulting semipermeable media prevent substances or particles of a selected size from passing through the porous membrane, thus separating these particles from other, smaller particles and/or from the fluid. While there is no universal standard, membrane filters are generally classified by their effective pore diameter:

Reverse Osmosis (RO): Effective pore diameter less than 1 nanometer.

Nanofiltration (NF): Effective pore diameter from 1 to 10 nanometers.

Ultrafiltration (UF): Effective pore diameter from 10 to 100 nanometers.

Microfiltration (MF): Effective pore diameter greater than 100 nanometers.

In some embodiments, RO, NF, UF, or MF membrane filters are fabricated by weaving ultrafine fibers to form fabrics having a selected pore size. Due to the small diameter of the nanowires disclosed herein, the thickness of such a fabric can be as small as the diameter of a fiber. Likewise, filters composed of multiple layers of woven material can be prepared. Different fiber densities, diameters, compositions, and combinations can be employed in order to achieve desired performance parameters, as will be recognized by the skilled artisan. In any of the filter applications disclosed herein, different fiber compositions and combinations can be selected to obtain a filter material that is resistant to corrosion by a particular feedstream composition, or that is reactive with a desired component, or that is catalytic for a selected reaction, or that can monitor or sense analytes within a feedstream, retentate, or filtrate. Details of such properties, which can be designed into any type of class or filter medium, are disclosed throughout this description of embodiments of the invention.

In other embodiments, RO, NF, UF, or MF nonwoven membrane filters, structures, fabrics, and formed membranes are fabricated using the ultrafine fibers of the present invention, employing the techniques disclosed in copending U.S. patent application Ser. No. 10/158,391, entitled FORMED MEMBRANE AND METHOD OF MAKING, filed on May 28, 2002, the disclosure of which is hereby incorporated by reference in its entirety. Briefly, a multiplicity of fine metallic fibers are suspended within a liquid binder and placed within a pressure vessel to overlay a porous substrate of any desired shape. A pressure is applied to the liquid binder, forcing the liquid binder through the porous formed substrate, and depositing the fine fibers onto the substrate. The layer of membrane material is formed in the shape of the substrate. Initially, the liquid binder migrates through the substrate in accordance with the shape and the flow characteristics of the container. After a partial accumulation of the fine fibers onto the surface of the substrate, the liquid binder migrates preferentially through the areas of least accumulation of the fine fibers onto the surface of the substrate. This pressure wet lay process results in a substantially uniform porosity to the layer of membrane material. The fine fibers can have any of the compositions described herein, permitting preparation of a formed membrane filter having catalytic, electrical, sensing, analytical, and/or other characteristics as desired.

In certain other embodiments, RO, NF, UF, or MF membrane filters are fabricated through the use of bundles of ultra fine fibers. The ultra fine fibers are bundled so that the fiber ends form a mold pattern that is submerged in a filter material in the form of a liquid or gel. The filter material is then hardened or cured though a process such as, for example, cooling. The ultra fine fiber mold is separated from the filter material either during or after this process to produce a porous filter with pore diameters related to the fiber diameters. This method may be used to produce filters that are substantially identical to one another, since the same ultra fine fiber mold was used to produce each. Other methods for utilizing ultra fine fiber mold in produce such membrane filters may also be used and the method herein recited should not be considered as limiting. For instance, the ultra fine fiber mold may be dissolved or otherwise destroyed after the filter material is cured, thus leaving voids where the fibers once existed.

Such fabrication methods can be used to advantage by allowing the use of broader range of membrane materials. For instance, ceramic membrane bioreactors have been implemented in wastewater treatment plant. Ceramic membranes have been shown to some advantages over the more commonly used organic membranes. One advantage is the lifetime of the ceramic membrane, which is reported to be more than seven years (organic membranes have lifetimes of three to five years). Another advantage of ceramic membranes are that they can withstand a wider range of washing procedure that might otherwise destroy an organic membrane. Other materials, such as stainless steel, may be utilized to withstand harsh environments such as temperature extremes or the filtering of corrosive materials.

In other embodiments, ultra fine fibers are used to strengthen a membrane filter so that it will withstand high differential working pressures. A pressure differential is utilized in filtration to cause liquid to flow across the membrane in a direction from the more concentrated solution to the more dilute (filtered) solution. Typical differential working pressures for NF filters is in the range of 150 to 300 psi, while RO filters can operate with pressure differentials as high as 2000 psig. Ultra fine fibers can be used to strengthen the membrane while minimizing or eliminating interference with the filter's function. For example, relatively long fibers (compared to fiber diameter) can be added to the membrane material during fabrication in the form of a fiber array or mesh. Since the ultra fine fibers have diameters that are approximately the same as the pore diameters, the fibers can be evenly distributed throughout the material in a homogeneous manner to produce a membrane with substantially uniform strength. Alternatively, the ultra fine fiber array or mesh can be located adjacent to the membrane to produce a similar enhancement of the effective membrane strength. Such a construction the ultra fine fiber array or mesh can offer other advantages such as reducing filter blockage that can occur due to the embedding of material in the membrane's pores. Similarly, the ultra fine fiber array or mesh can be located upstream of the membrane filter a short distance to act as a pre-filter, thus extending the life or effectiveness of the membrane filter.

In another embodiment, the ultra fine fiber array or mesh is used to create a composite membrane filter that has favorable properties. For instance, electrodialysis or electrodialysis reversal, which uses an electrical current to separate ions from the water, is used in conjunction with a NF or RO filter. By making the ultra fine fiber array or mesh of a conductive material, both functions can be combined in to a single filter unit. Other composite membrane filter properties are also possible as a result of the wide array of materials that can be formed into ultra fine fibers by the methods disclosed herein.

In certain embodiments, the ultra fine fiber array or mesh itself is used as a filter, either alone or in conjunction with other filters. The median size of voids in an ultra fine fiber array or mesh is directly related to the diameter of the individual ultra fine fibers used to produce the mesh. In other embodiments, shorter ultra fine fibers of substantially equal length are arranged such that the ends of the fibers are bundled together, thus forming a filter or screen through which smaller molecules or substances may pass. Since ultra fine fibers can be formed from many different types of materials, an ultra fine fiber array or mesh can be produced in other embodiments that have favorable properties. For instance, materials such as stainless steel may be utilized to withstand harsh environments such as temperature extremes or the filtering of corrosive materials.

Nano-Catalytically Enhanced Filtration Device

In certain embodiments, the performance of membrane and other types of filters can be enhanced when used in conjunction with a chemical catalyst. For instance, a catalytic converter completes the oxidation of a fuel that was not completely oxidized in the engine to reduce the amount of pollutants emitted. Other catalysts can be used in which the resultant product is more easily filtered.

As a result of their extremely small scale, the surface area of nanoparticles is large compared to the total number of molecules comprising each particle. Because of this characteristic, nanoparticles have been found to exhibit unique properties as catalysts. For example, nano-sized irridium particles can be used to make a nearly uniform catalyst that increased reaction efficiency by ten fold compared to prior art devices utilizing the same material, but not in the form of nanoparticles. In certain embodiments, ultra fine fibers in the form of elongated rods or filament can be used to enhance catalytic effect. The elongated forms of ultra fine fibers can offer unique material properties as compared to more spherically shaped nanoparticles. For instance, the average length of the ultra fine fibers can be used as a parameter to adjust the reaction efficiency. In other embodiments, the nano-structure of the ultra fine fibers is used to increase the strength or other macro properties of the material.

Aerosol Filter Device

One concern associated with the rapidly expanding use of nanoparticles is the potential for health risks due to inhalation or leakage into undesired parts of the body. While the concern regarding negative health consequences as a result from nanotechnology is largely speculative at this point, work has already been initiated to study potential effects. Aerosol filters to prevent inhalation of nanoparticles have been developed to reduce the potential risk.

In certain embodiments, the ultra fine fibers disclosed herein can be used to test the effectiveness of such filters by generating calibration nanoparticles in the form of elongated rods of known diameter and length. Such nanostructures can be used to simulate the size and shape of carbon nanotubes, considered to be one of the more promising aspects of nanotechnology. The calibration rods can also be used to calibrate aerosol particle detectors.

Optical Gratings

In certain embodiments, the ultra fine fibers can be used as be use to form a fine pitched grating. The wavelength discrimination of a diffraction grating is directly related to the grating pitch. Commercial gratings are currently available with grating pitches of around 300 nm. By aligning ultra fine fibers to form a line grid, grating pitches of less than 200 nm are possible. Because of the extremely fine grating pitch possible using ultra fine fibers, such gratings can be used in the visible spectrum applications requiring sub-wavelength as well as in applications utilizing deep UV wavelengths. Such fine pitch gratings can be used to as part of a high resolution spectrometer. Other applications include high quality polarizers, anti-reflection surfaces, dense wavelength division multiplexers.

Nanotechnology and Molecular Photovoltaic Cells

In organic photovoltaic devices, photoinduced electron transfer from a donor to an acceptor molecule generates charged molecules. Preferably, the donor and acceptor molecules are in close proximity. An advantageous molecular photovoltaic cell can have a large proportion, or in some embodiments substantially all, of its donor molecules close to acceptor molecules. In these embodiments, the donor molecules are preferably distributed as a monomolecular layer on a nanocrystalline acceptor material. The donor and acceptor molecules exist in interpenetrating networks molecules, providing a bulk-heterojunction (b-junction). Preferably, the photovoltaic active layer contains nanoparticles, including the nanofibers disclosed herein.

A difficulty of conventional molecular photovoltaics is the low mobility of the charge carriers, limiting the efficiency of the light induced charges to reach the electrodes of the photovoltaic device. In order to obtain a maximum efficiency of conversion of solar light to electricity, it is preferable to make b-junctions in such a way that (a) the charge carrier mobility is optimized and (b) the path length for the charges to reach the electrodes is minimized. Both goals can be reached by constructing b-junctions consisting of well ordered arrays or interpenetrating networks of donor and acceptor molecules. Well ordered b-junction photovoltaic cells can be made employing the nanowires of the present invention.

In conventional photovoltaic cells, the active portion is made of silicon, either in single-crystalline (sc-Si) form, or in the multi-crystalline (mc-Si) form. The thickness of the silicon layer in these devices is ˜150-300 um, causing high material costs per square meter. Alternatively, thin photovoltaic active layers, around 1 to 3 um in thickness, made of, for example, amorphous silicon (a-Si), copper indium diselenide (CuInSe₂), or cadmium telluride (CdTe), as light absorbing materials, are thick enough to absorb the bulk of the incoming light.

Even thinner layers are sufficient when strongly absorbing organic dyes are used: conjugated organic polymers (CPs) and some low molecular weight organic dyes can have absorption coefficients of 10⁵-10⁶. This allows for a light absorbing film thickness of only 100-300 nm. Nanolayers or nanostructures, containing, for example, semiconducting titanium dioxide (nc-TiO₂), can provide inter-particle electrical contact. The resulting porous network of particles is subsequently coated with a layer of organic dye molecules, permitting absorbance of most of the incoming light.

Nanofiber Storage Capacitor

A capacitor consists of two isolated conductive plates. When an electric charge is applied to the conductive plates of the capacitor, an electric field is created between the plates. Capacitors are often used for their capacity to store electrical potential energy, and to quickly discharge that stored energy as needed for high-speed applications. When built on the nanometer scale, for example with dimensions between 1 to 1000 nanometers, such capacitors (referred to herein as “nano-capacitors”) are useful in a wide variety of applications, including making basic measurements and minimizing circuitry dimensions in electronic components. One of ordinary skill in the art will recognize that the practical applications for nano-capacitors are particularly wide-ranging.

For example, in certain embodiments the fine metallic fibers described herein can be used to construct the conducting plates of a nano-capacitor. Specifically, by fabricating such wires into a fine membrane, a nano-capacitor can be constructed that is capable of storing and detecting extremely small amounts of electric charge. For example, using a precise electron pump, electrons can be dispensed onto one of the plates of a nano-capacitor that is capable of detecting and counting electrons with an accuracy of, for example, one electron in 70 million. Such nano-capacitors can exhibit single-electron quantum effects.

A nano-capacitor is also useful in applications other than detection and measurement of small quantities of electric charge. Nano-capacitors also find application in binary logic electronics, where the presence or absence of a charge on the nano-capacitor signifies an “on” or “off” state. The small physical dimensions of such nano-capacitors facilitate miniaturization of electronics devices.

Furthermore, a cylindrical nano-capacitor can be constructed using the techniques described herein. By fabricating an inner conductive fiber core surrounded by a non-conductive cladding layer, which is surrounded by a conductive fiber shell, a cylindrical nano-capacitor is formed, wherein the inner non-conductive cladding layer acts as the dielectric. In such embodiments, individual fine metallic fibers are electrically connected to the inner and outer metallic surfaces, thereby permitting the cylindrical nano-capacitor to be placed in electrical connection with other electronic components. Just as a macroscopic coaxial cable is effectively a cylindrical capacitor, the cylindrical nano-capacitor described herein can be used as a coaxial conductor for transmitting electrical signals across a finite distance.

Nanofiber Fuel Cell Array

In a fuel cell, chemical energy is converted directly into electrical power by means of electrochemical reactions, thereby resulting in particularly high conversion efficiencies. At the most fundamental level, a fuel cell comprises an electrolyte that separates an anode from a cathode. Hydrogen gas passing over the anode is oxidized, producing hydrogen ions (protons) and electrons. The protons migrate through the electrolyte to the cathode, while the electrons induce a current in an electric circuit. The electrons released at the cathode recombine with the protons to form hydrogen gas, which reacts with oxygen to form exhaust water.

When built on the nanometer scale, for example with dimensions between 1 to 1000 nanometers, fuel cells and fuel cell arrays (referred to herein as “nano-fuel cells”) are useful in a wide variety of applications. For example, nanometer-scale fuel cells applying a “power plant on a chip” approach can be used to power small electronic devices such as cellular telephones, pagers and laptop computers. Similarly, implantable biologically acceptable fuel cells can be used to perform, or enhance the effect of, a medical treatment from within the body. While such nano-fuel cells are capable of producing only small amounts of power when taken individually—typically less than 1 watt per hour—when bundled together in large numbers into an array, larger power outputs can be achieved.

In addition to smaller physical size requirements, fuel cells built on the nanometer scale offer several other advantages over traditional portable power sources such as, for example, dry cell batteries. In particular, fuel cells can be “recharged” instantaneously by simply providing an additional fuel source, and fuel cells do not produce toxic waste products.

The fine metallic fibers disclosed herein can be used in nano-fuel cells to form subsystem such as nanometer scale pumps, conduits and membranes. For example, the anode, cathode, and/or electrolyte can comprise a membrane formed from a plurality of such fine metallic fibers. In other embodiments, conduits for transmission of electric current, exhaust water or heat, and fuel in a nano-fuel cell can comprise fine metallic fibers. In such embodiments, the electrolyte and electrical interconnections can be fabricated by powder sintering or chemical vapor deposition.

Nanofiber Thermocouple

Thermocouples are based on the Seebeck effect wherein a junction of dissimilar conductors induces a voltage that varies with temperature. A thermocouple is formed from two different metals, jointed at two points in such a way that a small voltage is produced when the two junctions are at different temperatures. Thermocouples are popular temperature sensors in a wide variety of applications. The disclosed ultra fine wires are useful in making nanothermocouples. Because the method disclosed herein may be used to fabricate ultra fine wires of many compositions, popular thermocouple materials, for example, constantin, alumel, cromel, platinum, and platinum-rhodium alloys, are available as ultra fine wires for the fabrication of nanothermocouples. The three most common thermocouple alloys for moderate temperature measurements are iron-constantan, copper-constantan and chromel-alumel. Criteria for selecting materials suitable for fabricating thermocouple junctions are well known in the art.

The fine metallic fibers disclosed herein can be used to construct a thermocouple on the nanometer scale (referred to herein as a “nano-thermocouple”). A nano-thermocouple comprised of any of the aforementioned common alloy pairs can be constructed using the fine metallic wire fabrication techniques disclosed herein. The junction between the two metals can be welded by any technique adequate for joining two fine metallic wires, such as arc welding, diffusion welding, spot welding or seam welding. In one embodiment, wires made of dissimilar metals are welded together to create the thermocouple junction. For example, two wires may be butted using SPM techniques and arc welded with a high voltage pulse. Alternatively, the butted wires may be heated to weld them thermally. In yet another embodiment, the wires are welded with an electron beam. In alternative embodiments, the junction may be soldered together.

A nano-thermocouple is particularly useful for making temperature measurements with especially high spatial resolution. For example, in one application, the extreme miniaturization of electronic devices has resulted in high heat generation rates in such electronics, and thus, the possibility of excessive temperatures. By positioning a nanothermocouple on a cantilever probe, temperature profiles of various electronic components can be measured, analyzed and studied. For example, temperature resolutions as high as 80 angstroms can be achieved using this configuration. Such high spatial resolution allows defects within transistors and hot spots in vertical-cavity, surface-emitting quantum well lasers to be seen clearly. In other applications, such high spatial resolution allows temperature to be measured at various points within a single biological cell, which can be useful in biological research, and in the diagnosis and treatment of certain diseases.

In addition to smaller physical size requirements, the use of fine metallic fibers to construct thermocouples offers several other advantages. For example, the small mass of a nano-thermocouple significantly reduces thermal shunting effects by reducing the amount of thermocouple mass that is heated (or cooled) during a measurement. Specifically, the use of the fine metallic wires disclosed herein will cause a steeper gradient of temperature along the nano-thermocouple wire at the junction between the sample medium and the surrounding (ambient) medium.

Nanofiber Heater Applications

When a voltage is applied to a conductor, such as a fine metallic wire fabricated according to the processes described herein, an electric current flows through the conductor. The resistance of the conductor is defined as the ratio of the applied voltage to the current it produces. As electric charge moves across the conductor, the electric potential energy decreases by an amount proportional to the applied voltage. This decrease in electric potential energy contributes to an increase in internal thermal energy present within the conductor. On a microscopic scale, this energy transfer is caused by collisions between the moving electrons and the lattice structure of the resistor, leading to an increase in the temperature of the lattice. On a macroscopic scale, a heater is thus created whenever an electric current passes through a conductor. Such heating is commonly referred to as “ohmic heating.”

The fine metallic fibers disclosed herein can be used to construct a heater on the nanometer scale (referred to herein as a “nano-heater”). For example, a moderate current of 100 microamperes in a nano-heater can lead to a current density as high as 10¹¹ amperes per square meter. Such current densities lead to rapid ohmic heating, causing a nano-heater to rapidly attain temperatures as high as 250 degrees Centigrade. Depending on the application, such generated heat can be applied directly to a proximal target region, or may be transported to a distal target region using any device capable of transporting thermal energy, such as the fine metallic fibers disclosed herein.

Nano-heaters fabricated using the techniques described herein can be configured according to the use for which their use is contemplated. For example, a circular heating device is constructed by winding a fine metallic fiber comprised of a material with an appropriate resistivity, such as a chrome-nickel alloy, around a non-conducting cylindrical core, such as a ceramic or a polymer. When an electric current is passed through such a circular heating device, a particularly concentrated heat source is created.

In other embodiments, two fine metallic wires are run separately through a nanopipette and are fused together at their ends. In such embodiments, passing an electric current through the two fine metallic wires will heat the junction between them. This fused junction can then be used to heat extremely small regions on a target surface. Additionally, such a nano-heater can be used as a nanosource of infrared radiation.

In still other embodiments, a nano-heater may be used in conjunction with the nano-thermocouple described herein to accomplish nanometer-scale thermal imaging and high-density data storage based on near-field scanning optical microscopy or atomic force microscopy.

Nanofiber Electromagnetic Radiation Sensor Applications

The fine metallic fibers disclosed herein can be used to construct an electromagnetic radiation sensor on the nanometer scale (referred to herein as a “nano-sensor”) In Certain embodiments, such a sensor may be used to detect infrared, ultraviolet, microwave and radiofrequency electromagnetic radiation. However, in other embodiments, other types of electromagnetic radiation can be detected with a nano-sensor, including gamma radiation or x-ray radiation.

Infrared radiation sensors. In certain embodiments, fine metallic fibers can be used to construct a photodiode having a quantum structure and high sensitivity to infrared radiation. In such embodiments, the quantum structure is applied to a fine metallic wire comprising semiconductor material, thereby depleting the conduction region. Thus, when infrared electromagnetic radiation is incident upon the conduction region, the depletion is removed, thus allowing the magnitude and direction of current flow through the fine metallic wire to be controlled. Such a configuration has a sensitivity to infrared electromagnetic radiation on the order of 10⁶ times greater than conventional diode-based infrared photodetectors.

Ultraviolet radiation sensors. Fine semiconductor fibers can be used to construct a photo-sensor configured to detect ultraviolet electromagnetic radiation. In particular, the conductivity of fine ZnO fibers is extremely sensitive to ultraviolet radiation exposure. Specifically, fine ZnO fibers have been found to be highly insulating in the dark, having a resistivity greater than 3.5 MΩ cm. However, when such fibers are exposed to ultraviolet radiation with wavelengths less than 380 nanometers, the resistivity decreases by typically four to six orders of magnitude. In addition to exhibiting a high degree of intensity sensitivity, fine ZnO fibers also exhibit a high degree of wavelength sensitivity, as a measurable photoresponse from fine ZnO fibers has been observed from broadband light sources such as indoor incandescent light or sunlight. Thus, fine ZnO fibers can be used as optoelectronic switches, with the dark insulating state as “off”, and the ultraviolet-exposed conducting state as “on”. In particular, fine ZnO fibers can be reversibly switched between the low conductivity state and the high conductivity state, as the rise and decay times are on the order of 1 s. As will be appreciated by those of skill in the art, fibers containing other components can also be used as nanoswitches.

Microwave radiation sensors. Microwave radiation is associated with the energy gaps in semiconductor nanostructures, and thus fine semiconductor fibers can be used to construct a radiation sensor configured to detect microwave electromagnetic radiation. Such a nano-sensor comprises a plurality of electrically connected quantum dots, which are small deposits of a first semiconductor material embedded in a second semiconductor material. Quantum dots can be fabricated on the fine semiconductor fibers disclosed herein by depositing the first semiconductor material within small regions of a fine semiconductor fiber comprising the second semiconductor material. In such embodiments, when a photon arrives at a first dot, it excites an electron into the conduction band of the dot, and an externally-applied strong bias voltage transfers this electron to a second quantum dot. The second dot acts as a single-electron transistor, which is switched by the electron to register the photon. This one-way transfer of single electrons prevents an excited electron returning to its ground state in the first quantum dot before it can be registered.

Radiofrequency radiation sensors. Fine metallic fibers can be used to construct an antenna configured to detect radiofrequency electromagnetic radiation. Specifically, fine metallic fibers can be positioned on flexible substrates to yield a radiofrequency antenna with improved mechanical properties (such as yield strength, tensile strength and fatigue). Furthermore, radiofrequency nano-sensors offer additional benefits over conventional radiofrequency antennas because eddy-current losses and magnetic losses are minimized in a fine metallic fiber, and because sharp resonances can be established, thereby leading to high-Q filter characteristics.

Nano-Mechanical Devices

The ultra fine fibers of the present invention can be used in a number of areas related to mechanical devices. For example, ultra fine fibers can be used in Micro-Electro-Mechanical Systems (MEMS) that include sensors, actuators, switches and electronics, for example, in a common silicon substrate. Here the term MEMS includes structures on the nano scale, which may be referred to as Nano Electro-Mechanical Systems. The nanomechanical components can be fabricated using ultra fine fibers as, for example, but not limited to nano-springs, nano-levers, nano-diaphragms, nano-cables, nano-switches and nano-gears. Properties of the ultra fine fibers can be selected that greatly enhance the ability to couple components of the MEM system. MEMS-based arrays of sensors, actuators, and computational elements emhedded within materials and on surfaces can enhance and control the behavior of macro-scale systems.

In some embodiments, ultra fine fibers can be used as nano springs or can be incorporated into nano springs. The fiber can be wrapped into a helix, for example, or it can be used in the form of a distortable spring rod or lever. Nano-springs may be used in highly sensitive magnetic field detectors, such as in hard drive read heads. Alternatively, nano-springs can serve as positioners or as conventional springs for nano-machines.

In some embodiments, a MEMS system has a transducer base having at least one sensing cantilevered nano-spring attached. The nano-spring is composed of a base material that has a coating of sensing material treated on all, or a region, of a first surface. The coating is a first sensing material that ionizes in response to a particular analyte, such as hydrogen ion concentration within a medium to be sampled. As the sensing material ionizes, the first surface accumulates surface charge proportional to the hydrogen ion concentrations within the medium. As surface charge accumulates on one surface of the nano-spring, changes occur in the differential surface charge density across the surfaces of the nano-spring, and the resulting surface stress deflects the nano-spring.

Another embodiment of a MEMS system using ultra fine fibers is a MEMS accelerometers for crash air-bag deployment systems in automobiles. The MEMS accelerometers can use nano-springs to determine the size and weight of an auto passenger and calculate the optimal response of the system to reduce the possibly of air-bag deployment induced injuries.

The ultra fine fibers can be used in nano-lever devices for providing a high-force, large-displacement linear actuation mechanism. The nano-lever actuator makes use of mechanical layers, magnifying high-force, small-displacement actuation to produce medium-force actuation with large displacement. The nano-lever can be used, for example in nanomechanical devices designed to analyze intrinsic strain in film and to study samples for tensile stress. The nano-lever can have an electrostatic parallel-plate configuration consisting of an array of parallel plate capacitors. The array provides input to a set of mechanical levers that reduce the force by the lever ratio (for example, 20:1) but magnify the displacement by the same ratio.

In other embodiments of MEMS systems, myofibrils are glued between a glass needle and a nano-lever using a silicone-based glue. The glass needle is moved to stretch the fiber using a piezoelectric motor. The nano-lever displacement is monitored with a linear photo-diode array. The force generated by the myofibril can be calculated from the displacement and the calibrated lever stiffness.

In still other embodiments of a MEMS system, a nano-lever is used in a nano-balance application. A mass is attached at the end of a nano-lever, therefore its resonance frequency is shifted. Calibrating the nano-lever makes it possible to measure the mass of the attached particle.

In another embodiment of a MEMS system, ultra fine fibers are used in nano-gears. Nanofiber based molecular gears are formed by bonding rigid molecules onto nanofibers to form gears with molecular teeth. The molecular teeth are positioned in atomically precise positions required for gear design by scanning tunnel microscopy (STM) techniques. The nano-gear can be used in a wedge stepping motor which can be used, for example, in an indexing mechanism. Indexing mechanisms are fundamental devices that are frequently needed in systems such as counters and odometers, etc. The nano-gear can provide indexing of mechanical components, such as gear teeth, and can precisely position mechanical components, as well as index one gear tooth at a time.

The ultra fine fibers can also be used in MEMS systems as “ropes” or “rods” on a nanometer scale, lending themselves to applications such as pulley belts, drive shafts and for transferring power between molecular machines. Long nanofibers connected at their ends in a loop can make motion transition belts for nanomachines. Shorter, stiff nanofibers can be used for rod logic computers or for frames with which to hang components of nanomachines.

In other embodiments, ultra fine fibers can become extraordinarily simple motors. Nanofibers can be exposed to an oscillating polarized light source, causing the nanofiber to rotate away from the “highest energy state” resonance. Exposure to the oscillating polarized light can continuously bump the nanofiber up into the high energy resonance coupling while the nanofiber alternately falls down to lower energy causing the fiber to rotate. Alternately, the motor consists of two concentric cylinders, such as a nano-fiber shaft and a surrounding sleeve. A positive and a negative electric charge is attached to the nano-shaft. Rotational motion of the nano-shaft can be induced by applying oscillating laser fields. The nano-shaft cycles between periods of rotational pendulum-like behavior and unidirectional rotation in a motor-like behavior. The motor on and off times depends on the motor size, field strength and frequency, and relative location of the attached positive and negative charges. The motor can rotate a nano-gear by connecting it to a shaft.

In some embodiments, a first nanofiber is used as a nano-cable having a free first end and a second end fixed to a reference point on the substrate. A second nano-cable has a first end connected to a middle or buckling region of the first nano-cable and a second end fixed to another reference point on a substrate. The first and second nano-cables are arranged to be substantially coplanar and perpendicular to each other. The first end of the first nano-cable can be acted upon by an actuator to induce an input axial force or movement upon the first nano-cable and thereby produce an output buckling of the first nano-cable. The output buckling of the first nano-cable provides an input axial force or movement upon the second nano-cable, thereby producing an output buckling of the second nano-cable. Accordingly, the first and second nano-cables arranged to function in this manner comprise a nanomotion amplifier stage and any number of such stages may be cascaded.

In other embodiments, ultra fine fibers can be woven, webbed, and/or sintered together to form a diaphragm for use in a mass sensor. For example, a connection plate and a diaphragm are joined together. A sensing plate can be joined to the connection plate in the direction perpendicular to the direction where the diaphragm is joined to the connection plate; a piezoelectric element consisting of a piezoelectric film and an electrode is installed on at least either one of the plate surfaces of the sensing plate. A resonating portion consisting of the diaphragm, the sensing plate, the connection plate, and the piezoelectric element is joined to a sensor substrate. Change in the mass of the diaphragm is measured by measuring change in the resonant frequency of the resonating portion accompanying the change in the mass of the diaphragm. The mass sensor enables the measurement of a minute mass of a nanogram order including microorganisms such as bacteria and viruses, chemical substances, and the thickness of vapor-deposited films.

Electronic Devices and Other Uses

Wire wound resistors are constructed by winding wire of resistive conductor such as chrome-nickel alloy around a non-conducting core. One embodiment of a very small wire round resistors can be comprised of ultra fine fibers made according to the present invention wherein the coil wire is an ultra fine fiber with a core or layer of resistive wire, and with an outer insulated layer, wherein the core includes another ultra fine fiber with an insulating outer layer.

A coil of wire, as in the wire wound resistor above, can form an inductor. However, in contrast to the wirewound resistor, the resistance of the wire used in an inductor is typically very low. One embodiment of a very small inductor can be comprised of an ultra fine fiber of a conductive metal, such as silver, wound into a coil. In another embodiment, the coil is wound around a core of iron or other material. This core can also be comprised of an ultra fine fiber.

In another embodiment, a nanotorus can be comprised of an ultra fine fiber in a single circular loop. In another embodiment, the ultra fine fiber can be wound in one or more turns around a toroid made of ferrous or other magnetic material. Nanotori of certain radii have unusually high magnetic moments and can thus be used as a component of an ultra-sensitive magnetic sensor.

As stated above, ultra fine fibers can be made with semiconductor outer layers or zones of semiconductor material. More particularly, semiconducting layers can be doped by adding an impurity such as arsenic or phosphorus (an n-type semiconductor) or aluminum or gallium (a p-type semiconductor). Basic semiconductor devices are comprised of one or more junctions of p or n type semiconductors. Diodes are the simplest of these devices, composed of a single p-n junction. A p-n type semiconductor junction exhibits the property that when a negative voltage is applied to the n-type material, current flows through the junction. When a positive voltage is applied to the n-type material, no current flows through the junction.

Using the ultra fine fibers of the invention, one embodiment of a diode is comprised of an ultra fine fiber with an outer layer of a p-type semiconductor and a second ultra fine fiber with an outer layer of an n-type semiconductor, wherein the two ultra fine fibers are crossed to form a point of electrical contact, thus forming a p-n junction between the two ultra fine fibers.

Other embodiments of the invention include a diode wherein the p-type semiconductor is formed as the outer layer in a zone of a ultra fine fiber and an n-type semiconductor is formed as the outer layer in a zone of a second ultra fine fiber and the two fibers cross, making electrical contact within the p-type zone of the first fiber and n-type zone of the second fiber, forming a p-n junction.

An advantage of a diode comprised of a p-n junction in accordance with the above embodiments is that the inner layer of the ultra fine fiber may be a conductor, allowing the fiber to form both the diode and electrical leads to the diode.

One skilled in the art will recognize that diodes according to the current invention can act as a half-wave rectifier and can be further combined to form full wave rectifiers or any other device that is normally comprised of p-n junction diodes.

A semiconductor transistor is composed of three layers of doped material, an n-type layer, the collector; a p-type layer, the base; and another n-type layer, the emitter. Using the ultra fine fibers of the invention, one embodiment of a transistor is comprised of three ultra fine fibers. In such embodiments, an ultra fine fiber with an outer layer of an n-type semiconductor is preferably the collector, a second ultra fine fiber with an outer layer of p-type semiconductor is preferably the base, and a third ultra fine fiber with an outer layer of an n-type semiconductor is preferably the emitter. In this configuration, the ultra fine fiber comprising the collector is crossed, and placed in electrical contact, with the ultra fine fiber comprising the base. The ultra fine fiber comprising the emitter is crossed, and placed in electrical contact, with the ultra fine fiber comprising the base. Also, the emitter and collector fibers cross the base fiber at different points with the distance between the fibers being dependent upon the properties of the semiconducting layers and the desired operating parameters of the resultant transistor.

Other embodiments are as above, except that the one or more of the ultra fine fibers only has the respective semiconducting outer layer in a zone around the contact points described above. One skilled in the art will recognize that other embodiments of transistors comprised of ultra fine fibers with semiconductor outer layers are possible, including pnp transistors and field effect transistors.

A semiconductor light emitting diode (LED) is comprised of a p-n junction, as described above, wherein the semiconducting materials have the appropriate electronic properties such that light is emitted in response to recombination of electrons and holes at the junction. Materials may be chosen such that p-type dopants are from column III of the Periodic Table (e.g., aluminum, gallium, indium) and n-type dopants are from column V (e.g., phosphorus, arsenic). A preferred light emitting diode is comprised of a diode as described above wherein the p and n type semiconductor layers are of gallium and arsenic.

In another embodiment, the LED comprises a single ultra fine fiber with a layer of p-type semiconductor, and a second layer of n-type semiconductor, wherein the two layers are adjacent and in electrical contact forming a p-n junction.

A variant of the previous embodiment,. a laser LED can be composed of an ultra fine fiber cut into short sections with smooth ends forming an optical cavity between the partially reflective surfaces. When the p-n band gap is appropriately chosen and at high current levels, emission of photons in response to the current results in stimulated emission of additional photons, resulting in laser operation. One skilled in the art will recognize that by appropriate selection of the outer semiconducting layer, specialized diodes, such as Zener diodes and tunnel diodes can be comprised of ultra fine fibers as disclosed by the present invention.

Logic circuits are composed of based on n-p semiconductor junctions as in the basic devices described above. One embodiment of a simple logic circuit is an OR gate comprised of three ultra fine fibers. An OR gate has a high output voltage (a logical 1) when either of its input voltages is high and a low output voltage (a logical 0) when both of its inputs are low. Using ultra fine fibers with an doped semiconductor outer layer, two p type fibers form the input, crossing, making electrical contact with, an n-type coated fiber that forms the output. The crossing points form p-n junctions which act as diodes. In another embodiment, only a zone of each ultra fine fiber in the area of the junction has the respective outer layer, with different outer layers in other portions of each fiber enabling each fiber to be combined into higher level circuits.

Similar arrangements of ultra fine fibers can be used to construct AND and NOR logic devices. One skilled in the art will recognize that OR, AND and NOR logic devices are the fundamental logical devices can be used to compose any higher level logic circuit such as an XOR or logic half adder. In one embodiment, an ultra fine fiber can have different semiconductors or conductors as the outer layer of the fiber in zones to enable the composition of higher level logic devices.

In addition to logic devices, one skilled in the art will recognize that static random access memory devices can be constructed by composition of the fundamental devices above. Furthermore, in a more complex embodiment, a general purpose computer can be composed of these simple devices using conventional design and composition techniques comprised of integrated circuits.

In another embodiment, ultra fine fibers having semiconducting properties can be assembled into quantum wells. A quantum well is a very thin semiconducting layer sandwiched between barriers having a larger bandgap. Because of the bandgap difference, electrons and positively charged electron holes are trapped in the quantum well.

The difficulty in manufacturing quantum wells using standard semiconductor processes results in low device yields. Ultra fine fibers can be used to create very defined quantum well structures. A quantum well can be realized by sandwiching a layer of GaAs between two layers of AlxGal-xAs. In one embodiment, a quantum well can be produced by sandwiching a thin semiconducting layer, for example GaAs, made of an ultra fine fiber between two larger bandgaps made of ultra fine fibers, for example, AlAs. Of course other materials can be used to manufacture a quantum well.

A quantum well confines carriers effectively due to the bandgap structure. However, light, or photons, are not effectively confined in the quantum well. Thus, quantum wells are used in the structure of quantum well devices that are often optical devices. These quantum devices include, but are not limited to, photodiodes, photodetectors, lasers, and optical modulators. However, devices not related to optics can be made using quantum wells. These devices include, but are not limited to, transistors, diodes, diode oscillators, and resonant tunneling devices.

Multiple quantum wells can be configured to create a quantum cascade device. Here, the energy from one quantum well cascades into an adjacent quantum well. Because a photon is emitted when an electron jumps from an upper to a lower energy band, and multiple photons can be emitted by using multiple quantum wells, a quantum cascade device is often an optical device. The quantum cascade device can be, for example, a quantum cascade laser manufactured using multiple quantum wells made from ultra fine fibers.

Cathode ray tubes (CRTs) are used to produce electromagnetic emissions in applications such as computer monitors and x-ray sources. Conventional CRTs are comprised of a metal filament heated to a high temperature (over 1,000 degrees Celsius in X-ray sources). The cathode, when exposed to an electric force, emits electrons which strike an anode to produce photons. If structures with extremely narrow tips, nanotips, are employed rather than a filament, electron emission occurs at much lower temperatures and voltages. Prior cold cathodes have been constructed using carbon nanotubes for producing x-rays and in field emission displays. However, these nanotip devices have been limited by the ability to produce uniform nanotips using carbon nanotubes or by standard semiconductor processes.

Using ultra fine fibers of the current invention, in an x-ray embodiment the cathode is comprised of short substantially uniform lengths of ultra fine fiber composed of conductive metal attached to a base plate, the anode comprised of a metal plate, enclosed in a vacuum to allow electron flow free of interference from air. Voltage is applied to the plate to induce electrons to flow through the vacuum, striking the anode to produce x-rays.

Other embodiments include a field effect display comprised of pixels wherein the pixels are comprised of a gate to control the pixel. Groups of ultra fine fibers are attached to the emitting side of the gate. An phosphor anode is placed on a glass substrate. When a voltage is applied, electrons are emitted from the fibers at the gate, striking the phosphor anode to produce visible light. A display is composed of a grid of pixels above wherein the brightness of a given pixel is controlled by the gate cathode

High temperature superconductors have been constructed using thin films of materials such as Y—Ba—Cu—O (YBCO) and MgB₂. However, widespread application of high temperature superconductors using these materials has been limited by the need to obtain sufficient surface area to handle high currents with the much larger wire sizes of the prior art. Superconducting wires composed of bundles of ultra fine fibers with a layer of superconducting material overcomes this limitation because large bundles of ultra fine wire with a superconducting layer have high effective surface areas.

Specific blocks, sections, devices, functions and modules have been set forth. However, a skilled technologist will recognize that there are many ways to partition the system of the invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the system illustrated may be made by those skilled in the art, without departing from the intent of the invention. Every patent, patent application, or other reference mentioned herein is hereby specifically incorporated by reference in its entirety.

What is claimed is:

1. An ultra fine fiber comprising a drawn metallic fiber having a diameter less than about 100 nanometers.

2. The fiber of claim 1, wherein the diameter of the fiber is between about 30 and 90 nanometers.

3. The fiber of claim 1, wherein the metallic fiber comprises stainless steel.

4. The fiber of claim 1, wherein the metallic fiber comprises gold.

5. The fiber of claim 1, wherein the metallic fiber comprises a metal selected from the group consisting of iron, nickel, platinum, silver, and any alloy thereof.

6. The fiber of claim 1, wherein the fiber comprises a combination of a first metal with a second component to form a material.

7. The fiber of claim 6, wherein the second component is selected from the group consisting of boron, carbon, nitrogen, oxygen, aluminum, silicon, phosphorus, sulfur, nickel, copper, zinc, gallium, germanium, palladium, silver, cadmium, indium, tin, platinum, gold, titanium, rhodium, zirconium, vanadium, titanium tetra-chloride, titanium ethoxide, aluminum sec-but-oxide, and tetra-carbonyl nickel.

8. The fiber of claim 6, wherein the material is selected from the group consisting of an alloy, a ceramic, a catalyst, an intermetallic and a glass.

9. The fiber of claim 6, wherein the material has at least one electrical function selected from the group consisting of a conductor, a semiconductor, an insulator, a capacitor, an electrode, and a photoconductor.

10. The fiber of claim 1, further comprising an outer layer adjacent an outer circumference of the fiber.

11. The fiber of claim 10, wherein the outer layer is selected from the group consisting of boron, carbon, nitrogen, oxygen, aluminum, silicon, phosphorus, sulfur, nickel, copper, zinc, gallium, germanium, platinum, silver, indium, titanium tetra-chloride, titanium ethoxide, aluminum sec-but-oxide, and tetra-carbonyl nickel.

12. The fiber of claim 1, the fiber having a longitudinal axis, the fiber further having at least a first region and a second region along its longitudinal axis, the first region having a first characteristic, and the second region having a second characteristic.

13. The fiber of claim 12, wherein the first or second characteristic is an electrical function selected from the group consisting of a conductor, a semiconductor, an insulator, a capacitor, a resistor and an electrode.

14. The fiber of claim 12, wherein the first or second characteristic is a material comprising a combination of a first metal with a second component.

15. The fiber of claim 14, wherein the first metal comprises a metal selected from the group consisting of stainless steel, gold, iron, nickel, platinum, silver, titanium, zirconium, niobium, and vanadium.

16. The fiber of claim 14, wherein the second component comprises an element selected from the group consisting of boron, carbon, nitrogen, oxygen, aluminum, silicon, phosphorus, sulfur, nickel, copper, zinc, gallium, germanium, palladium, silver, cadmium, indium, tin, platinum, indium, gold, titanium, rhodium, zirconium and vanadium.

17. The fiber of claim 14, wherein the material is selected from the group consisting of an alloy, a ceramic, a catalyst, and an intermetallic.

18. A device comprising an ultra fine fiber, the fiber comprising a drawn metallic fiber having a diameter less than 100 nanometers.

19. The device of claim 18, selected from the group consisting of a filter, a sensor, a capacitor, a resistor, a semiconductor, a fuel cell, a nanogear, a nanomechanical device, a nanochemical device, a nanoelectrical device, a nanoelectromechanical system, a nanospring, and a catalyst.

20. A filter comprising an ultra fine fiber, the fiber comprising a drawn metallic fiber having a diameter less than about 100 nanometers.

21. The filter of claim 20, wherein the fiber comprises a ductile material that is resistant to chemical corrosion.

22. The filter of claim 20, wherein the fiber comprises a material having a catalytic property.

23. The filter of claim 20, wherein the fiber comprises a material having resistance to a temperatures between about 100° C. to about 1250° C.

24. The filter of claim 20, having a thickness of between about 25 μm and about 1250 μm.

25. The filter of claim 20, having pores capable of excluding particles of a minimum size, wherein the minimum size is between about 1000 Daltons and about 1 μm.

26. The filter of claim 20, having a bulk porosity of at least about 30%.

27. A process for making ultra fine fibers comprising:
providing a plurality of metallic wires;
coating the wires with a sacrificial coating material to obtain a plurality of coated wires;
subjecting the plurality of coated wires to at least two cycles of a drawing process, the drawing process comprising:
forming a bundle of metallic wires, or claddings containing metallic wires;
encasing the bundle within an outer cladding; and
drawing the outer cladding to reduce the outer diameter thereof and to reduce the cross-section of the metallic wires;
releasing the fibers by removing the sacrificial coating material and claddings; and
obtaining a plurality of ultra fine metallic fibers, the fibers having a diameter of less than about 100 nanometers.

28. The process of claim 27, in which at least one cycle of the drawing process further comprises an annealing step.

29. The process of claim 28, wherein the annealing step comprises exposing the metallic wires to a temperature between 0.5 and 0.8 of a melting point of the wires.

30. The process of claim 27, comprising at least three cycles of the drawing process.

31. The process of claim 27, further comprising exposing at least a portion of a fiber to a second component under conditions permitting doping of the second component into the fiber.

32. The process of claim 31, wherein the conditions permitting doping comprise contacting the fiber with a doping atmosphere comprising a gas, the gas comprising an element selected from the group consisting of nitrogen, hydrogen, carbon, boron, phosphorus, silicon, aluminum, sulfur, oxygen titanium tetra-chloride, titanium ethoxide, aluminum sec-but-oxide, and tetra-carbonyl nickel.

33. The process of claim 32, wherein the conditions permitting doping further comprise heating the fibers in the doping atmosphere.

34. The process of claim 33, wherein the heating is at a temperature sufficient to break an intramolecular bond of the gas, and wherein the temperature is lower than a melting point of the fiber.

35. The process of claim 31 wherein the conditions permitting doping comprise heating the fiber at a level between about 0.5 and 0.9 of a melting point of the fibers.

36. The process of claim 35, wherein the heating is at a level between about 0.6 and 0.8 of a melting point of the fibers.

37. The process of claim 36, wherein the heating is at a level between about 0.65 and 0.69 of a melting point of the fibers.

38. The process of claim 27, wherein the coating step comprises electroplating the coating material onto the metallic wires.

39. The process of claim 27, further comprising treating an interior of the cladding with a release material to inhibit chemical interaction between the cladding and the plurality of coated metallic wires within the cladding.

40. The process of claim 39, wherein the release material is in a quantity sufficient to inhibit chemical interaction between the cladding and the plurality of coated metallic wires within the cladding, and wherein the quantity is insufficient to inhibit a diffusion bond between the coated metallic wires and the sacrificial coating material.

41. The process of claim 27, wherein the encasing step of at least one cycle comprises forming a longitudinally extending sheet of cladding material into a continuous tube about the plurality of metallic wires.

42. The process of claim 27, wherein the sacrificial coating comprises from about 5% to about 15% by volume of a combined volume of the metallic wires and the sacrificial coating material.

43. The process of claim 27, wherein the releasing step comprises chemically removing the sacrificial coating material.

44. The process of claim 27, wherein the releasing step comprises immersing the drawn metallic wires into an acid for dissolving the sacrificial coating material.

45. The process of claim 27, wherein at least one cycle comprises a reduction ratio of the cross section of the wires between about 8% and about 20%.

46. The process of claim 45, wherein the reduction ratio is about 10%.

47. The process of claim 27, wherein the metallic wires have a diameter of from about 12 μm to about 50 μm prior to the drawing process.

48. Use of an ultra fine fiber in a device, wherein the ultra fine fiber comprises a drawn metallic fiber having a diameter less than about 100 nanometers for use in a device.

49. The use of an ultra fine fiber according to claim 48, wherein the device is an electronic sensor.

50. The use of an ultra fine fiber according to claim 49, wherein the electronic sensor is a sensor selected from the group consisting of a piezo-resistive sensor, a chemo-resistive sensor, a nano-computer switch, a thermo-resistive sensor, a nano-transmitter, a nano-receiver, a thermocouple, and a nano-antenna.

51. The use of an ultra fine fiber according to claim 48, wherein the device is a biomedical sensor.

52. The use of an ultra fine fiber according to claim 51, wherein the biomedical sensor is a glucose sensor.

53. The use of an ultra fine fiber according to claim 48, wherein the device is an opto-electronic converter.

54. The use of an ultra fine fiber according to claim 53 wherein the opto-electronic converter is a photovoltaic cell.

55. The use of an ultra fine fiber according to claim 48, wherein the device is a filtration device.

56. The use of an ultra fine fiber according to claim 55, wherein the filtration device is selected from the group consisting of a nano-catalytically enhanced filtration device, an aerosol filter device, and a nano-filtration membrane.

57. The use of an ultra fine fiber according to claim 48, wherein the device is an energy device.

58. The use of an ultra fine fiber according to claim 57, wherein the energy device is selected from the group consisting of a nano-fuel cell array; a nano-storage capacitor; an infrared energy sensor, an ultraviolet energy sensor, a microwave energy sensor, an RF energy sensor, a thermocouple, and a nano-heater.

59. The use of an ultra fine fiber according to claim 48, wherein the device is a chemical device.

60. The use of an ultra fine fiber according to claim 59, wherein the chemical device is selected from the group consisting of a nano-engineered catalyst structure, a nano-chemical sensor, and a nano-chemical analyzer.

61. The use of an ultra fine fiber according to claim 48, wherein the device is a mechanical device.

62. The use of an ultra fine fiber according to claim 61, wherein the mechanical device is selected from the group consisting of a nano-electro-mechanical system, a nano-spring, a nano-lever, a nano-diaphragm, a nano cable and a nanogear.

63. The use of an ultra fine fiber according to claim 48, wherein the device is an electronic device.

64. The use of an ultra fine fiber according to claim 63, wherein the electronic device is selected from the group consisting of a transistor, a diode, an LED, a nanotorus, a cathode emitter, a rectifier, a resistor, an inductor, a nanocomputer, and a nanomemory circuit.

65. The use of an ultra fine fiber according to claim 48, wherein the device is a quantum well device.

66. The use of an ultra fine fiber according to claim 48, wherein the device is a quantum cascade device.

67. The use of an ultra fine fiber according to claim 48, wherein the device is a ceramic superconductor.

68. The use of an ultra fine fiber according to claim 48, wherein the device is a nanowire laser.

69. The use of an ultra fine fiber according to claim 48, wherein the diameter of the fiber is between about 30 and 90 nanometers.

70. The use of an ultra fine fiber according to claim 48, wherein the metallic fiber comprises stainless steel.

71. The use of an ultra fine fiber according to claim 48, wherein the metallic fiber comprises gold.

72. The use of an ultra fine fiber according to claim 48, wherein the metallic fiber comprises a metal selected from the group consisting of iron, nickel, platinum, silver, titanium, zirconium, niobium, vanadium, chromium, manganese, cobalt, molybdenum, and copper.
